(19) United States
(12) Patent Application Publication
(10) Pub. No.: US 2022/0019367 A1
(43) Pub. Date: Jan. 20, 2022

(54) Migrating Data In And Out Of Cloud Environments

(71) Applicant: PURE STORAGE, INC., Mountain View, CA (US)

(72) Inventors: JOSHUA FREILICH, SAN FRANCISCO, CA (US); MATTHEW FAY, MOUNTAIN VIEW, CA (US); RILEY THOMASSON, REDONDO BEACH, CA (US); RONALD KARR, PALO ALTO, CA (US); VIRENDRA PRAKASHAIAH, SUNNYVALE, CA (US)

(21) Appl. No.: 17/487,778

(22) Filed: Sep. 28, 2021

Related U.S. Application Data
(63) Continuation-in-part of application No. 16/171,907, filed on Oct. 26, 2018.
Application No. 16/171,907 is a continuation-in-part of application No. 15/494,360, filed on Apr. 21, 2017, now Pat. No. 10,678,754.
(60) Provisional application No. 62/750,764, filed on Oct. 25, 2018.
(60) Provisional application No. 62/639,009, filed on Mar. 6, 2018.

(51) Int. Cl. G06F 3/06

(52) U.S. Cl. CPC G06F 3/0647; G06F 3/067; G06F 3/0604; G06F 3/0659

(57) ABSTRACT

In an embodiment, a migration of a dataset from a source storage system to a target storage system is initiated, wherein at least one of the source storage system and the target storage system is a cloud-based storage system. The target storage system provides read/write access to the dataset before completing migration of the dataset from the source storage system to the target storage system.

### CROSS-REFERENCE TO RELATED APPLICATIONS

This is a continuation in-part application for patent entitled to a filing dated and claiming the benefit of earlier-filed of U.S. patent application Ser. No. 16/171,907, filed Oct. 26, 2018, herein incorporated by reference in its entirety, which is a continuation-in-part of U.S. Pat. No. 10,678,754, issued Jun. 9, 2020, which claims the benefit of U.S. Provisional Application 62/639,009 filed Mar. 6, 2018, and U.S. Provisional Application 62/750,764 filed Oct. 25, 2018.

### BRIEF DESCRIPTION OF DRAWINGS

FIG. 1A illustrates a first example system for data storage in accordance with some implementations.

FIG. 1B illustrates a second example system for data storage in accordance with some implementations.

FIG. 1C illustrates a third example system for data storage in accordance with some implementations.

FIG. 1D illustrates a fourth example system for data storage in accordance with some implementations.

FIG. 2A is a perspective view of a storage cluster with multiple storage nodes and internal storage coupled to each storage node to provide network attached storage, in accordance with some embodiments.

FIG. 2B is a block diagram showing an interconnect switch coupling multiple storage nodes in accordance with some embodiments.

FIG. 2C is a multiple level block diagram, showing contents of a storage node and contents of one of the non-volatile solid state storage units in accordance with some embodiments.

FIG. 2D shows a storage server environment, which uses embodiments of the storage nodes and storage units of some previous figures in accordance with some embodiments.

FIG. 2E is a blade hardware block diagram, showing a control plane, compute and storage planes, and authorities interacting with underlying physical resources, in accordance with some embodiments.

FIG. 2F depicts elasticity software layers in blades of a storage cluster, in accordance with some embodiments.

FIG. 2G depicts authorities and storage resources in blades of a storage cluster, in accordance with some embodiments.

FIG. 3A sets forth a diagram of a storage system that is coupled for data communications with a cloud services provider in accordance with some embodiments of the present disclosure.

FIG. 3B sets forth a diagram of a storage system in accordance with some embodiments of the present disclosure.

FIG. 3C illustrates an exemplary computing device that may be specifically configured to perform one or more of the processes described herein.

FIG. 3D illustrates an example of a fleet of storage systems for providing storage services in accordance with embodiments of the present disclosure.

FIG. 4A illustrates a first block diagram for deduplication-aware per-tenant encryption in accordance with some embodiments of the present disclosure.

FIG. 4B illustrates a second block diagram for deduplication-aware per-tenant encryption in accordance with some embodiments of the present disclosure.

FIG. 5 illustrates a first flow diagram for deduplication-aware per-tenant encryption in accordance with some embodiments of the present disclosure.

FIG. 6 illustrates a second flow diagram for deduplication-aware per-tenant encryption in accordance with some embodiments of the present disclosure.

FIG. 7 sets forth an example of a cloud-based storage system in accordance with some embodiments of the present disclosure.

FIG. 8 sets forth an example of an additional cloud-based storage system in accordance with some embodiments of the present disclosure.

FIG. 9 illustrates an example virtual storage system architecture in accordance with some embodiments of the present disclosure.

FIG. 10 illustrates an additional example virtual storage system architecture in accordance with some embodiments of the present disclosure.

FIG. 11 illustrates an additional example virtual storage system architecture in accordance with some embodiments of the present disclosure.

FIG. 12 illustrates an additional example virtual storage system architecture in accordance with some embodiments of the present disclosure.

FIG. 13 illustrates an additional example virtual storage system architecture in accordance with some embodiments of the present disclosure.

FIG. 14 illustrates an additional example virtual storage system architecture in accordance with some embodiments of the present disclosure.

FIG. 15 illustrates an additional example virtual storage system architecture in accordance with some embodiments of the present disclosure.

FIG. 16 sets forth a flow diagram for an example method of migrating data in and out of cloud environments in accordance with some embodiments of the present disclosure.

FIG. 17 sets forth a block diagram of an example storage system for migrating data in and out of cloud environments in accordance with some embodiments of the present disclosure.

FIG. 18 sets forth a flow diagram for another example method of migrating data in and out of cloud environments in accordance with some embodiments of the present disclosure.

FIG. 19 sets forth another block diagram of the storage system of FIG. 8 in accordance with some embodiments of the present disclosure.

FIG. 20 sets forth a flow diagram for another example method of migrating data in and out of cloud environments in accordance with some embodiments of the present disclosure.

FIG. 21 sets forth a flow diagram for another example method of migrating data in and out of cloud environments in accordance with some embodiments of the present disclosure.

### DETAILED DESCRIPTION

Data deduplication is a process to eliminate or remove redundant data to improve the utilization of storage resources. For example, during the deduplication process, blocks of data may be processed and stored. When a subsequent block of data is received, the subsequent block of data may be compared with the previously stored block of data. If the subsequent block of data matches with the previously stored block of data, then the subsequent block of data may not be stored in the storage resource. Instead, a pointer to the previously stored block of data may replace the contents of the subsequent block of data.

Aspects of the present disclosure relate to providing per-tenant data deduplication in a multi-tenant storage array. In some embodiments, distributed storage systems may implement data deduplication techniques to identify a data block received in a write request to determine whether a duplicate copy of the data block is currently stored in the storage system. The deduplication process may use a hash function that generates a hash value based on the data block. The generated hash value may be compared with hash values of a deduplication map that identifies currently stored data blocks at the storage system. If the generated hash value matches with any of the hash values in the deduplication map, then the data block may be considered to be a copy or duplicate of another data block that is currently stored at the storage system.

In some multi-tenant environments, each tenant might want to have their volumes encrypted with a unique encryption key that is not shared with other tenants. While this offers an increased level of security, deduplication in such an environment may be difficult. Advantageously, aspects of the present disclosure address the above difficulty, and others, by providing for deduplication-aware per-tenant encryption. The systems and methods described in the present disclosure may allow for increased storage efficiency in storage systems by allowing for the deduplication of data that was previously incapable of being deduplicated. In addition to increasing storage space efficiencies, processing efficiencies may also be realized as a result of increased storage capacity.

It should be noted that, in some embodiments, although an “encryption key” is referred to herein for convenience, an encryption key may include any of the above encryption information, and/or any other suitable information. In one embodiment, an encryption key, as referred to herein, may be an encryption/decryption key as used in a symmetric encryption algorithm, for example. In other embodiments, other types of keys may be used.

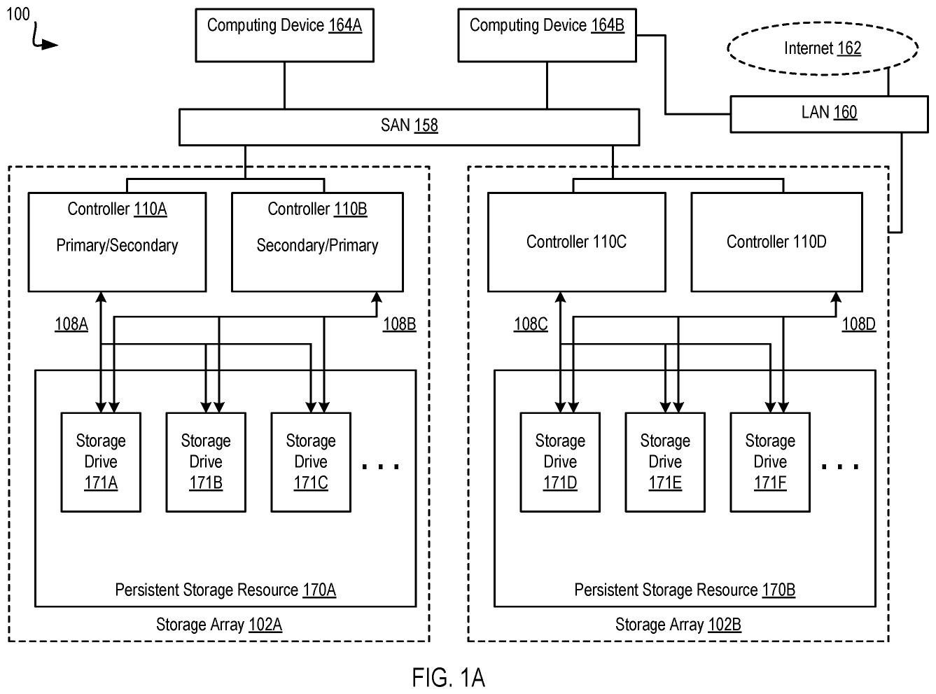

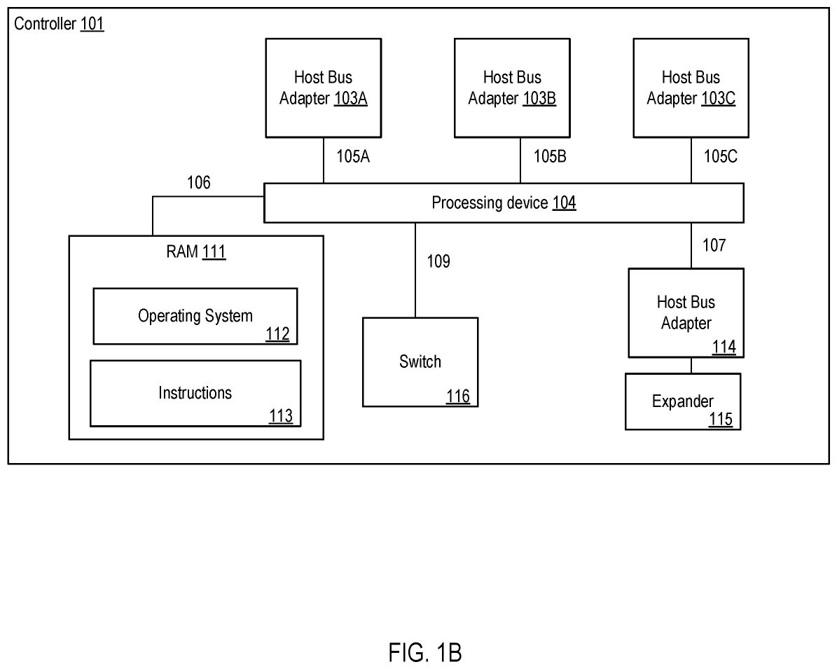

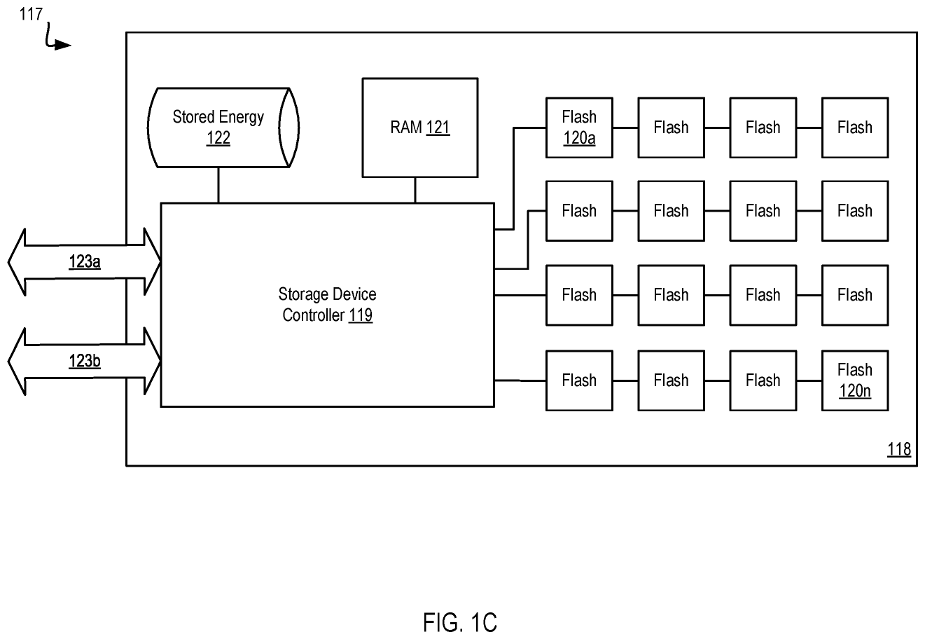

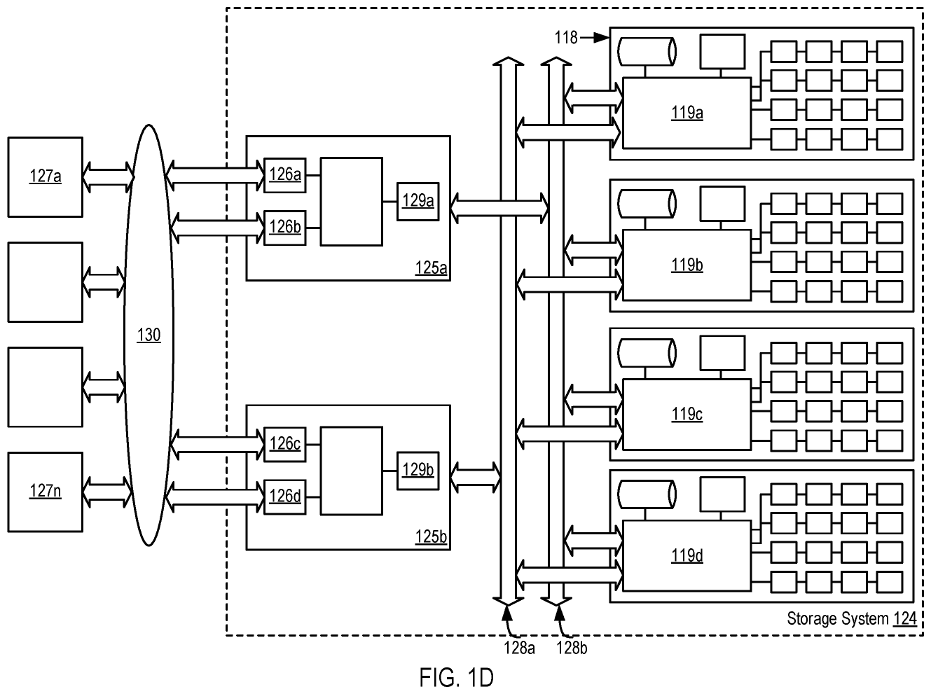

Example methods, apparatus, and products for deduplication-aware per-tenant encryption in accordance with embodiments of the present disclosure are described with reference to the accompanying drawings, beginning with FIG. 1A. FIG. 1A illustrates an example system for data storage, in accordance with some implementations. System 100 (also referred to as “storage system” herein) includes numerous elements for purposes of illustration rather than limitation. It may be noted that system 100 may include the same, more, or fewer elements configured in the same or different manner in other implementations.

System 100 includes a number of computing devices 164A-B. Computing devices (also referred to as “client devices” herein) may be embodied, for example, a server in a data center, a workstation, a personal computer, a notebook, or the like. Computing devices 164A-B may be coupled for data communications to one or more storage arrays 102A-B through a storage area network (‘SAN’) 158 or a local area network (‘LAN’) 160.

The SAN 158 may be implemented with a variety of data communications fabrics, devices, and protocols. For example, the fabrics for SAN 158 may include Fibre Channel, Ethernet, Infiniband, Serial Attached Small Computer System Interface (‘SAS’), or the like. Data communications protocols for use with SAN 158 may include Advanced Technology Attachment (‘ATA’), Fibre Channel Protocol, Small Computer System Interface (‘SCSI’), Internet Small Computer System Interface (‘iSCSI’), HyperSCSI, Non-Volatile Memory Express (‘NVMe’) over Fabrics, or the like. It may be noted that SAN 158 is provided for illustration, rather than limitation. Other data communication couplings may be implemented between computing devices 164A-B and storage arrays 102A-B.

The LAN 160 may also be implemented with a variety of fabrics, devices, and protocols. For example, the fabrics for LAN 160 may include Ethernet (802.3), wireless (802.11), or the like. Data communication protocols for use in LAN 160 may include Transmission Control Protocol (‘TCP’), User Datagram Protocol (‘UDP’), Internet Protocol (‘IP’), HyperText Transfer Protocol (‘HTTP’), Wireless Access Protocol (‘WAP’), Handheld Device Transport Protocol (‘HDTP’), Session Initiation Protocol (‘SIP’), Real Time Protocol (‘RTP’), or the like.

Storage arrays 102A-B may provide persistent data storage for the computing devices 164A-B. Storage array 102A may be contained in a chassis (not shown), and storage array 102B may be contained in another chassis (not shown), in implementations. Storage array 102A and 102B may include one or more storage array controllers 110A-D (also referred to as “controller” herein). A storage array controller 110A-D may be embodied as a module of automated computing machinery comprising computer hardware, computer software, or a combination of computer hardware and software. In some implementations, the storage array controllers 110A-D may be configured to carry out various storage tasks. Storage tasks may include writing data received from the computing devices 164A-B to storage array 102A-B, erasing data from storage array 102A-B, retrieving data from storage array 102A-B and providing data to computing devices 164A-B, monitoring and reporting of disk utilization and performance, performing redundancy operations, such as Redundant Array of Independent Drives (‘RAID’) or RAID-like data redundancy operations, compressing data, encrypting data, and so forth.

Storage array controller 110A-D may be implemented in a variety of ways, including as a Field Programmable Gate Array (‘FPGA’), a Programmable Logic Chip (‘PLC’), an Application Specific Integrated Circuit (‘ASIC’), System-on-Chip (‘SOC’), or any computing device that includes discrete components such as a processing device, central processing unit, computer memory, or various adapters. Storage array controller 110A-D may include, for example, a data communications adapter configured to support communications via the SAN 158 or LAN 160. In some implementations, storage array controller 110A-D may be independently coupled to the LAN 160. In implementations, storage array controller 110A-D may include an I/O controller or the like that couples the storage array controller 110A-D for data communications, through a midplane (not shown), to a persistent storage resource 170A-B (also referred to as a “storage resource” herein). The persistent storage resource 170A-B main include any number of storage drives 171A-F (also referred to as “storage devices” herein) and any number of non-volatile Random Access Memory (‘NVRAM’) devices (not shown).

In some implementations, the NVRAM devices of a persistent storage resource 170A-B may be configured to receive, from the storage array controller 110A-D, data to be stored in the storage drives 171A-F. In some examples, the data may originate from computing devices 164A-B. In some examples, writing data to the NVRAM device may be carried out more quickly than directly writing data to the storage drive 171A-F. In implementations, the storage array controller 110A-D may be configured to utilize the NVRAM devices as a quickly accessible buffer for data destined to be written to the storage drives 171A-F. Latency for write requests using NVRAM devices as a buffer may be improved relative to a system in which a storage array controller 110A-D writes data directly to the storage drives 171A-F. In some implementations, the NVRAM devices may be implemented with computer memory in the form of high bandwidth, low latency RAM. The NVRAM device is referred to as “non-volatile” because the NVRAM device may receive or include a unique power source that maintains the state of the RAM after main power loss to the NVRAM device. Such a power source may be a battery, one or more capacitors, or the like. In response to a power loss, the NVRAM device may be configured to write the contents of the RAM to a persistent storage, such as the storage drives 171A-F.

In implementations, storage drive 171A-F may refer to any device configured to record data persistently, where “persistently” or “persistent” refers as to a device's ability to maintain recorded data after loss of power. In some implementations, storage drive 171A-F may correspond to non-disk storage media. For example, the storage drive 171A-F may be one or more solid-state drives (‘SSDs’), flash memory based storage, any type of solid-state non-volatile memory, or any other type of non-mechanical storage device. In other implementations, storage drive 171A-F may include mechanical or spinning hard disk, such as hard-disk drives (‘HDD’).

In some implementations, the storage array controllers 110A-D may be configured for offloading device management responsibilities from storage drive 171A-F in storage array 102A-B. For example, storage array controllers 110A-D may manage control information that may describe the state of one or more memory blocks in the storage drives 171A-F. The control information may indicate, for example, that a particular memory block has failed and should no longer be written to, that a particular memory block contains boot code for a storage array controller 110A-D, the number of program-erase (‘P/E’) cycles that have been performed on a particular memory block, the age of data stored in a particular memory block, the type of data that is stored in a particular memory block, and so forth. In some implementations, the control information may be stored with an associated memory block as metadata. In other implementations, the control information for the storage drives 171A-F may be stored in one or more particular memory blocks of the storage drives 171A-F that are selected by the storage array controller 110A-D. The selected memory blocks may be tagged with an identifier indicating that the selected memory block contains control information. The identifier may be utilized by the storage array controllers 110A-D in conjunction with storage drives 171A-F to quickly identify the memory blocks that contain control information. For example, the storage controllers 110A-D may issue a command to locate memory blocks that contain control information. It may be noted that control information may be so large that parts of the control information may be stored in multiple locations, that the control information may be stored in multiple locations for purposes of redundancy, for example, or that the control information may otherwise be distributed across multiple memory blocks in the storage drive 171A-F.

In implementations, storage array controllers 110A-D may offload device management responsibilities from storage drives 171A-F of storage array 102A-B by retrieving, from the storage drives 171A-F, control information describing the state of one or more memory blocks in the storage drives 171A-F. Retrieving the control information from the storage drives 171A-F may be carried out, for example, by the storage array controller 110A-D querying the storage drives 171A-F for the location of control information for a particular storage drive 171A-F. The storage drives 171A-F may be configured to execute instructions that enable the storage drive 171A-F to identify the location of the control information. The instructions may be executed by a controller (not shown) associated with or otherwise located on the storage drive 171A-F and may cause the storage drive 171A-F to scan a portion of each memory block to identify the memory blocks that store control information for the storage drives 171A-F. The storage drives 171A-F may respond by sending a response message to the storage array controller 110A-D that includes the location of control information for the storage drive 171A-F. Responsive to receiving the response message, storage array controllers 110A-D may issue a request to read data stored at the address associated with the location of control information for the storage drives 171A-F.

In other implementations, the storage array controllers 110A-D may further offload device management responsibilities from storage drives 171A-F by performing, in response to receiving the control information, a storage drive management operation. A storage drive management operation may include, for example, an operation that is typically performed by the storage drive 171A-F (e.g., the controller (not shown) associated with a particular storage drive 171A-F). A storage drive management operation may include, for example, ensuring that data is not written to failed memory blocks within the storage drive 171A-F, ensuring that data is written to memory blocks within the storage drive 171A-F in such a way that adequate wear leveling is achieved, and so forth.

In implementations, storage array 102A-B may implement two or more storage array controllers 110A-D. For example, storage array 102A may include storage array controllers 110A and storage array controllers 110B. At a given instance, a single storage array controller 110A-D (e.g., storage array controller 110A) of a storage system 100 may be designated with primary status (also referred to as “primary controller” herein), and other storage array controllers 110A-D (e.g., storage array controller 110A) may be designated with secondary status (also referred to as “secondary controller” herein). The primary controller may have particular rights, such as permission to alter data in persistent storage resource 170A-B (e.g., writing data to persistent storage resource 170A-B). At least some of the rights of the primary controller may supersede the rights of the secondary controller. For instance, the secondary controller may not have permission to alter data in persistent storage resource 170A-B when the primary controller has the right. The status of storage array controllers 110A-D may change. For example, storage array controller 110A may be designated with secondary status, and storage array controller 110B may be designated with primary status.

In some implementations, a primary controller, such as storage array controller 110A, may serve as the primary controller for one or more storage arrays 102A-B, and a second controller, such as storage array controller 110B, may serve as the secondary controller for the one or more storage arrays 102A-B. For example, storage array controller 110A may be the primary controller for storage array 102A and storage array 102B, and storage array controller 110B may be the secondary controller for storage array 102A and 102B. In some implementations, storage array controllers 110C and 110D (also referred to as “storage processing modules”) may neither have primary or secondary status. Storage array controllers 110C and 110D, implemented as storage processing modules, may act as a communication interface between the primary and secondary controllers (e.g., storage array controllers 110A and 110B, respectively) and storage array 102B. For example, storage array controller 110A of storage array 102A may send a write request, via SAN 158, to storage array 102B. The write request may be received by both storage array controllers 110C and 110D of storage array 102B. Storage array controllers 110C and 110D facilitate the communication, e.g., send the write request to the appropriate storage drive 171A-F. It may be noted that in some implementations storage processing modules may be used to increase the number of storage drives controlled by the primary and secondary controllers.

In implementations, storage array controllers 110A-D are communicatively coupled, via a midplane (not shown), to one or more storage drives 171A-F and to one or more NVRAM devices (not shown) that are included as part of a storage array 102A-B. The storage array controllers 110A-D may be coupled to the midplane via one or more data communication links and the midplane may be coupled to the storage drives 171A-F and the NVRAM devices via one or more data communications links. The data communications links described herein are collectively illustrated by data communications links 108A-D and may include a Peripheral Component Interconnect Express (‘PCIe’) bus, for example.

FIG. 1B illustrates an example system for data storage, in accordance with some implementations. Storage array controller 101 illustrated in FIG. 1B may be similar to the storage array controllers 110A-D described with respect to FIG. 1A. In one example, storage array controller 101 may be similar to storage array controller 110A or storage array controller 110B. Storage array controller 101 includes numerous elements for purposes of illustration rather than limitation. It may be noted that storage array controller 101 may include the same, more, or fewer elements configured in the same or different manner in other implementations. It may be noted that elements of FIG. 1A may be included below to help illustrate features of storage array controller 101.

Storage array controller 101 may include one or more processing devices 104 and random access memory (‘RAM’) 111. Processing device 104 (or controller 101) represents one or more general-purpose processing devices such as a microprocessor, central processing unit, or the like. More particularly, the processing device 104 (or controller 101) may be a complex instruction set computing (‘CISC’) microprocessor, reduced instruction set computing (‘RISC’) microprocessor, very long instruction word (‘VLIW’) microprocessor, or a processor implementing other instruction sets or processors implementing a combination of instruction sets. The processing device 104 (or controller 101) may also be one or more special-purpose processing devices such as an ASIC, an FPGA, a digital signal processor (‘DSP’), network processor, or the like.

The processing device 104 may be connected to the RAM 111 via a data communications link 106, which may be embodied as a high speed memory bus such as a Double-Data Rate 4 (‘DDR4’) bus. Stored in RAM 111 is an operating system 112. In some implementations, instructions 113 are stored in RAM 111. Instructions 113 may include computer program instructions for performing operations in in a direct-mapped flash storage system. In one embodiment, a direct-mapped flash storage system is one that that addresses data blocks within flash drives directly and without an address translation performed by the storage controllers of the flash drives.

In implementations, storage array controller 101 includes one or more host bus adapters 103A-C that are coupled to the processing device 104 via a data communications link 105A-C. In implementations, host bus adapters 103A-C may be computer hardware that connects a host system (e.g., the storage array controller) to other network and storage arrays. In some examples, host bus adapters 103A-C may be a Fibre Channel adapter that enables the storage array controller 101 to connect to a SAN, an Ethernet adapter that enables the storage array controller 101 to connect to a LAN, or the like. Host bus adapters 103A-C may be coupled to the processing device 104 via a data communications link 105A-C such as, for example, a PCIe bus.

In implementations, storage array controller 101 may include a host bus adapter 114 that is coupled to an expander 115. The expander 115 may be used to attach a host system to a larger number of storage drives. The expander 115 may, for example, be a SAS expander utilized to enable the host bus adapter 114 to attach to storage drives in an implementation where the host bus adapter 114 is embodied as a SAS controller.

In implementations, storage array controller 101 may include a switch 116 coupled to the processing device 104 via a data communications link 109. The switch 116 may be a computer hardware device that can create multiple endpoints out of a single endpoint, thereby enabling multiple devices to share a single endpoint. The switch 116 may, for example, be a PCIe switch that is coupled to a PCIe bus (e.g., data communications link 109) and presents multiple PCIe connection points to the midplane.

In implementations, storage array controller 101 includes a data communications link 107 for coupling the storage array controller 101 to other storage array controllers. In some examples, data communications link 107 may be a QuickPath Interconnect (QPI) interconnect.

A traditional storage system that uses traditional flash drives may implement a process across the flash drives that are part of the traditional storage system. For example, a higher level process of the storage system may initiate and control a process across the flash drives. However, a flash drive of the traditional storage system may include its own storage controller that also performs the process. Thus, for the traditional storage system, a higher level process (e.g., initiated by the storage system) and a lower level process (e.g., initiated by a storage controller of the storage system) may both be performed.

To resolve various deficiencies of a traditional storage system, operations may be performed by higher level processes and not by the lower level processes. For example, the flash storage system may include flash drives that do not include storage controllers that provide the process. Thus, the operating system of the flash storage system itself may initiate and control the process. This may be accomplished by a direct-mapped flash storage system that addresses data blocks within the flash drives directly and without an address translation performed by the storage controllers of the flash drives.

In implementations, storage drive 171A-F may be one or more zoned storage devices. In some implementations, the one or more zoned storage devices may be a shingled HDD. In implementations, the one or more storage devices may be a flash-based SSD. In a zoned storage device, a zoned namespace on the zoned storage device can be addressed by groups of blocks that are grouped and aligned by a natural size, forming a number of addressable zones. In implementations utilizing an SSD, the natural size may be based on the erase block size of the SSD. In some implementations, the zones of the zoned storage device may be defined during initialization of the zoned storage device. In implementations, the zones may be defined dynamically as data is written to the zoned storage device.

In some implementations, zones may be heterogeneous, with some zones each being a page group and other zones being multiple page groups. In implementations, some zones may correspond to an erase block and other zones may correspond to multiple erase blocks. In an implementation, zones may be any combination of differing numbers of pages in page groups and/or erase blocks, for heterogeneous mixes of programming modes, manufacturers, product types and/or product generations of storage devices, as applied to heterogeneous assemblies, upgrades, distributed storages, etc. In some implementations, zones may be defined as having usage characteristics, such as a property of supporting data with particular kinds of longevity (very short lived or very long lived, for example). These properties could be used by a zoned storage device to determine how the zone will be managed over the zone's expected lifetime.

It should be appreciated that a zone is a virtual construct. Any particular zone may not have a fixed location at a storage device. Until allocated, a zone may not have any location at a storage device. A zone may correspond to a number representing a chunk of virtually allocatable space that is the size of an erase block or other block size in various implementations. When the system allocates or opens a zone, zones get allocated to flash or other solid-state storage memory and, as the system writes to the zone, pages are written to that mapped flash or other solid-state storage memory of the zoned storage device. When the system closes the zone, the associated erase block(s) or other sized block(s) are completed. At some point in the future, the system may delete a zone which will free up the zone's allocated space. During its lifetime, a zone may be moved around to different locations of the zoned storage device, e.g., as the zoned storage device does internal maintenance.

In implementations, the zones of the zoned storage device may be in different states. A zone may be in an empty state in which data has not been stored at the zone. An empty zone may be opened explicitly, or implicitly by writing data to the zone. This is the initial state for zones on a fresh zoned storage device, but may also be the result of a zone reset. In some implementations, an empty zone may have a designated location within the flash memory of the zoned storage device. In an implementation, the location of the empty zone may be chosen when the zone is first opened or first written to (or later if writes are buffered into memory). A zone may be in an open state either implicitly or explicitly, where a zone that is in an open state may be written to store data with write or append commands. In an implementation, a zone that is in an open state may also be written to using a copy command that copies data from a different zone. In some implementations, a zoned storage device may have a limit on the number of open zones at a particular time.

A zone in a closed state is a zone that has been partially written to, but has entered a closed state after issuing an explicit close operation. A zone in a closed state may be left available for future writes, but may reduce some of the run-time overhead consumed by keeping the zone in an open state. In implementations, a zoned storage device may have a limit on the number of closed zones at a particular time. A zone in a full state is a zone that is storing data and can no longer be written to. A zone may be in a full state either after writes have written data to the entirety of the zone or as a result of a zone finish operation. Prior to a finish operation, a zone may or may not have been completely written. After a finish operation, however, the zone may not be opened a written to further without first performing a zone reset operation.

The mapping from a zone to an erase block (or to a shingled track in an HDD) may be arbitrary, dynamic, and hidden from view. The process of opening a zone may be an operation that allows a new zone to be dynamically mapped to underlying storage of the zoned storage device, and then allows data to be written through appending writes into the zone until the zone reaches capacity. The zone can be finished at any point, after which further data may not be written into the zone. When the data stored at the zone is no longer needed, the zone can be reset which effectively deletes the zone's content from the zoned storage device, making the physical storage held by that zone available for the subsequent storage of data. Once a zone has been written and finished, the zoned storage device ensures that the data stored at the zone is not lost until the zone is reset. In the time between writing the data to the zone and the resetting of the zone, the zone may be moved around between shingle tracks or erase blocks as part of maintenance operations within the zoned storage device, such as by copying data to keep the data refreshed or to handle memory cell aging in an SSD.

In implementations utilizing an HDD, the resetting of the zone may allow the shingle tracks to be allocated to a new, opened zone that may be opened at some point in the future. In implementations utilizing an SSD, the resetting of the zone may cause the associated physical erase block(s) of the zone to be erased and subsequently reused for the storage of data. In some implementations, the zoned storage device may have a limit on the number of open zones at a point in time to reduce the amount of overhead dedicated to keeping zones open.

The operating system of the flash storage system may identify and maintain a list of allocation units across multiple flash drives of the flash storage system. The allocation units may be entire erase blocks or multiple erase blocks. The operating system may maintain a map or address range that directly maps addresses to erase blocks of the flash drives of the flash storage system.

Direct mapping to the erase blocks of the flash drives may be used to rewrite data and erase data. For example, the operations may be performed on one or more allocation units that include a first data and a second data where the first data is to be retained and the second data is no longer being used by the flash storage system. The operating system may initiate the process to write the first data to new locations within other allocation units and erasing the second data and marking the allocation units as being available for use for subsequent data. Thus, the process may only be performed by the higher level operating system of the flash storage system without an additional lower level process being performed by controllers of the flash drives.

Advantages of the process being performed only by the operating system of the flash storage system include increased reliability of the flash drives of the flash storage system as unnecessary or redundant write operations are not being performed during the process. One possible point of novelty here is the concept of initiating and controlling the process at the operating system of the flash storage system. In addition, the process can be controlled by the operating system across multiple flash drives. This is contrast to the process being performed by a storage controller of a flash drive.

A storage system can consist of two storage array controllers that share a set of drives for failover purposes, or it could consist of a single storage array controller that provides a storage service that utilizes multiple drives, or it could consist of a distributed network of storage array controllers each with some number of drives or some amount of Flash storage where the storage array controllers in the network collaborate to provide a complete storage service and collaborate on various aspects of a storage service including storage allocation and garbage collection.

FIG. 1C illustrates a third example system 117 for data storage in accordance with some implementations. System 117 (also referred to as “storage system” herein) includes numerous elements for purposes of illustration rather than limitation. It may be noted that system 117 may include the same, more, or fewer elements configured in the same or different manner in other implementations.

In one embodiment, system 117 includes a dual Peripheral Component Interconnect (‘PCI’) flash storage device 118 with separately addressable fast write storage. System 117 may include a storage device controller 119. In one embodiment, storage device controller 119A-D may be a CPU, ASIC, FPGA, or any other circuitry that may implement control structures necessary according to the present disclosure. In one embodiment, system 117 includes flash memory devices (e.g., including flash memory devices 120a-n), operatively coupled to various channels of the storage device controller 119. Flash memory devices 120a-n, may be presented to the controller 119A-D as an addressable collection of Flash pages, erase blocks, and/or control elements sufficient to allow the storage device controller 119A-D to program and retrieve various aspects of the Flash. In one embodiment, storage device controller 119A-D may perform operations on flash memory devices 120a-n including storing and retrieving data content of pages, arranging and erasing any blocks, tracking statistics related to the use and reuse of Flash memory pages, erase blocks, and cells, tracking and predicting error codes and faults within the Flash memory, controlling voltage levels associated with programming and retrieving contents of Flash cells, etc.

In one embodiment, system 117 may include RAM 121 to store separately addressable fast-write data. In one embodiment, RAM 121 may be one or more separate discrete devices. In another embodiment, RAM 121 may be integrated into storage device controller 119A-D or multiple storage device controllers. The RAM 121 may be utilized for other purposes as well, such as temporary program memory for a processing device (e.g., a CPU) in the storage device controller 119.

In one embodiment, system 117 may include a stored energy device 122, such as a rechargeable battery or a capacitor. Stored energy device 122 may store energy sufficient to power the storage device controller 119, some amount of the RAM (e.g., RAM 121), and some amount of Flash memory (e.g., Flash memory 120a-120n) for sufficient time to write the contents of RAM to Flash memory. In one embodiment, storage device controller 119A-D may write the contents of RAM to Flash Memory if the storage device controller detects loss of external power.

In one embodiment, system 117 includes two data communications links 123a, 123b. In one embodiment, data communications links 123a, 123b may be PCI interfaces. In another embodiment, data communications links 123a, 123b may be based on other communications standards (e.g., HyperTransport, InfiniBand, etc.). Data communications links 123a, 123b may be based on non-volatile memory express (‘NVMe’) or NVMe over fabrics (‘NVMf’) specifications that allow external connection to the storage device controller 119A-D from other components in the storage system 117. It should be noted that data communications links may be interchangeably referred to herein as PCI buses for convenience.

System 117 may also include an external power source (not shown), which may be provided over one or both data communications links 123a, 123b, or which may be provided separately. An alternative embodiment includes a separate Flash memory (not shown) dedicated for use in storing the content of RAM 121. The storage device controller 119A-D may present a logical device over a PCI bus which may include an addressable fast-write logical device, or a distinct part of the logical address space of the storage device 118, which may be presented as PCI memory or as persistent storage. In one embodiment, operations to store into the device are directed into the RAM 121. On power failure, the storage device controller 119A-D may write stored content associated with the addressable fast-write logical storage to Flash memory (e.g., Flash memory 120a-n) for long-term persistent storage.

In one embodiment, the logical device may include some presentation of some or all of the content of the Flash memory devices 120a-n, where that presentation allows a storage system including a storage device 118 (e.g., storage system 117) to directly address Flash memory pages and directly reprogram erase blocks from storage system components that are external to the storage device through the PCI bus. The presentation may also allow one or more of the external components to control and retrieve other aspects of the Flash memory including some or all of: tracking statistics related to use and reuse of Flash memory pages, erase blocks, and cells across all the Flash memory devices; tracking and predicting error codes and faults within and across the Flash memory devices; controlling voltage levels associated with programming and retrieving contents of Flash cells; etc.

In one embodiment, the stored energy device 122 may be sufficient to ensure completion of in-progress operations to the Flash memory devices 120a-120n stored energy device 122 may power storage device controller 119A-D and associated Flash memory devices (e.g., 120a-n) for those operations, as well as for the storing of fast-write RAM to Flash memory. Stored energy device 122 may be used to store accumulated statistics and other parameters kept and tracked by the Flash memory devices 120a-n and/or the storage device controller 119. Separate capacitors or stored energy devices (such as smaller capacitors near or embedded within the Flash memory devices themselves) may be used for some or all of the operations described herein.

Various schemes may be used to track and optimize the life span of the stored energy component, such as adjusting voltage levels over time, partially discharging the stored energy device 122 to measure corresponding discharge characteristics, etc. If the available energy decreases over time, the effective available capacity of the addressable fast-write storage may be decreased to ensure that it can be written safely based on the currently available stored energy.

FIG. 1D illustrates a third example storage system 124 for data storage in accordance with some implementations. In one embodiment, storage system 124 includes storage controllers 125a, 125b. In one embodiment, storage controllers 125a, 125b are operatively coupled to Dual PCI storage devices. Storage controllers 125a, 125b may be operatively coupled (e.g., via a storage network 130) to some number of host computers 127a-n.

In one embodiment, two storage controllers (e.g., 125a and 125b) provide storage services, such as a SCS) block storage array, a file server, an object server, a database or data analytics service, etc. The storage controllers 125a, 125b may provide services through some number of network interfaces (e.g., 126a-d) to host computers 127a-n outside of the storage system 124. Storage controllers 125a, 125b may provide integrated services or an application entirely within the storage system 124, forming a converged storage and compute system. The storage controllers 125a, 125b may utilize the fast write memory within or across storage devices 119a-d to journal in progress operations to ensure the operations are not lost on a power failure, storage controller removal, storage controller or storage system shutdown, or some fault of one or more software or hardware components within the storage system 124.

In one embodiment, storage controllers 125a, 125b operate as PCI masters to one or the other PCI buses 128a, 128b. In another embodiment, 128a and 128b may be based on other communications standards (e.g., HyperTransport, InfiniBand, etc.). Other storage system embodiments may operate storage controllers 125a, 125b as multi-masters for both PCI buses 128a, 128b. Alternately, a PCI/NVMe/NVMf switching infrastructure or fabric may connect multiple storage controllers. Some storage system embodiments may allow storage devices to communicate with each other directly rather than communicating only with storage controllers. In one embodiment, a storage device controller 119a may be operable under direction from a storage controller 125a to synthesize and transfer data to be stored into Flash memory devices from data that has been stored in RAM (e.g., RAM 121 of FIG. 1C). For example, a recalculated version of RAM content may be transferred after a storage controller has determined that an operation has fully committed across the storage system, or when fast-write memory on the device has reached a certain used capacity, or after a certain amount of time, to ensure improve safety of the data or to release addressable fast-write capacity for reuse. This mechanism may be used, for example, to avoid a second transfer over a bus (e.g., 128a, 128b) from the storage controllers 125a, 125b. In one embodiment, a recalculation may include compressing data, attaching indexing or other metadata, combining multiple data segments together, performing erasure code calculations, etc.

In one embodiment, under direction from a storage controller 125a, 125b, a storage device controller 119a, 119b may be operable to calculate and transfer data to other storage devices from data stored in RAM (e.g., RAM 121 of FIG. 1C) without involvement of the storage controllers 125a, 125b. This operation may be used to mirror data stored in one storage controller 125a to another storage controller 125b, or it could be used to offload compression, data aggregation, and/or erasure coding calculations and transfers to storage devices to reduce load on storage controllers or the storage controller interface 129a, 129b to the PCI bus 128a, 128b.

A storage device controller 119A-D may include mechanisms for implementing high availability primitives for use by other parts of a storage system external to the Dual PCI storage device 118. For example, reservation or exclusion primitives may be provided so that, in a storage system with two storage controllers providing a highly available storage service, one storage controller may prevent the other storage controller from accessing or continuing to access the storage device. This could be used, for example, in cases where one controller detects that the other controller is not functioning properly or where the interconnect between the two storage controllers may itself not be functioning properly.

In one embodiment, a storage system for use with Dual PCI direct mapped storage devices with separately addressable fast write storage includes systems that manage erase blocks or groups of erase blocks as allocation units for storing data on behalf of the storage service, or for storing metadata (e.g., indexes, logs, etc.) associated with the storage service, or for proper management of the storage system itself. Flash pages, which may be a few kilobytes in size, may be written as data arrives or as the storage system is to persist data for long intervals of time (e.g., above a defined threshold of time). To commit data more quickly, or to reduce the number of writes to the Flash memory devices, the storage controllers may first write data into the separately addressable fast write storage on one more storage devices.

In one embodiment, the storage controllers 125a, 125b may initiate the use of erase blocks within and across storage devices (e.g., 118) in accordance with an age and expected remaining lifespan of the storage devices, or based on other statistics. The storage controllers 125a, 125b may initiate garbage collection and data migration data between storage devices in accordance with pages that are no longer needed as well as to manage Flash page and erase block lifespans and to manage overall system performance.

In one embodiment, the storage system 124 may utilize mirroring and/or erasure coding schemes as part of storing data into addressable fast write storage and/or as part of writing data into allocation units associated with erase blocks. Erasure codes may be used across storage devices, as well as within erase blocks or allocation units, or within and across Flash memory devices on a single storage device, to provide redundancy against single or multiple storage device failures or to protect against internal corruptions of Flash memory pages resulting from Flash memory operations or from degradation of Flash memory cells. Mirroring and erasure coding at various levels may be used to recover from multiple types of failures that occur separately or in combination.

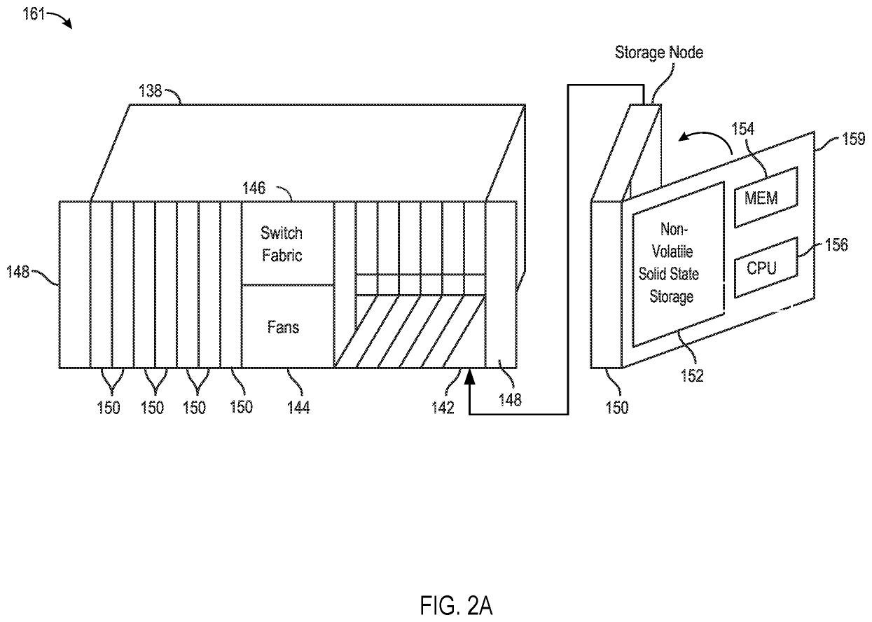

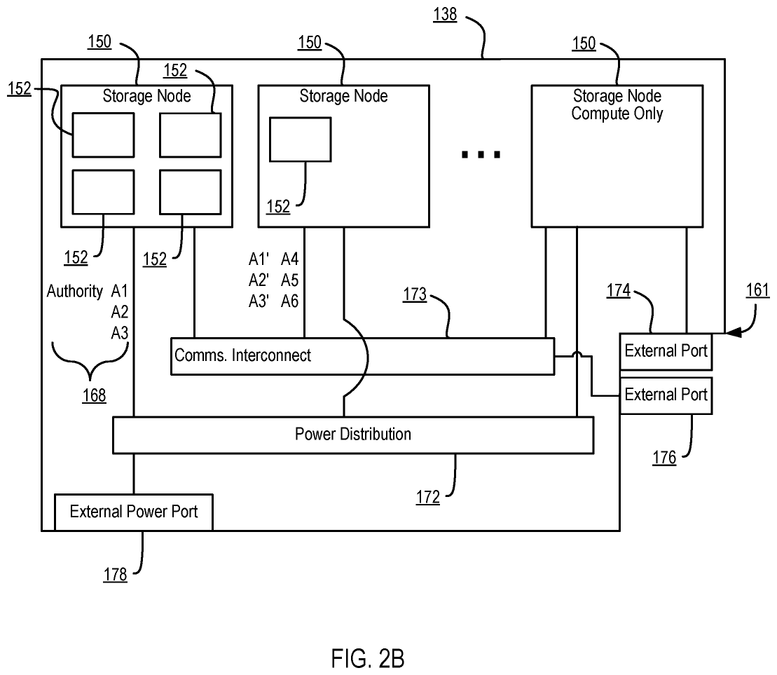

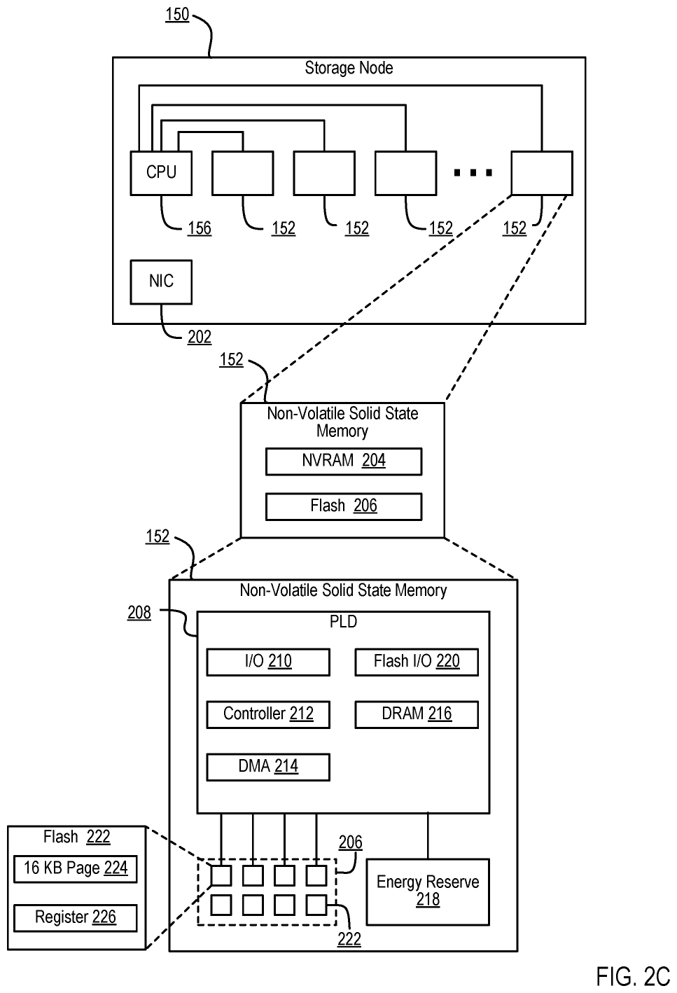

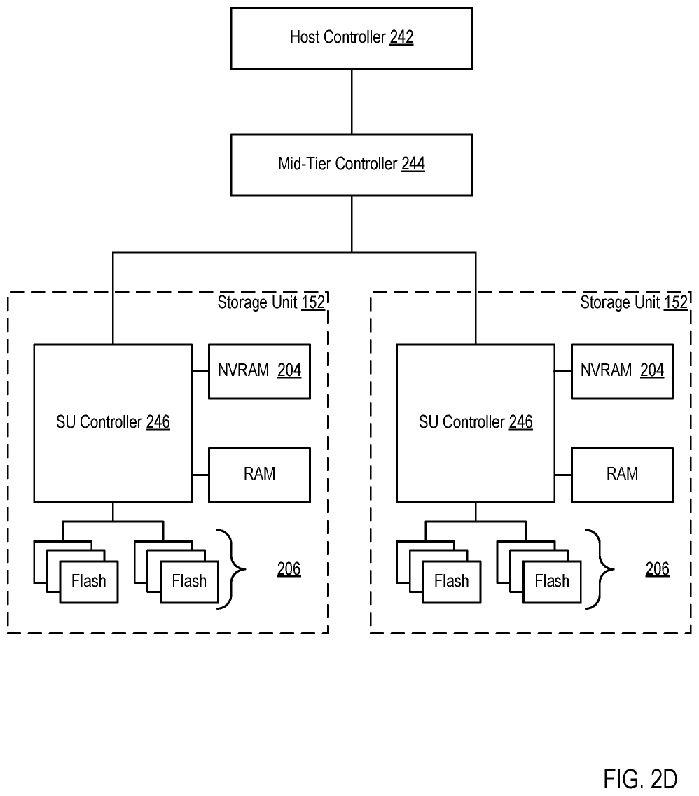

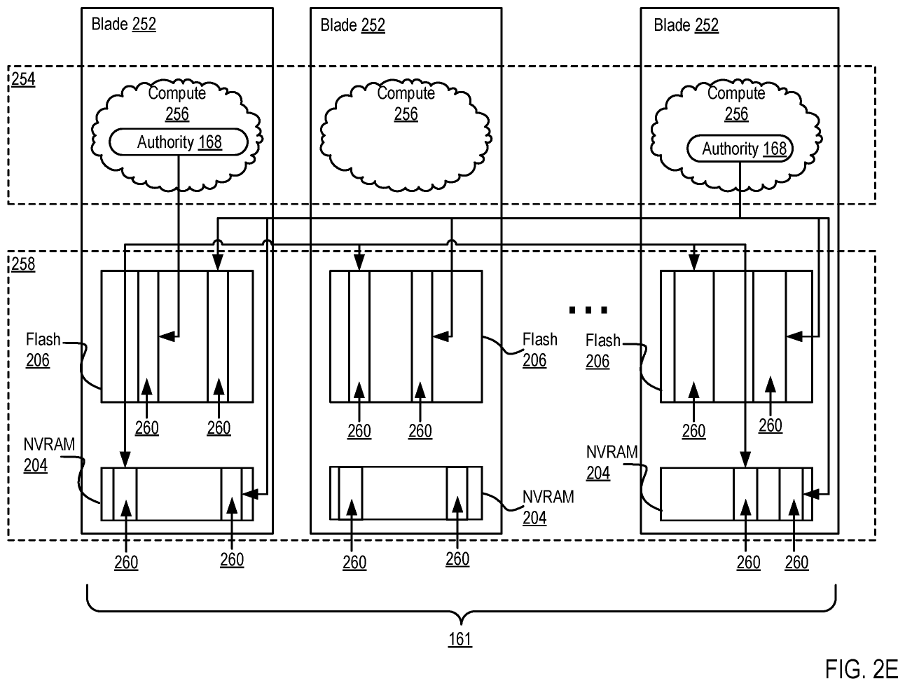

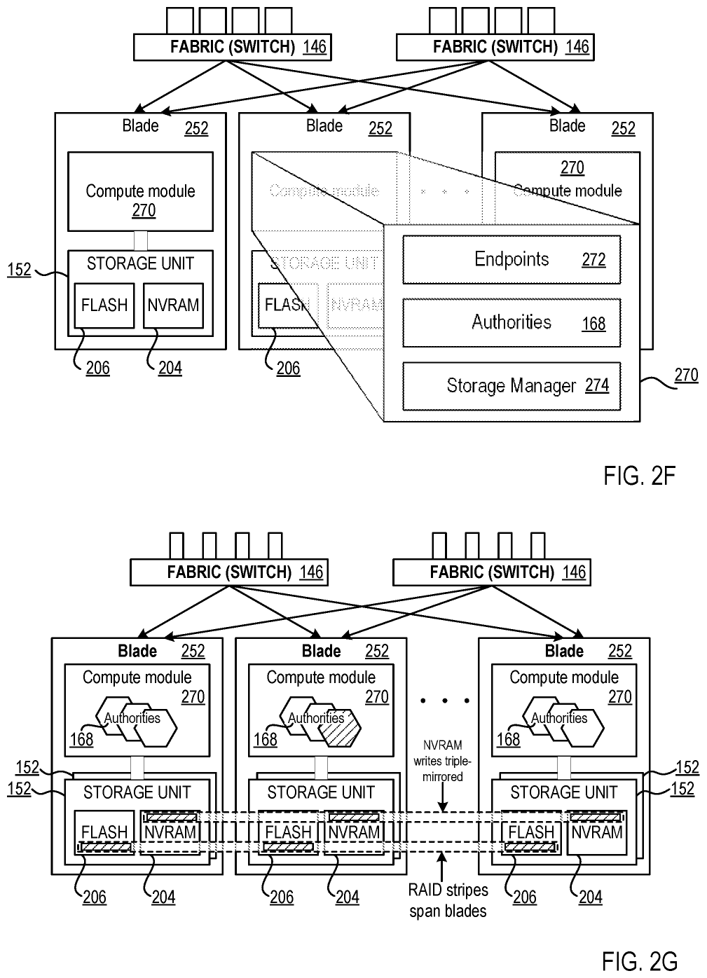

The embodiments depicted with reference to FIGS. 2A-G illustrate a storage cluster that stores user data, such as user data originating from one or more user or client systems or other sources external to the storage cluster. The storage cluster distributes user data across storage nodes housed within a chassis, or across multiple chassis, using erasure coding and redundant copies of metadata. Erasure coding refers to a method of data protection or reconstruction in which data is stored across a set of different locations, such as disks, storage nodes or geographic locations. Flash memory is one type of solid-state memory that may be integrated with the embodiments, although the embodiments may be extended to other types of solid-state memory or other storage medium, including non-solid state memory. Control of storage locations and workloads are distributed across the storage locations in a clustered peer-to-peer system. Tasks such as mediating communications between the various storage nodes, detecting when a storage node has become unavailable, and balancing I/Os (inputs and outputs) across the various storage nodes, are all handled on a distributed basis. Data is laid out or distributed across multiple storage nodes in data fragments or stripes that support data recovery in some embodiments. Ownership of data can be reassigned within a cluster, independent of input and output patterns. This architecture described in more detail below allows a storage node in the cluster to fail, with the system remaining operational, since the data can be reconstructed from other storage nodes and thus remain available for input and output operations. In various embodiments, a storage node may be referred to as a cluster node, a blade, or a server.

The storage cluster may be contained within a chassis, i.e., an enclosure housing one or more storage nodes. A mechanism to provide power to each storage node, such as a power distribution bus, and a communication mechanism, such as a communication bus that enables communication between the storage nodes are included within the chassis. The storage cluster can run as an independent system in one location according to some embodiments. In one embodiment, a chassis contains at least two instances of both the power distribution and the communication bus which may be enabled or disabled independently. The internal communication bus may be an Ethernet bus, however, other technologies such as PCIe, InfiniBand, and others, are equally suitable. The chassis provides a port for an external communication bus for enabling communication between multiple chassis, directly or through a switch, and with client systems. The external communication may use a technology such as Ethernet, InfiniBand, Fibre Channel, etc. In some embodiments, the external communication bus uses different communication bus technologies for inter-chassis and client communication. If a switch is deployed within or between chassis, the switch may act as a translation between multiple protocols or technologies. When multiple chassis are connected to define a storage cluster, the storage cluster may be accessed by a client using either proprietary interfaces or standard interfaces such as network file system (‘NFS’), common internet file system (‘CIFS’), small computer system interface (‘SCSI’) or hypertext transfer protocol (‘HTTP’). Translation from the client protocol may occur at the switch, chassis external communication bus or within each storage node. In some embodiments, multiple chassis may be coupled or connected to each other through an aggregator switch. A portion and/or all of the coupled or connected chassis may be designated as a storage cluster. As discussed above, each chassis can have multiple blades, each blade has a media access control (‘MAC’) address, but the storage cluster is presented to an external network as having a single cluster IP address and a single MAC address in some embodiments.

Each storage node may be one or more storage servers and each storage server is connected to one or more non-volatile solid state memory units, which may be referred to as storage units or storage devices. One embodiment includes a single storage server in each storage node and between one to eight non-volatile solid state memory units, however this one example is not meant to be limiting. The storage server may include a processor, DRAM and interfaces for the internal communication bus and power distribution for each of the power buses. Inside the storage node, the interfaces and storage unit share a communication bus, e.g., PCI Express, in some embodiments. The non-volatile solid state memory units may directly access the internal communication bus interface through a storage node communication bus, or request the storage node to access the bus interface. The non-volatile solid state memory unit contains an embedded CPU, solid state storage controller, and a quantity of solid state mass storage, e.g., between 2-32 terabytes (‘TB’) in some embodiments. An embedded volatile storage medium, such as DRAM, and an energy reserve apparatus are included in the non-volatile solid state memory unit. In some embodiments, the energy reserve apparatus is a capacitor, super-capacitor, or battery that enables transferring a subset of DRAM contents to a stable storage medium in the case of power loss. In some embodiments, the non-volatile solid state memory unit is constructed with a storage class memory, such as phase change or magnetoresistive random access memory (‘MRAM’) that substitutes for DRAM and enables a reduced power hold-up apparatus.

One of many features of the storage nodes and non-volatile solid state storage is the ability to proactively rebuild data in a storage cluster. The storage nodes and non-volatile solid state storage can determine when a storage node or non-volatile solid state storage in the storage cluster is unreachable, independent of whether there is an attempt to read data involving that storage node or non-volatile solid state storage. The storage nodes and non-volatile solid state storage then cooperate to recover and rebuild the data in at least partially new locations. This constitutes a proactive rebuild, in that the system rebuilds data without waiting until the data is needed for a read access initiated from a client system employing the storage cluster. These and further details of the storage memory and operation thereof are discussed below.

FIG. 2A is a perspective view of a storage cluster 161, with multiple storage nodes 150 and internal solid-state memory coupled to each storage node to provide network attached storage or storage area network, in accordance with some embodiments. A network attached storage, storage area network, or a storage cluster, or other storage memory, could include one or more storage clusters 161, each having one or more storage nodes 150, in a flexible and reconfigurable arrangement of both the physical components and the amount of storage memory provided thereby. The storage cluster 161 is designed to fit in a rack, and one or more racks can be set up and populated as desired for the storage memory. The storage cluster 161 has a chassis 138 having multiple slots 142. It should be appreciated that chassis 138 may be referred to as a housing, enclosure, or rack unit. In one embodiment, the chassis 138 has fourteen slots 142, although other numbers of slots are readily devised. For example, some embodiments have four slots, eight slots, sixteen slots, thirty-two slots, or other suitable number of slots. Each slot 142 can accommodate one storage node 150 in some embodiments. Chassis 138 includes flaps 148 that can be utilized to mount the chassis 138 on a rack. Fans 144 provide air circulation for cooling of the storage nodes 150 and components thereof, although other cooling components could be used, or an embodiment could be devised without cooling components. A switch fabric 146 couples storage nodes 150 within chassis 138 together and to a network for communication to the memory. In an embodiment depicted in herein, the slots 142 to the left of the switch fabric 146 and fans 144 are shown occupied by storage nodes 150, while the slots 142 to the right of the switch fabric 146 and fans 144 are empty and available for insertion of storage node 150 for illustrative purposes. This configuration is one example, and one or more storage nodes 150 could occupy the slots 142 in various further arrangements. The storage node arrangements need not be sequential or adjacent in some embodiments. Storage nodes 150 are hot pluggable, meaning that a storage node 150 can be inserted into a slot 142 in the chassis 138, or removed from a slot 142, without stopping or powering down the system. Upon insertion or removal of storage node 150 from slot 142, the system automatically reconfigures in order to recognize and adapt to the change. Reconfiguration, in some embodiments, includes restoring redundancy and/or rebalancing data or load.

Each storage node 150 can have multiple components. In the embodiment shown here, the storage node 150 includes a printed circuit board 159 populated by a CPU 156, i.e., processor, a memory 154 coupled to the CPU 156, and a non-volatile solid state storage 152 coupled to the CPU 156, although other mountings and/or components could be used in further embodiments. The memory 154 has instructions which are executed by the CPU 156 and/or data operated on by the CPU 156. As further explained below, the non-volatile solid state storage 152 includes flash or, in further embodiments, other types of solid-state memory.

Referring to FIG. 2A, storage cluster 161 is scalable, meaning that storage capacity with non-uniform storage sizes is readily added, as described above. One or more storage nodes 150 can be plugged into or removed from each chassis and the storage cluster self-configures in some embodiments. Plug-in storage nodes 150, whether installed in a chassis as delivered or later added, can have different sizes. For example, in one embodiment a storage node 150 can have any multiple of 4 TB, e.g., 8 TB, 12 TB, 16 TB, 32 TB, etc. In further embodiments, a storage node 150 could have any multiple of other storage amounts or capacities. Storage capacity of each storage node 150 is broadcast, and influences decisions of how to stripe the data. For maximum storage efficiency, an embodiment can self-configure as wide as possible in the stripe, subject to a predetermined requirement of continued operation with loss of up to one, or up to two, non-volatile solid state storage 152 units or storage nodes 150 within the chassis.

FIG. 2B is a block diagram showing a communications interconnect 173 and power distribution bus 172 coupling multiple storage nodes 150. Referring back to FIG. 2A, the communications interconnect 173 can be included in or implemented with the switch fabric 146 in some embodiments. Where multiple storage clusters 161 occupy a rack, the communications interconnect 173 can be included in or implemented with a top of rack switch, in some embodiments. As illustrated in FIG. 2B, storage cluster 161 is enclosed within a single chassis 138. External port 176 is coupled to storage nodes 150 through communications interconnect 173, while external port 174 is coupled directly to a storage node. External power port 178 is coupled to power distribution bus 172. Storage nodes 150 may include varying amounts and differing capacities of non-volatile solid state storage 152 as described with reference to FIG. 2A. In addition, one or more storage nodes 150 may be a compute only storage node as illustrated in FIG. 2B. Authorities 168 are implemented on the non-volatile solid state storage 152, for example as lists or other data structures stored in memory. In some embodiments the authorities are stored within the non-volatile solid state storage 152 and supported by software executing on a controller or other processor of the non-volatile solid state storage 152. In a further embodiment, authorities 168 are implemented on the storage nodes 150, for example as lists or other data structures stored in the memory 154 and supported by software executing on the CPU 156 of the storage node 150. Authorities 168 control how and where data is stored in the non-volatile solid state storage 152 in some embodiments. This control assists in determining which type of erasure coding scheme is applied to the data, and which storage nodes 150 have which portions of the data. Each authority 168 may be assigned to a non-volatile solid state storage 152. Each authority may control a range of inode numbers, segment numbers, or other data identifiers which are assigned to data by a file system, by the storage nodes 150, or by the non-volatile solid state storage 152, in various embodiments.

Every piece of data, and every piece of metadata, has redundancy in the system in some embodiments. In addition, every piece of data and every piece of metadata has an owner, which may be referred to as an authority. If that authority is unreachable, for example through failure of a storage node, there is a plan of succession for how to find that data or that metadata. In various embodiments, there are redundant copies of authorities 168. Authorities 168 have a relationship to storage nodes 150 and non-volatile solid state storage 152 in some embodiments. Each authority 168, covering a range of data segment numbers or other identifiers of the data, may be assigned to a specific non-volatile solid state storage 152. In some embodiments the authorities 168 for all of such ranges are distributed over the non-volatile solid state storage 152 of a storage cluster. Each storage node 150 has a network port that provides access to the non-volatile solid state storage(s) 152 of that storage node 150. Data can be stored in a segment, which is associated with a segment number and that segment number is an indirection for a configuration of a RAID (redundant array of independent disks) stripe in some embodiments. The assignment and use of the authorities 168 thus establishes an indirection to data. Indirection may be referred to as the ability to reference data indirectly, in this case via an authority 168, in accordance with some embodiments. A segment identifies a set of non-volatile solid state storage 152 and a local identifier into the set of non-volatile solid state storage 152 that may contain data. In some embodiments, the local identifier is an offset into the device and may be reused sequentially by multiple segments. In other embodiments the local identifier is unique for a specific segment and never reused. The offsets in the non-volatile solid state storage 152 are applied to locating data for writing to or reading from the non-volatile solid state storage 152 (in the form of a RAID stripe). Data is striped across multiple units of non-volatile solid state storage 152, which may include or be different from the non-volatile solid state storage 152 having the authority 168 for a particular data segment.

If there is a change in where a particular segment of data is located, e.g., during a data move or a data reconstruction, the authority 168 for that data segment should be consulted, at that non-volatile solid state storage 152 or storage node 150 having that authority 168. In order to locate a particular piece of data, embodiments calculate a hash value for a data segment or apply an inode number or a data segment number. The output of this operation points to a non-volatile solid state storage 152 having the authority 168 for that particular piece of data. In some embodiments there are two stages to this operation. The first stage maps an entity identifier (ID), e.g., a segment number, inode number, or directory number to an authority identifier. This mapping may include a calculation such as a hash or a bit mask. The second stage is mapping the authority identifier to a particular non-volatile solid state storage 152, which may be done through an explicit mapping. The operation is repeatable, so that when the calculation is performed, the result of the calculation repeatably and reliably points to a particular non-volatile solid state storage 152 having that authority 168. The operation may include the set of reachable storage nodes as input. If the set of reachable non-volatile solid state storage units changes the optimal set changes. In some embodiments, the persisted value is the current assignment (which is always true) and the calculated value is the target assignment the cluster will attempt to reconfigure towards. This calculation may be used to determine the optimal non-volatile solid state storage 152 for an authority in the presence of a set of non-volatile solid state storage 152 that are reachable and constitute the same cluster. The calculation also determines an ordered set of peer non-volatile solid state storage 152 that will also record the authority to non-volatile solid state storage mapping so that the authority may be determined even if the assigned non-volatile solid state storage is unreachable. A duplicate or substitute authority 168 may be consulted if a specific authority 168 is unavailable in some embodiments.

With reference to FIGS. 2A and 2B, two of the many tasks of the CPU 156 on a storage node 150 are to break up write data, and reassemble read data. When the system has determined that data is to be written, the authority 168 for that data is located as above. When the segment ID for data is already determined the request to write is forwarded to the non-volatile solid state storage 152 currently determined to be the host of the authority 168 determined from the segment. The host CPU 156 of the storage node 150, on which the non-volatile solid state storage 152 and corresponding authority 168 reside, then breaks up or shards the data and transmits the data out to various non-volatile solid state storage 152. The transmitted data is written as a data stripe in accordance with an erasure coding scheme. In some embodiments, data is requested to be pulled, and in other embodiments, data is pushed. In reverse, when data is read, the authority 168 for the segment ID containing the data is located as described above. The host CPU 156 of the storage node 150 on which the non-volatile solid state storage 152 and corresponding authority 168 reside requests the data from the non-volatile solid state storage and corresponding storage nodes pointed to by the authority. In some embodiments the data is read from flash storage as a data stripe. The host CPU 156 of storage node 150 then reassembles the read data, correcting any errors (if present) according to the appropriate erasure coding scheme, and forwards the reassembled data to the network. In further embodiments, some or all of these tasks can be handled in the non-volatile solid state storage 152. In some embodiments, the segment host requests the data be sent to storage node 150 by requesting pages from storage and then sending the data to the storage node making the original request.

In embodiments, authorities 168 operate to determine how operations will proceed against particular logical elements. Each of the logical elements may be operated on through a particular authority across a plurality of storage controllers of a storage system. The authorities 168 may communicate with the plurality of storage controllers so that the plurality of storage controllers collectively perform operations against those particular logical elements.

In embodiments, logical elements could be, for example, files, directories, object buckets, individual objects, delineated parts of files or objects, other forms of key-value pair databases, or tables. In embodiments, performing an operation can involve, for example, ensuring consistency, structural integrity, and/or recoverability with other operations against the same logical element, reading metadata and data associated with that logical element, determining what data should be written durably into the storage system to persist any changes for the operation, or where metadata and data can be determined to be stored across modular storage devices attached to a plurality of the storage controllers in the storage system.

In some embodiments the operations are token based transactions to efficiently communicate within a distributed system. Each transaction may be accompanied by or associated with a token, which gives permission to execute the transaction. The authorities 168 are able to maintain a pre-transaction state of the system until completion of the operation in some embodiments. The token based communication may be accomplished without a global lock across the system, and also enables restart of an operation in case of a disruption or other failure.

In some systems, for example in UNIX-style file systems, data is handled with an index node or inode, which specifies a data structure that represents an object in a file system. The object could be a file or a directory, for example. Metadata may accompany the object, as attributes such as permission data and a creation timestamp, among other attributes. A segment number could be assigned to all or a portion of such an object in a file system. In other systems, data segments are handled with a segment number assigned elsewhere. For purposes of discussion, the unit of distribution is an entity, and an entity can be a file, a directory or a segment. That is, entities are units of data or metadata stored by a storage system. Entities are grouped into sets called authorities. Each authority has an authority owner, which is a storage node that has the exclusive right to update the entities in the authority. In other words, a storage node contains the authority, and that the authority, in turn, contains entities.

A segment is a logical container of data in accordance with some embodiments. A segment is an address space between medium address space and physical flash locations, i.e., the data segment number, are in this address space. Segments may also contain meta-data, which enable data redundancy to be restored (rewritten to different flash locations or devices) without the involvement of higher level software. In one embodiment, an internal format of a segment contains client data and medium mappings to determine the position of that data. Each data segment is protected, e.g., from memory and other failures, by breaking the segment into a number of data and parity shards, where applicable. The data and parity shards are distributed, i.e., striped, across non-volatile solid state storage 152 coupled to the host CPUs 156 (See FIGS. 2E and 2G) in accordance with an erasure coding scheme. Usage of the term segments refers to the container and its place in the address space of segments in some embodiments. Usage of the term stripe refers to the same set of shards as a segment and includes how the shards are distributed along with redundancy or parity information in accordance with some embodiments.

A series of address-space transformations takes place across an entire storage system. At the top are the directory entries (file names) which link to an inode. Inodes point into medium address space, where data is logically stored. Medium addresses may be mapped through a series of indirect mediums to spread the load of large files, or implement data services like deduplication or snapshots. Medium addresses may be mapped through a series of indirect mediums to spread the load of large files, or implement data services like deduplication or snapshots. Segment addresses are then translated into physical flash locations. Physical flash locations have an address range bounded by the amount of flash in the system in accordance with some embodiments. Medium addresses and segment addresses are logical containers, and in some embodiments use a 128 bit or larger identifier so as to be practically infinite, with a likelihood of reuse calculated as longer than the expected life of the system. Addresses from logical containers are allocated in a hierarchical fashion in some embodiments. Initially, each non-volatile solid state storage 152 unit may be assigned a range of address space. Within this assigned range, the non-volatile solid state storage 152 is able to allocate addresses without synchronization with other non-volatile solid state storage 152.

Data and metadata is stored by a set of underlying storage layouts that are optimized for varying workload patterns and storage devices. These layouts incorporate multiple redundancy schemes, compression formats and index algorithms. Some of these layouts store information about authorities and authority masters, while others store file metadata and file data. The redundancy schemes include error correction codes that tolerate corrupted bits within a single storage device (such as a NAND flash chip), erasure codes that tolerate the failure of multiple storage nodes, and replication schemes that tolerate data center or regional failures. In some embodiments, low density parity check (‘LDPC’) code is used within a single storage unit. Reed-Solomon encoding is used within a storage cluster, and mirroring is used within a storage grid in some embodiments. Metadata may be stored using an ordered log structured index (such as a Log Structured Merge Tree), and large data may not be stored in a log structured layout.

In order to maintain consistency across multiple copies of an entity, the storage nodes agree implicitly on two things through calculations: (1) the authority that contains the entity, and (2) the storage node that contains the authority. The assignment of entities to authorities can be done by pseudo randomly assigning entities to authorities, by splitting entities into ranges based upon an externally produced key, or by placing a single entity into each authority. Examples of pseudorandom schemes are linear hashing and the Replication Under Scalable Hashing (‘RUSH’) family of hashes, including Controlled Replication Under Scalable Hashing (‘CRUSH’). In some embodiments, pseudo-random assignment is utilized only for assigning authorities to nodes because the set of nodes can change. The set of authorities cannot change so any subjective function may be applied in these embodiments. Some placement schemes automatically place authorities on storage nodes, while other placement schemes rely on an explicit mapping of authorities to storage nodes. In some embodiments, a pseudorandom scheme is utilized to map from each authority to a set of candidate authority owners. A pseudorandom data distribution function related to CRUSH may assign authorities to storage nodes and create a list of where the authorities are assigned. Each storage node has a copy of the pseudorandom data distribution function, and can arrive at the same calculation for distributing, and later finding or locating an authority. Each of the pseudorandom schemes requires the reachable set of storage nodes as input in some embodiments in order to conclude the same target nodes. Once an entity has been placed in an authority, the entity may be stored on physical devices so that no expected failure will lead to unexpected data loss. In some embodiments, rebalancing algorithms attempt to store the copies of all entities within an authority in the same layout and on the same set of machines.

Examples of expected failures include device failures, stolen machines, datacenter fires, and regional disasters, such as nuclear or geological events. Different failures lead to different levels of acceptable data loss. In some embodiments, a stolen storage node impacts neither the security nor the reliability of the system, while depending on system configuration, a regional event could lead to no loss of data, a few seconds or minutes of lost updates, or even complete data loss.

In the embodiments, the placement of data for storage redundancy is independent of the placement of authorities for data consistency. In some embodiments, storage nodes that contain authorities do not contain any persistent storage. Instead, the storage nodes are connected to non-volatile solid state storage units that do not contain authorities. The communications interconnect between storage nodes and non-volatile solid state storage units consists of multiple communication technologies and has non-uniform performance and fault tolerance characteristics. In some embodiments, as mentioned above, non-volatile solid state storage units are connected to storage nodes via PCI express, storage nodes are connected together within a single chassis using Ethernet backplane, and chassis are connected together to form a storage cluster. Storage clusters are connected to clients using Ethernet or fiber channel in some embodiments. If multiple storage clusters are configured into a storage grid, the multiple storage clusters are connected using the Internet or other long-distance networking links, such as a “metro scale” link or private link that does not traverse the internet.

Authority owners have the exclusive right to modify entities, to migrate entities from one non-volatile solid state storage unit to another non-volatile solid state storage unit, and to add and remove copies of entities. This allows for maintaining the redundancy of the underlying data. When an authority owner fails, is going to be decommissioned, or is overloaded, the authority is transferred to a new storage node. Transient failures make it non-trivial to ensure that all non-faulty machines agree upon the new authority location. The ambiguity that arises due to transient failures can be achieved automatically by a consensus protocol such as Paxos, hot-warm failover schemes, via manual intervention by a remote system administrator, or by a local hardware administrator (such as by physically removing the failed machine from the cluster, or pressing a button on the failed machine). In some embodiments, a consensus protocol is used, and failover is automatic. If too many failures or replication events occur in too short a time period, the system goes into a self-preservation mode and halts replication and data movement activities until an administrator intervenes in accordance with some embodiments.

As authorities are transferred between storage nodes and authority owners update entities in their authorities, the system transfers messages between the storage nodes and non-volatile solid state storage units. With regard to persistent messages, messages that have different purposes are of different types. Depending on the type of the message, the system maintains different ordering and durability guarantees. As the persistent messages are being processed, the messages are temporarily stored in multiple durable and non-durable storage hardware technologies. In some embodiments, messages are stored in RAM, NVRAM and on NAND flash devices, and a variety of protocols are used in order to make efficient use of each storage medium. Latency-sensitive client requests may be persisted in replicated NVRAM, and then later NAND, while background rebalancing operations are persisted directly to NAND.

Persistent messages are persistently stored prior to being transmitted. This allows the system to continue to serve client requests despite failures and component replacement. Although many hardware components contain unique identifiers that are visible to system administrators, manufacturer, hardware supply chain and ongoing monitoring quality control infrastructure, applications running on top of the infrastructure address virtualize addresses. These virtualized addresses do not change over the lifetime of the storage system, regardless of component failures and replacements. This allows each component of the storage system to be replaced over time without reconfiguration or disruptions of client request processing, i.e., the system supports non-disruptive upgrades.

In some embodiments, the virtualized addresses are stored with sufficient redundancy. A continuous monitoring system correlates hardware and software status and the hardware identifiers. This allows detection and prediction of failures due to faulty components and manufacturing details. The monitoring system also enables the proactive transfer of authorities and entities away from impacted devices before failure occurs by removing the component from the critical path in some embodiments.

FIG. 2C is a multiple level block diagram, showing contents of a storage node 150 and contents of a non-volatile solid state storage 152 of the storage node 150. Data is communicated to and from the storage node 150 by a network interface controller (‘NIC’) 202 in some embodiments. Each storage node 150 has a CPU 156, and one or more non-volatile solid state storage 152, as discussed above. Moving down one level in FIG. 2C, each non-volatile solid state storage 152 has a relatively fast non-volatile solid state memory, such as nonvolatile random access memory (‘NVRAM’) 204, and flash memory 206. In some embodiments, NVRAM 204 may be a component that does not require program/erase cycles (DRAM, MRAM, PCM), and can be a memory that can support being written vastly more often than the memory is read from. Moving down another level in FIG. 2C, the NVRAM 204 is implemented in one embodiment as high speed volatile memory, such as dynamic random access memory (DRAM) 216, backed up by energy reserve 218. Energy reserve 218 provides sufficient electrical power to keep the DRAM 216 powered long enough for contents to be transferred to the flash memory 206 in the event of power failure. In some embodiments, energy reserve 218 is a capacitor, super-capacitor, battery, or other device, that supplies a suitable supply of energy sufficient to enable the transfer of the contents of DRAM 216 to a stable storage medium in the case of power loss. The flash memory 206 is implemented as multiple flash dies 222, which may be referred to as packages of flash dies 222 or an array of flash dies 222. It should be appreciated that the flash dies 222 could be packaged in any number of ways, with a single die per package, multiple dies per package (i.e., multichip packages), in hybrid packages, as bare dies on a printed circuit board or other substrate, as encapsulated dies, etc. In the embodiment shown, the non-volatile solid state storage 152 has a controller 212 or other processor, and an input output (I/O) port 210 coupled to the controller 212. I/O port 210 is coupled to the CPU 156 and/or the network interface controller 202 of the flash storage node 150. Flash input output (I/O) port 220 is coupled to the flash dies 222, and a direct memory access unit (DMA) 214 is coupled to the controller 212, the DRAM 216 and the flash dies 222. In the embodiment shown, the I/O port 210, controller 212, DMA unit 214 and flash I/O port 220 are implemented on a programmable logic device (‘PLD’) 208, e.g., an FPGA. In this embodiment, each flash die 222 has pages, organized as sixteen kB (kilobyte) pages 224, and a register 226 through which data can be written to or read from the flash die 222. In further embodiments, other types of solid-state memory are used in place of, or in addition to flash memory illustrated within flash die 222.

Storage clusters 161, in various embodiments as disclosed herein, can be contrasted with storage arrays in general. The storage nodes 150 are part of a collection that creates the storage cluster 161. Each storage node 150 owns a slice of data and computing required to provide the data. Multiple storage nodes 150 cooperate to store and retrieve the data. Storage memory or storage devices, as used in storage arrays in general, are less involved with processing and manipulating the data. Storage memory or storage devices in a storage array receive commands to read, write, or erase data. The storage memory or storage devices in a storage array are not aware of a larger system in which they are embedded, or what the data means. Storage memory or storage devices in storage arrays can include various types of storage memory, such as RAM, solid state drives, hard disk drives, etc. The non-volatile solid state storage 152 units described herein have multiple interfaces active simultaneously and serving multiple purposes. In some embodiments, some of the functionality of a storage node 150 is shifted into a storage unit 152, transforming the storage unit 152 into a combination of storage unit 152 and storage node 150. Placing computing (relative to storage data) into the storage unit 152 places this computing closer to the data itself. The various system embodiments have a hierarchy of storage node layers with different capabilities. By contrast, in a storage array, a controller owns and knows everything about all of the data that the controller manages in a shelf or storage devices. In a storage cluster 161, as described herein, multiple controllers in multiple non-volatile sold state storage 152 units and/or storage nodes 150 cooperate in various ways (e.g., for erasure coding, data sharding, metadata communication and redundancy, storage capacity expansion or contraction, data recovery, and so on).

FIG. 2D shows a storage server environment, which uses embodiments of the storage nodes 150 and storage 152 units of FIGS. 2A-C. In this version, each non-volatile solid state storage 152 unit has a processor such as controller 212 (see FIG. 2C), an FPGA, flash memory 206, and NVRAM 204 (which is super-capacitor backed DRAM 216, see FIGS. 2B and 2C) on a PCIe (peripheral component interconnect express) board in a chassis 138 (see FIG. 2A). The non-volatile solid state storage 152 unit may be implemented as a single board containing storage, and may be the largest tolerable failure domain inside the chassis. In some embodiments, up to two non-volatile solid state storage 152 units may fail and the device will continue with no data loss.

The physical storage is divided into named regions based on application usage in some embodiments. The NVRAM 204 is a contiguous block of reserved memory in the non-volatile solid state storage 152 DRAM 216, and is backed by NAND flash. NVRAM 204 is logically divided into multiple memory regions written for two as spool (e.g., spool region). Space within the NVRAM 204 spools is managed by each authority 168 independently. Each device provides an amount of storage space to each authority 168. That authority 168 further manages lifetimes and allocations within that space. Examples of a spool include distributed transactions or notions. When the primary power to a non-volatile solid state storage 152 unit fails, onboard super-capacitors provide a short duration of power hold up. During this holdup interval, the contents of the NVRAM 204 are flushed to flash memory 206. On the next power-on, the contents of the NVRAM 204 are recovered from the flash memory 206.

As for the storage unit controller, the responsibility of the logical “controller” is distributed across each of the blades containing authorities 168. This distribution of logical control is shown in FIG. 2D as a host controller 242, mid-tier controller 244 and storage unit controller(s) 246. Management of the control plane and the storage plane are treated independently, although parts may be physically co-located on the same blade. Each authority 168 effectively serves as an independent controller. Each authority 168 provides its own data and metadata structures, its own background workers, and maintains its own lifecycle.

FIG. 2E is a blade 252 hardware block diagram, showing a control plane 254, compute and storage planes 256, 258, and authorities 168 interacting with underlying physical resources, using embodiments of the storage nodes 150 and storage units 152 of FIGS. 2A-C in the storage server environment of FIG. 2D. The control plane 254 is partitioned into a number of authorities 168 which can use the compute resources in the compute plane 256 to run on any of the blades 252. The storage plane 258 is partitioned into a set of devices, each of which provides access to flash 206 and NVRAM 204 resources. In one embodiment, the compute plane 256 may perform the operations of a storage array controller, as described herein, on one or more devices of the storage plane 258 (e.g., a storage array).

In the compute and storage planes 256, 258 of FIG. 2E, the authorities 168 interact with the underlying physical resources (i.e., devices). From the point of view of an authority 168, its resources are striped over all of the physical devices. From the point of view of a device, it provides resources to all authorities 168, irrespective of where the authorities happen to run. Each authority 168 has allocated or has been allocated one or more partitions 260 of storage memory in the storage units 152, e.g., partitions 260 in flash memory 206 and NVRAM 204. Each authority 168 uses those allocated partitions 260 that belong to it, for writing or reading user data. Authorities can be associated with differing amounts of physical storage of the system. For example, one authority 168 could have a larger number of partitions 260 or larger sized partitions 260 in one or more storage units 152 than one or more other authorities 168.

FIG. 2F depicts elasticity software layers in blades 252 of a storage cluster, in accordance with some embodiments. In the elasticity structure, elasticity software is symmetric, i.e., each blade's compute module 270 runs the three identical layers of processes depicted in FIG. 2F. Storage managers 274 execute read and write requests from other blades 252 for data and metadata stored in local storage unit 152 NVRAM 204 and flash 206. Authorities 168 fulfill client requests by issuing the necessary reads and writes to the blades 252 on whose storage units 152 the corresponding data or metadata resides. Endpoints 272 parse client connection requests received from switch fabric 146 supervisory software, relay the client connection requests to the authorities 168 responsible for fulfillment, and relay the authorities' 168 responses to clients. The symmetric three-layer structure enables the storage system's high degree of concurrency. Elasticity scales out efficiently and reliably in these embodiments. In addition, elasticity implements a unique scale-out technique that balances work evenly across all resources regardless of client access pattern, and maximizes concurrency by eliminating much of the need for inter-blade coordination that typically occurs with conventional distributed locking.

Still referring to FIG. 2F, authorities 168 running in the compute modules 270 of a blade 252 perform the internal operations required to fulfill client requests. One feature of elasticity is that authorities 168 are stateless, i.e., they cache active data and metadata in their own blades' 252 DRAMs for fast access, but the authorities store every update in their NVRAM 204 partitions on three separate blades 252 until the update has been written to flash 206. All the storage system writes to NVRAM 204 are in triplicate to partitions on three separate blades 252 in some embodiments. With triple-mirrored NVRAM 204 and persistent storage protected by parity and Reed-Solomon RAID checksums, the storage system can survive concurrent failure of two blades 252 with no loss of data, metadata, or access to either.

Because authorities 168 are stateless, they can migrate between blades 252. Each authority 168 has a unique identifier. NVRAM 204 and flash 206 partitions are associated with authorities' 168 identifiers, not with the blades 252 on which they are running in some. Thus, when an authority 168 migrates, the authority 168 continues to manage the same storage partitions from its new location. When a new blade 252 is installed in an embodiment of the storage cluster, the system automatically rebalances load by: partitioning the new blade's 252 storage for use by the system's authorities 168, migrating selected authorities 168 to the new blade 252, starting endpoints 272 on the new blade 252 and including them in the switch fabric's 146 client connection distribution algorithm.

From their new locations, migrated authorities 168 persist the contents of their NVRAM 204 partitions on flash 206, process read and write requests from other authorities 168, and fulfill the client requests that endpoints 272 direct to them. Similarly, if a blade 252 fails or is removed, the system redistributes its authorities 168 among the system's remaining blades 252. The redistributed authorities 168 continue to perform their original functions from their new locations.

FIG. 2G depicts authorities 168 and storage resources in blades 252 of a storage cluster, in accordance with some embodiments. Each authority 168 is exclusively responsible for a partition of the flash 206 and NVRAM 204 on each blade 252. The authority 168 manages the content and integrity of its partitions independently of other authorities 168. Authorities 168 compress incoming data and preserve it temporarily in their NVRAM 204 partitions, and then consolidate, RAID-protect, and persist the data in segments of the storage in their flash 206 partitions. As the authorities 168 write data to flash 206, storage managers 274 perform the necessary flash translation to optimize write performance and maximize media longevity. In the background, authorities 168 “garbage collect,” or reclaim space occupied by data that clients have made obsolete by overwriting the data. It should be appreciated that since authorities' 168 partitions are disjoint, there is no need for distributed locking to execute client and writes or to perform background functions.

The embodiments described herein may utilize various software, communication and/or networking protocols. In addition, the configuration of the hardware and/or software may be adjusted to accommodate various protocols. For example, the embodiments may utilize Active Directory, which is a database based system that provides authentication, directory, policy, and other services in a WINDOWS™ environment. In these embodiments, LDAP (Lightweight Directory Access Protocol) is one example application protocol for querying and modifying items in directory service providers such as Active Directory. In some embodiments, a network lock manager (‘NLM’) is utilized as a facility that works in cooperation with the Network File System (‘NFS’) to provide a System V style of advisory file and record locking over a network. The Server Message Block (‘SMB’) protocol, one version of which is also known as Common Internet File System (‘CIFS’), may be integrated with the storage systems discussed herein. SMP operates as an application-layer network protocol typically used for providing shared access to files, printers, and serial ports and miscellaneous communications between nodes on a network. SMB also provides an authenticated inter-process communication mechanism. AMAZON™ S3 (Simple Storage Service) is a web service offered by Amazon Web Services, and the systems described herein may interface with Amazon S3 through web services interfaces (REST (representational state transfer), SOAP (simple object access protocol), and BitTorrent). A RESTful API (application programming interface) breaks down a transaction to create a series of small modules. Each module addresses a particular underlying part of the transaction. The control or permissions provided with these embodiments, especially for object data, may include utilization of an access control list (‘ACL’). The ACL is a list of permissions attached to an object and the ACL specifies which users or system processes are granted access to objects, as well as what operations are allowed on given objects. The systems may utilize Internet Protocol version 6 (‘IPv6’), as well as IPv4, for the communications protocol that provides an identification and location system for computers on networks and routes traffic across the Internet. The routing of packets between networked systems may include Equal-cost multi-path routing (‘ECMP’), which is a routing strategy where next-hop packet forwarding to a single destination can occur over multiple “best paths” which tie for top place in routing metric calculations. Multi-path routing can be used in conjunction with most routing protocols, because it is a per-hop decision limited to a single router. The software may support Multi-tenancy, which is an architecture in which a single instance of a software application serves multiple customers. Each customer may be referred to as a tenant. Tenants may be given the ability to customize some parts of the application, but may not customize the application's code, in some embodiments. The embodiments may maintain audit logs. An audit log is a document that records an event in a computing system. In addition to documenting what resources were accessed, audit log entries typically include destination and source addresses, a timestamp, and user login information for compliance with various regulations. The embodiments may support various key management policies, such as encryption key rotation. In addition, the system may support dynamic root passwords or some variation dynamically changing passwords.

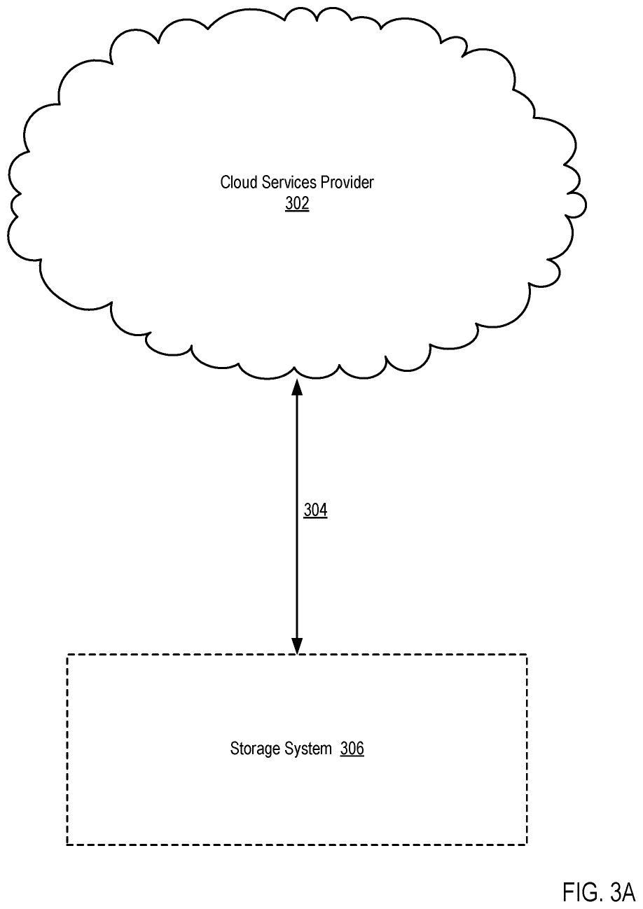

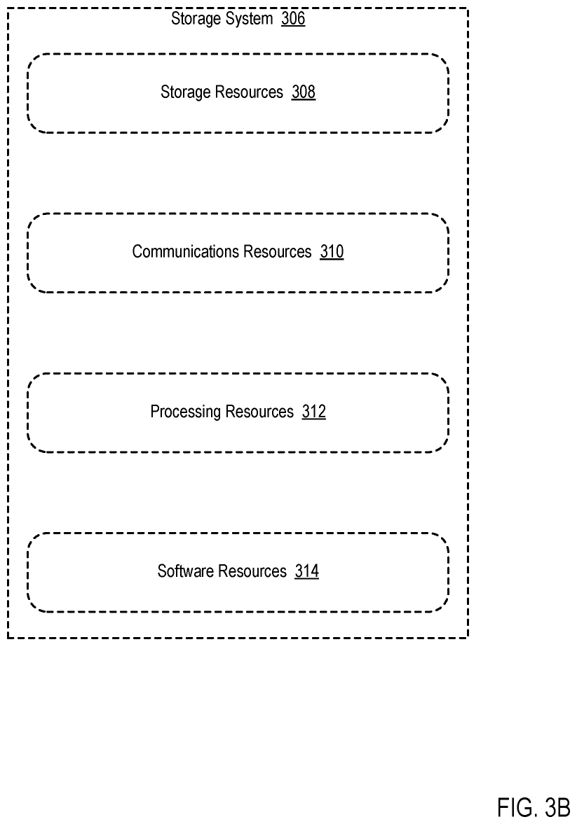

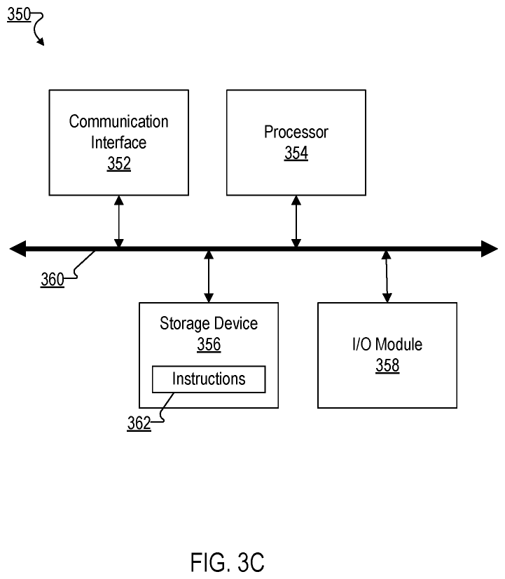

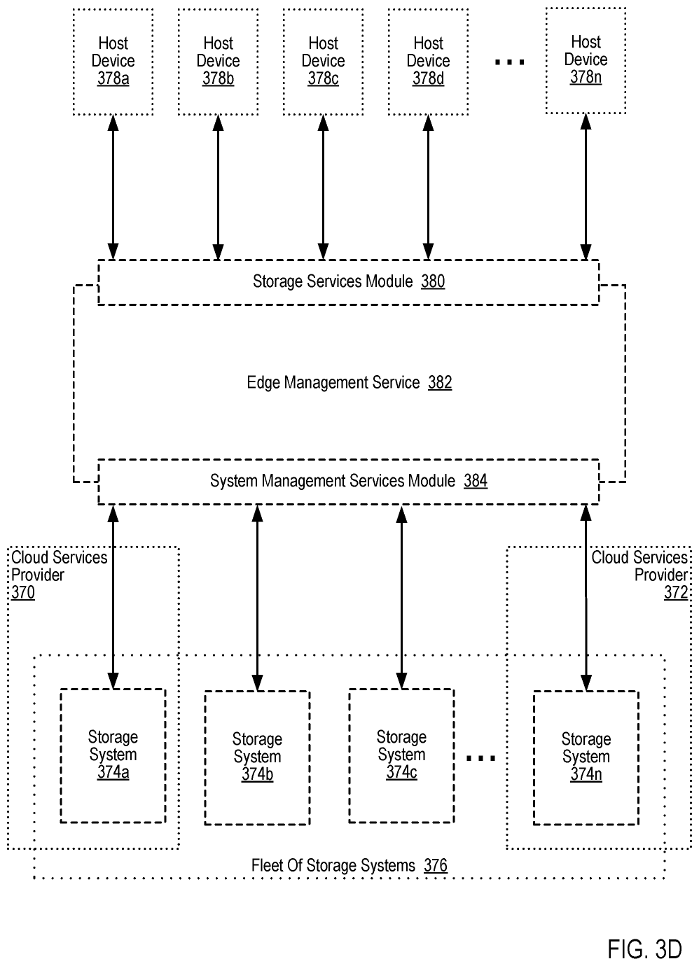

FIG. 3A sets forth a diagram of a storage system 306 that is coupled for data communications with a cloud services provider 302 in accordance with some embodiments of the present disclosure. Although depicted in less detail, the storage system 306 depicted in FIG. 3A may be similar to the storage systems described above with reference to FIGS. 1A-1D and FIGS. 2A-2G. In some embodiments, the storage system 306 depicted in FIG. 3A may be embodied as a storage system that includes imbalanced active/active controllers, as a storage system that includes balanced active/active controllers, as a storage system that includes active/active controllers where less than all of each controller's resources are utilized such that each controller has reserve resources that may be used to support failover, as a storage system that includes fully active/active controllers, as a storage system that includes dataset-segregated controllers, as a storage system that includes dual-layer architectures with front-end controllers and back-end integrated storage controllers, as a storage system that includes scale-out clusters of dual-controller arrays, as well as combinations of such embodiments.

In the example depicted in FIG. 3A, the storage system 306 is coupled to the cloud services provider 302 via a data communications link 304. The data communications link 304 may be embodied as a dedicated data communications link, as a data communications pathway that is provided through the use of one or data communications networks such as a wide area network (‘WAN’) or LAN, or as some other mechanism capable of transporting digital information between the storage system 306 and the cloud services provider 302. Such a data communications link 304 may be fully wired, fully wireless, or some aggregation of wired and wireless data communications pathways. In such an example, digital information may be exchanged between the storage system 306 and the cloud services provider 302 via the data communications link 304 using one or more data communications protocols. For example, digital information may be exchanged between the storage system 306 and the cloud services provider 302 via the data communications link 304 using the handheld device transfer protocol (‘HDTP’), hypertext transfer protocol (‘HTTP’), internet protocol (‘IP’), real-time transfer protocol (‘RTP’), transmission control protocol (‘TCP’), user datagram protocol (‘UDP’), wireless application protocol (‘WAP’), or other protocol.

The cloud services provider 302 depicted in FIG. 3A may be embodied, for example, as a system and computing environment that provides a vast array of services to users of the cloud services provider 302 through the sharing of computing resources via the data communications link 304. The cloud services provider 302 may provide on-demand access to a shared pool of configurable computing resources such as computer networks, servers, storage, applications and services, and so on. The shared pool of configurable resources may be rapidly provisioned and released to a user of the cloud services provider 302 with minimal management effort. Generally, the user of the cloud services provider 302 is unaware of the exact computing resources utilized by the cloud services provider 302 to provide the services. Although in many cases such a cloud services provider 302 may be accessible via the Internet, readers of skill in the art will recognize that any system that abstracts the use of shared resources to provide services to a user through any data communications link may be considered a cloud services provider 302.

In the example depicted in FIG. 3A, the cloud services provider 302 may be configured to provide a variety of services to the storage system 306 and users of the storage system 306 through the implementation of various service models. For example, the cloud services provider 302 may be configured to provide services through the implementation of an infrastructure as a service (‘IaaS’) service model, through the implementation of a platform as a service (‘PaaS’) service model, through the implementation of a software as a service (‘SaaS’) service model, through the implementation of an authentication as a service (‘AaaS’) service model, through the implementation of a storage as a service model where the cloud services provider 302 offers access to its storage infrastructure for use by the storage system 306 and users of the storage system 306, and so on. Readers will appreciate that the cloud services provider 302 may be configured to provide additional services to the storage system 306 and users of the storage system 306 through the implementation of additional service models, as the service models described above are included only for explanatory purposes and in no way represent a limitation of the services that may be offered by the cloud services provider 302 or a limitation as to the service models that may be implemented by the cloud services provider 302.

In the example depicted in FIG. 3A, the cloud services provider 302 may be embodied, for example, as a private cloud, as a public cloud, or as a combination of a private cloud and public cloud. In an embodiment in which the cloud services provider 302 is embodied as a private cloud, the cloud services provider 302 may be dedicated to providing services to a single organization rather than providing services to multiple organizations. In an embodiment where the cloud services provider 302 is embodied as a public cloud, the cloud services provider 302 may provide services to multiple organizations. In still alternative embodiments, the cloud services provider 302 may be embodied as a mix of a private and public cloud services with a hybrid cloud deployment.

Although not explicitly depicted in FIG. 3A, readers will appreciate that a vast amount of additional hardware components and additional software components may be necessary to facilitate the delivery of cloud services to the storage system 306 and users of the storage system 306. For example, the storage system 306 may be coupled to (or even include) a cloud storage gateway. Such a cloud storage gateway may be embodied, for example, as hardware-based or software-based appliance that is located on premise with the storage system 306. Such a cloud storage gateway may operate as a bridge between local applications that are executing on the storage system 306 and remote, cloud-based storage that is utilized by the storage system 306. Through the use of a cloud storage gateway, organizations may move primary iSCSI or NAS to the cloud services provider 302, thereby enabling the organization to save space on their on-premises storage systems. Such a cloud storage gateway may be configured to emulate a disk array, a block-based device, a file server, or other storage system that can translate the SCSI commands, file server commands, or other appropriate command into REST-space protocols that facilitate communications with the cloud services provider 302.

In order to enable the storage system 306 and users of the storage system 306 to make use of the services provided by the cloud services provider 302, a cloud migration process may take place during which data, applications, or other elements from an organization's local systems (or even from another cloud environment) are moved to the cloud services provider 302. In order to successfully migrate data, applications, or other elements to the cloud services provider's 302 environment, middleware such as a cloud migration tool may be utilized to bridge gaps between the cloud services provider's 302 environment and an organization's environment. Such cloud migration tools may also be configured to address potentially high network costs and long transfer times associated with migrating large volumes of data to the cloud services provider 302, as well as addressing security concerns associated with sensitive data to the cloud services provider 302 over data communications networks. In order to further enable the storage system 306 and users of the storage system 306 to make use of the services provided by the cloud services provider 302, a cloud orchestrator may also be used to arrange and coordinate automated tasks in pursuit of creating a consolidated process or workflow. Such a cloud orchestrator may perform tasks such as configuring various components, whether those components are cloud components or on-premises components, as well as managing the interconnections between such components. The cloud orchestrator can simplify the inter-component communication and connections to ensure that links are correctly configured and maintained.

In the example depicted in FIG. 3A, and as described briefly above, the cloud services provider 302 may be configured to provide services to the storage system 306 and users of the storage system 306 through the usage of a SaaS service model, eliminating the need to install and run the application on local computers, which may simplify maintenance and support of the application. Such applications may take many forms in accordance with various embodiments of the present disclosure. For example, the cloud services provider 302 may be configured to provide access to data analytics applications to the storage system 306 and users of the storage system 306. Such data analytics applications may be configured, for example, to receive vast amounts of telemetry data phoned home by the storage system 306. Such telemetry data may describe various operating characteristics of the storage system 306 and may be analyzed for a vast array of purposes including, for example, to determine the health of the storage system 306, to identify workloads that are executing on the storage system 306, to predict when the storage system 306 will run out of various resources, to recommend configuration changes, hardware or software upgrades, workflow migrations, or other actions that may improve the operation of the storage system 306.

The cloud services provider 302 may also be configured to provide access to virtualized computing environments to the storage system 306 and users of the storage system 306. Such virtualized computing environments may be embodied, for example, as a virtual machine or other virtualized computer hardware platforms, virtual storage devices, virtualized computer network resources, and so on. Examples of such virtualized environments can include virtual machines that are created to emulate an actual computer, virtualized desktop environments that separate a logical desktop from a physical machine, virtualized file systems that allow uniform access to different types of concrete file systems, and many others.

Although the example depicted in FIG. 3A illustrates the storage system 306 being coupled for data communications with the cloud services provider 302, in other embodiments the storage system 306 may be part of a hybrid cloud deployment in which private cloud elements (e.g., private cloud services, on-premises infrastructure, and so on) and public cloud elements (e.g., public cloud services, infrastructure, and so on that may be provided by one or more cloud services providers) are combined to form a single solution, with orchestration among the various platforms. Such a hybrid cloud deployment may leverage hybrid cloud management software such as, for example, Azure™ Arc from Microsoft™, that centralize the management of the hybrid cloud deployment to any infrastructure and enable the deployment of services anywhere. In such an example, the hybrid cloud management software may be configured to create, update, and delete resources (both physical and virtual) that form the hybrid cloud deployment, to allocate compute and storage to specific workloads, to monitor workloads and resources for performance, policy compliance, updates and patches, security status, or to perform a variety of other tasks.

Readers will appreciate that by pairing the storage systems described herein with one or more cloud services providers, various offerings may be enabled. For example, disaster recovery as a service (‘DRaaS’) may be provided where cloud resources are utilized to protect applications and data from disruption caused by disaster, including in embodiments where the storage systems may serve as the primary data store. In such embodiments, a total system backup may be taken that allows for business continuity in the event of system failure. In such embodiments, cloud data backup techniques (by themselves or as part of a larger DRaaS solution) may also be integrated into an overall solution that includes the storage systems and cloud services providers described herein.

The storage systems described herein, as well as the cloud services providers, may be utilized to provide a wide array of security features. For example, the storage systems may encrypt data at rest (and data may be sent to and from the storage systems encrypted) and may make use of Key Management-as-a-Service (‘KMaaS’) to manage encryption keys, keys for locking and unlocking storage devices, and so on. Likewise, cloud data security gateways or similar mechanisms may be utilized to ensure that data stored within the storage systems does not improperly end up being stored in the cloud as part of a cloud data backup operation. Furthermore, microsegmentation or identity-based-segmentation may be utilized in a data center that includes the storage systems or within the cloud services provider, to create secure zones in data centers and cloud deployments that enables the isolation of workloads from one another.

For further explanation, FIG. 3B sets forth a diagram of a storage system 306 in accordance with some embodiments of the present disclosure. Although depicted in less detail, the storage system 306 depicted in FIG. 3B may be similar to the storage systems described above with reference to FIGS. 1A-1D and FIGS. 2A-2G as the storage system may include many of the components described above.

The storage system 306 depicted in FIG. 3B may include a vast amount of storage resources 308, which may be embodied in many forms. For example, the storage resources 308 can include nano-RAM or another form of nonvolatile random access memory that utilizes carbon nanotubes deposited on a substrate, 3D crosspoint non-volatile memory, flash memory including single-level cell (‘SLC’) NAND flash, multi-level cell (‘MLC’) NAND flash, triple-level cell (‘TLC’) NAND flash, quad-level cell (‘QLC’) NAND flash, or others. Likewise, the storage resources 308 may include non-volatile magnetoresistive random-access memory (‘MRAM’), including spin transfer torque (‘STT’) MRAM. The example storage resources 308 may alternatively include non-volatile phase-change memory (‘PCM’), quantum memory that allows for the storage and retrieval of photonic quantum information, resistive random-access memory (‘ReRAM’), storage class memory (‘SCM’), or other form of storage resources, including any combination of resources described herein. Readers will appreciate that other forms of computer memories and storage devices may be utilized by the storage systems described above, including DRAM, SRAM, EEPROM, universal memory, and many others. The storage resources 308 depicted in FIG. 3A may be embodied in a variety of form factors, including but not limited to, dual in-line memory modules (‘DIMMs’), non-volatile dual in-line memory modules (‘NVDIMMs’), M.2, U.2, and others.

The storage resources 308 depicted in FIG. 3B may include various forms of SCM. SCM may effectively treat fast, non-volatile memory (e.g., NAND flash) as an extension of DRAM such that an entire dataset may be treated as an in-memory dataset that resides entirely in DRAM. SCM may include non-volatile media such as, for example, NAND flash. Such NAND flash may be accessed utilizing NVMe that can use the PCIe bus as its transport, providing for relatively low access latencies compared to older protocols. In fact, the network protocols used for SSDs in all-flash arrays can include NVMe using Ethernet (ROCE, NVME TCP), Fibre Channel (NVMe FC), InfiniBand (iWARP), and others that make it possible to treat fast, non-volatile memory as an extension of DRAM. In view of the fact that DRAM is often byte-addressable and fast, non-volatile memory such as NAND flash is block-addressable, a controller software/hardware stack may be needed to convert the block data to the bytes that are stored in the media. Examples of media and software that may be used as SCM can include, for example, 3D XPoint, Intel Memory Drive Technology, Samsung's Z-SSD, and others.

The storage resources 308 depicted in FIG. 3B may also include racetrack memory (also referred to as domain-wall memory). Such racetrack memory may be embodied as a form of non-volatile, solid-state memory that relies on the intrinsic strength and orientation of the magnetic field created by an electron as it spins in addition to its electronic charge, in solid-state devices. Through the use of spin-coherent electric current to move magnetic domains along a nanoscopic permalloy wire, the domains may pass by magnetic read/write heads positioned near the wire as current is passed through the wire, which alter the domains to record patterns of bits. In order to create a racetrack memory device, many such wires and read/write elements may be packaged together.

The example storage system 306 depicted in FIG. 3B may implement a variety of storage architectures. For example, storage systems in accordance with some embodiments of the present disclosure may utilize block storage where data is stored in blocks, and each block essentially acts as an individual hard drive. Storage systems in accordance with some embodiments of the present disclosure may utilize object storage, where data is managed as objects. Each object may include the data itself, a variable amount of metadata, and a globally unique identifier, where object storage can be implemented at multiple levels (e.g., device level, system level, interface level). Storage systems in accordance with some embodiments of the present disclosure utilize file storage in which data is stored in a hierarchical structure. Such data may be saved in files and folders, and presented to both the system storing it and the system retrieving it in the same format.

The example storage system 306 depicted in FIG. 3B may be embodied as a storage system in which additional storage resources can be added through the use of a scale-up model, additional storage resources can be added through the use of a scale-out model, or through some combination thereof. In a scale-up model, additional storage may be added by adding additional storage devices. In a scale-out model, however, additional storage nodes may be added to a cluster of storage nodes, where such storage nodes can include additional processing resources, additional networking resources, and so on.

The example storage system 306 depicted in FIG. 3B may leverage the storage resources described above in a variety of different ways. For example, some portion of the storage resources may be utilized to serve as a write cache, storage resources within the storage system may be utilized as a read cache, or tiering may be achieved within the storage systems by placing data within the storage system in accordance with one or more tiering policies.

The storage system 306 depicted in FIG. 3B also includes communications resources 310 that may be useful in facilitating data communications between components within the storage system 306, as well as data communications between the storage system 306 and computing devices that are outside of the storage system 306, including embodiments where those resources are separated by a relatively vast expanse. The communications resources 310 may be configured to utilize a variety of different protocols and data communication fabrics to facilitate data communications between components within the storage systems as well as computing devices that are outside of the storage system. For example, the communications resources 310 can include fibre channel (‘FC’) technologies such as FC fabrics and FC protocols that can transport SCSI commands over FC network, FC over ethernet (‘FCoE’) technologies through which FC frames are encapsulated and transmitted over Ethernet networks, InfiniBand (‘IB’) technologies in which a switched fabric topology is utilized to facilitate transmissions between channel adapters, NVM Express (‘NVMe’) technologies and NVMe over fabrics (‘NVMeoF’) technologies through which non-volatile storage media attached via a PCI express (‘PCIe’) bus may be accessed, and others. In fact, the storage systems described above may, directly or indirectly, make use of neutrino communication technologies and devices through which information (including binary information) is transmitted using a beam of neutrinos.

The communications resources 310 can also include mechanisms for accessing storage resources 308 within the storage system 306 utilizing serial attached SCSI (‘SAS’), serial ATA (‘SATA’) bus interfaces for connecting storage resources 308 within the storage system 306 to host bus adapters within the storage system 306, internet small computer systems interface (‘iSCSI’) technologies to provide block-level access to storage resources 308 within the storage system 306, and other communications resources that that may be useful in facilitating data communications between components within the storage system 306, as well as data communications between the storage system 306 and computing devices that are outside of the storage system 306.

The storage system 306 depicted in FIG. 3B also includes processing resources 312 that may be useful in useful in executing computer program instructions and performing other computational tasks within the storage system 306. The processing resources 312 may include one or more ASICs that are customized for some particular purpose as well as one or more CPUs. The processing resources 312 may also include one or more DSPs, one or more FPGAs, one or more systems on a chip (‘SoCs’), or other form of processing resources 312. The storage system 306 may utilize the storage resources 312 to perform a variety of tasks including, but not limited to, supporting the execution of software resources 314 that will be described in greater detail below.

The storage system 306 depicted in FIG. 3B also includes software resources 314 that, when executed by processing resources 312 within the storage system 306, may perform a vast array of tasks. The software resources 314 may include, for example, one or more modules of computer program instructions that when executed by processing resources 312 within the storage system 306 are useful in carrying out various data protection techniques. Such data protection techniques may be carried out, for example, by system software executing on computer hardware within the storage system, by a cloud services provider, or in other ways. Such data protection techniques can include data archiving, data backup, data replication, data snapshotting, data and database cloning, and other data protection techniques.

The software resources 314 may also include software that is useful in implementing software-defined storage (‘SDS’). In such an example, the software resources 314 may include one or more modules of computer program instructions that, when executed, are useful in policy-based provisioning and management of data storage that is independent of the underlying hardware. Such software resources 314 may be useful in implementing storage virtualization to separate the storage hardware from the software that manages the storage hardware.

The software resources 314 may also include software that is useful in facilitating and optimizing I/O operations that are directed to the storage system 306. For example, the software resources 314 may include software modules that perform various data reduction techniques such as, for example, data compression, data deduplication, and others. The software resources 314 may include software modules that intelligently group together I/O operations to facilitate better usage of the underlying storage resource 308, software modules that perform data migration operations to migrate from within a storage system, as well as software modules that perform other functions. Such software resources 314 may be embodied as one or more software containers or in many other ways.

The storage systems described above may carry out intelligent data backup techniques through which data stored in the storage system may be copied and stored in a distinct location to avoid data loss in the event of equipment failure or some other form of catastrophe. For example, the storage systems described above may be configured to examine each backup to avoid restoring the storage system to an undesirable state. Consider an example in which malware infects the storage system. In such an example, the storage system may include software resources 314 that can scan each backup to identify backups that were captured before the malware infected the storage system and those backups that were captured after the malware infected the storage system. In such an example, the storage system may restore itself from a backup that does not include the malware—or at least not restore the portions of a backup that contained the malware. In such an example, the storage system may include software resources 314 that can scan each backup to identify the presences of malware (or a virus, or some other undesirable), for example, by identifying write operations that were serviced by the storage system and originated from a network subnet that is suspected to have delivered the malware, by identifying write operations that were serviced by the storage system and originated from a user that is suspected to have delivered the malware, by identifying write operations that were serviced by the storage system and examining the content of the write operation against fingerprints of the malware, and in many other ways.

Readers will further appreciate that the backups (often in the form of one or more snapshots) may also be utilized to perform rapid recovery of the storage system. Consider an example in which the storage system is infected with ransomware that locks users out of the storage system. In such an example, software resources 314 within the storage system may be configured to detect the presence of ransomware and may be further configured to restore the storage system to a point-in-time, using the retained backups, prior to the point-in-time at which the ransomware infected the storage system. In such an example, the presence of ransomware may be explicitly detected through the use of software tools utilized by the system, through the use of a key (e.g., a USB drive) that is inserted into the storage system, or in a similar way. Likewise, the presence of ransomware may be inferred in response to system activity meeting a predetermined fingerprint such as, for example, no reads or writes coming into the system for a predetermined period of time.

Readers will appreciate that the various components described above may be grouped into one or more optimized computing packages as converged infrastructures. Such converged infrastructures may include pools of computers, storage and networking resources that can be shared by multiple applications and managed in a collective manner using policy-driven processes. Such converged infrastructures may be implemented with a converged infrastructure reference architecture, with standalone appliances, with a software driven hyper-converged approach (e.g., hyper-converged infrastructures), or in other ways.

Readers will appreciate that the storage systems described in this disclosure may be useful for supporting various types of software applications. In fact, the storage systems may be ‘application aware’ in the sense that the storage systems may obtain, maintain, or otherwise have access to information describing connected applications (e.g., applications that utilize the storage systems) to optimize the operation of the storage system based on intelligence about the applications and their utilization patterns. For example, the storage system may optimize data layouts, optimize caching behaviors, optimize ‘QoS’ levels, or perform some other optimization that is designed to improve the storage performance that is experienced by the application.

As an example of one type of application that may be supported by the storage systems describe herein, the storage system 306 may be useful in supporting artificial intelligence (‘AI’) applications, database applications, XOps projects (e.g., DevOps projects, DataOps projects, MLOps projects, ModelOps projects, PlatformOps projects), electronic design automation tools, event-driven software applications, high performance computing applications, simulation applications, high-speed data capture and analysis applications, machine learning applications, media production applications, media serving applications, picture archiving and communication systems (‘PACS’) applications, software development applications, virtual reality applications, augmented reality applications, and many other types of applications by providing storage resources to such applications.

In view of the fact that the storage systems include compute resources, storage resources, and a wide variety of other resources, the storage systems may be well suited to support applications that are resource intensive such as, for example, AI applications. AI applications may be deployed in a variety of fields, including: predictive maintenance in manufacturing and related fields, healthcare applications such as patient data & risk analytics, retail and marketing deployments (e.g., search advertising, social media advertising), supply chains solutions, fintech solutions such as business analytics & reporting tools, operational deployments such as real-time analytics tools, application performance management tools, IT infrastructure management tools, and many others.

Such AI applications may enable devices to perceive their environment and take actions that maximize their chance of success at some goal. Examples of such AI applications can include IBM Watson™, Microsoft Oxford™, Google DeepMind™, Baidu Minwa™, and others.

The storage systems described above may also be well suited to support other types of applications that are resource intensive such as, for example, machine learning applications. Machine learning applications may perform various types of data analysis to automate analytical model building. Using algorithms that iteratively learn from data, machine learning applications can enable computers to learn without being explicitly programmed. One particular area of machine learning is referred to as reinforcement learning, which involves taking suitable actions to maximize reward in a particular situation.

In addition to the resources already described, the storage systems described above may also include graphics processing units (‘GPUs’), occasionally referred to as visual processing unit (‘VPUs’). Such GPUs may be embodied as specialized electronic circuits that rapidly manipulate and alter memory to accelerate the creation of images in a frame buffer intended for output to a display device. Such GPUs may be included within any of the computing devices that are part of the storage systems described above, including as one of many individually scalable components of a storage system, where other examples of individually scalable components of such storage system can include storage components, memory components, compute components (e.g., CPUs, FPGAs, ASICs), networking components, software components, and others. In addition to GPUs, the storage systems described above may also include neural network processors (‘NNPs’) for use in various aspects of neural network processing. Such NNPs may be used in place of (or in addition to) GPUs and may also be independently scalable.

As described above, the storage systems described herein may be configured to support artificial intelligence applications, machine learning applications, big data analytics applications, and many other types of applications. The rapid growth in these sort of applications is being driven by three technologies: deep learning (DL), GPU processors, and Big Data. Deep learning is a computing model that makes use of massively parallel neural networks inspired by the human brain. Instead of experts handcrafting software, a deep learning model writes its own software by learning from lots of examples. Such GPUs may include thousands of cores that are well-suited to run algorithms that loosely represent the parallel nature of the human brain.

Advances in deep neural networks, including the development of multi-layer neural networks, have ignited a new wave of algorithms and tools for data scientists to tap into their data with artificial intelligence (AI). With improved algorithms, larger data sets, and various frameworks (including open-source software libraries for machine learning across a range of tasks), data scientists are tackling new use cases like autonomous driving vehicles, natural language processing and understanding, computer vision, machine reasoning, strong AI, and many others. Applications of such techniques may include: machine and vehicular object detection, identification and avoidance; visual recognition, classification and tagging; algorithmic financial trading strategy performance management; simultaneous localization and mapping; predictive maintenance of high-value machinery; prevention against cyber security threats, expertise automation; image recognition and classification; question answering; robotics; text analytics (extraction, classification) and text generation and translation; and many others. Applications of AI techniques has materialized in a wide array of products include, for example, Amazon Echo's speech recognition technology that allows users to talk to their machines, Google Translate™ which allows for machine-based language translation, Spotify's Discover Weekly that provides recommendations on new songs and artists that a user may like based on the user's usage and traffic analysis, Quill's text generation offering that takes structured data and turns it into narrative stories, Chatbots that provide real-time, contextually specific answers to questions in a dialog format, and many others.

Data is the heart of modern AI and deep learning algorithms. Before training can begin, one problem that must be addressed revolves around collecting the labeled data that is crucial for training an accurate AI model. A full scale AI deployment may be required to continuously collect, clean, transform, label, and store large amounts of data. Adding additional high quality data points directly translates to more accurate models and better insights. Data samples may undergo a series of processing steps including, but not limited to: 1) ingesting the data from an external source into the training system and storing the data in raw form, 2) cleaning and transforming the data in a format convenient for training, including linking data samples to the appropriate label, 3) exploring parameters and models, quickly testing with a smaller dataset, and iterating to converge on the most promising models to push into the production cluster, 4) executing training phases to select random batches of input data, including both new and older samples, and feeding those into production GPU servers for computation to update model parameters, and 5) evaluating including using a holdback portion of the data not used in training in order to evaluate model accuracy on the holdout data. This lifecycle may apply for any type of parallelized machine learning, not just neural networks or deep learning. For example, standard machine learning frameworks may rely on CPUs instead of GPUs but the data ingest and training workflows may be the same. Readers will appreciate that a single shared storage data hub creates a coordination point throughout the lifecycle without the need for extra data copies among the ingest, preprocessing, and training stages. Rarely is the ingested data used for only one purpose, and shared storage gives the flexibility to train multiple different models or apply traditional analytics to the data.

Readers will appreciate that each stage in the AI data pipeline may have varying requirements from the data hub (e.g., the storage system or collection of storage systems). Scale-out storage systems must deliver uncompromising performance for all manner of access types and patterns—from small, metadata-heavy to large files, from random to sequential access patterns, and from low to high concurrency. The storage systems described above may serve as an ideal AI data hub as the systems may service unstructured workloads. In the first stage, data is ideally ingested and stored on to the same data hub that following stages will use, in order to avoid excess data copying. The next two steps can be done on a standard compute server that optionally includes a GPU, and then in the fourth and last stage, full training production jobs are run on powerful GPU-accelerated servers. Often, there is a production pipeline alongside an experimental pipeline operating on the same dataset. Further, the GPU-accelerated servers can be used independently for different models or joined together to train on one larger model, even spanning multiple systems for distributed training. If the shared storage tier is slow, then data must be copied to local storage for each phase, resulting in wasted time staging data onto different servers. The ideal data hub for the AI training pipeline delivers performance similar to data stored locally on the server node while also having the simplicity and performance to enable all pipeline stages to operate concurrently.

In order for the storage systems described above to serve as a data hub or as part of an AI deployment, in some embodiments the storage systems may be configured to provide DMA between storage devices that are included in the storage systems and one or more GPUs that are used in an AI or big data analytics pipeline. The one or more GPUs may be coupled to the storage system, for example, via NVMe-over-Fabrics (‘NVMe-oF’) such that bottlenecks such as the host CPU can be bypassed and the storage system (or one of the components contained therein) can directly access GPU memory. In such an example, the storage systems may leverage API hooks to the GPUs to transfer data directly to the GPUs. For example, the GPUs may be embodied as Nvidia™ GPUs and the storage systems may support GPUDirect Storage (‘GDS’) software, or have similar proprietary software, that enables the storage system to transfer data to the GPUs via RDMA or similar mechanism.

Although the preceding paragraphs discuss deep learning applications, readers will appreciate that the storage systems described herein may also be part of a distributed deep learning (‘DDL’) platform to support the execution of DDL algorithms. The storage systems described above may also be paired with other technologies such as TensorFlow, an open-source software library for dataflow programming across a range of tasks that may be used for machine learning applications such as neural networks, to facilitate the development of such machine learning models, applications, and so on.

The storage systems described above may also be used in a neuromorphic computing environment. Neuromorphic computing is a form of computing that mimics brain cells. To support neuromorphic computing, an architecture of interconnected “neurons” replace traditional computing models with low-powered signals that go directly between neurons for more efficient computation. Neuromorphic computing may make use of very-large-scale integration (VLSI) systems containing electronic analog circuits to mimic neuro-biological architectures present in the nervous system, as well as analog, digital, mixed-mode analog/digital VLSI, and software systems that implement models of neural systems for perception, motor control, or multisensory integration.

Readers will appreciate that the storage systems described above may be configured to support the storage or use of (among other types of data) blockchains and derivative items such as, for example, open source blockchains and related tools that are part of the IBM™ Hyperledger project, permissioned blockchains in which a certain number of trusted parties are allowed to access the block chain, blockchain products that enable developers to build their own distributed ledger projects, and others. Blockchains and the storage systems described herein may be leveraged to support on-chain storage of data as well as off-chain storage of data.

Off-chain storage of data can be implemented in a variety of ways and can occur when the data itself is not stored within the blockchain. For example, in one embodiment, a hash function may be utilized and the data itself may be fed into the hash function to generate a hash value. In such an example, the hashes of large pieces of data may be embedded within transactions, instead of the data itself. Readers will appreciate that, in other embodiments, alternatives to blockchains may be used to facilitate the decentralized storage of information. For example, one alternative to a blockchain that may be used is a blockweave. While conventional blockchains store every transaction to achieve validation, a blockweave permits secure decentralization without the usage of the entire chain, thereby enabling low cost on-chain storage of data. Such blockweaves may utilize a consensus mechanism that is based on proof of access (PoA) and proof of work (PoW).

The storage systems described above may, either alone or in combination with other computing devices, be used to support in-memory computing applications. In-memory computing involves the storage of information in RAM that is distributed across a cluster of computers. Readers will appreciate that the storage systems described above, especially those that are configurable with customizable amounts of processing resources, storage resources, and memory resources (e.g., those systems in which blades that contain configurable amounts of each type of resource), may be configured in a way so as to provide an infrastructure that can support in-memory computing. Likewise, the storage systems described above may include component parts (e.g., NVDIMMs, 3D crosspoint storage that provide fast random access memory that is persistent) that can actually provide for an improved in-memory computing environment as compared to in-memory computing environments that rely on RAM distributed across dedicated servers.

In some embodiments, the storage systems described above may be configured to operate as a hybrid in-memory computing environment that includes a universal interface to all storage media (e.g., RAM, flash storage, 3D crosspoint storage). In such embodiments, users may have no knowledge regarding the details of where their data is stored but they can still use the same full, unified API to address data. In such embodiments, the storage system may (in the background) move data to the fastest layer available—including intelligently placing the data in dependence upon various characteristics of the data or in dependence upon some other heuristic. In such an example, the storage systems may even make use of existing products such as Apache Ignite and GridGain to move data between the various storage layers, or the storage systems may make use of custom software to move data between the various storage layers. The storage systems described herein may implement various optimizations to improve the performance of in-memory computing such as, for example, having computations occur as close to the data as possible.

Readers will further appreciate that in some embodiments, the storage systems described above may be paired with other resources to support the applications described above. For example, one infrastructure could include primary compute in the form of servers and workstations which specialize in using General-purpose computing on graphics processing units (‘GPGPU’) to accelerate deep learning applications that are interconnected into a computation engine to train parameters for deep neural networks. Each system may have Ethernet external connectivity, InfiniBand external connectivity, some other form of external connectivity, or some combination thereof. In such an example, the GPUs can be grouped for a single large training or used independently to train multiple models. The infrastructure could also include a storage system such as those described above to provide, for example, a scale-out all-flash file or object store through which data can be accessed via high-performance protocols such as NFS, S3, and so on. The infrastructure can also include, for example, redundant top-of-rack Ethernet switches connected to storage and compute via ports in MLAG port channels for redundancy. The infrastructure could also include additional compute in the form of whitebox servers, optionally with GPUs, for data ingestion, pre-processing, and model debugging. Readers will appreciate that additional infrastructures are also be possible.

Readers will appreciate that the storage systems described above, either alone or in coordination with other computing machinery may be configured to support other AI related tools. For example, the storage systems may make use of tools like ONXX or other open neural network exchange formats that make it easier to transfer models written in different AI frameworks. Likewise, the storage systems may be configured to support tools like Amazon's Gluon that allow developers to prototype, build, and train deep learning models. In fact, the storage systems described above may be part of a larger platform, such as IBM™ Cloud Private for Data, that includes integrated data science, data engineering and application building services.

Readers will further appreciate that the storage systems described above may also be deployed as an edge solution. Such an edge solution may be in place to optimize cloud computing systems by performing data processing at the edge of the network, near the source of the data. Edge computing can push applications, data and computing power (i.e., services) away from centralized points to the logical extremes of a network. Through the use of edge solutions such as the storage systems described above, computational tasks may be performed using the compute resources provided by such storage systems, data may be storage using the storage resources of the storage system, and cloud-based services may be accessed through the use of various resources of the storage system (including networking resources). By performing computational tasks on the edge solution, storing data on the edge solution, and generally making use of the edge solution, the consumption of expensive cloud-based resources may be avoided and, in fact, performance improvements may be experienced relative to a heavier reliance on cloud-based resources.

While many tasks may benefit from the utilization of an edge solution, some particular uses may be especially suited for deployment in such an environment. For example, devices like drones, autonomous cars, robots, and others may require extremely rapid processing—so fast, in fact, that sending data up to a cloud environment and back to receive data processing support may simply be too slow. As an additional example, some IoT devices such as connected video cameras may not be well-suited for the utilization of cloud-based resources as it may be impractical (not only from a privacy perspective, security perspective, or a financial perspective) to send the data to the cloud simply because of the pure volume of data that is involved. As such, many tasks that really on data processing, storage, or communications may be better suited by platforms that include edge solutions such as the storage systems described above.

The storage systems described above may alone, or in combination with other computing resources, serves as a network edge platform that combines compute resources, storage resources, networking resources, cloud technologies and network virtualization technologies, and so on. As part of the network, the edge may take on characteristics similar to other network facilities, from the customer premise and backhaul aggregation facilities to Points of Presence (PoPs) and regional data centers. Readers will appreciate that network workloads, such as Virtual Network Functions (VNFs) and others, will reside on the network edge platform. Enabled by a combination of containers and virtual machines, the network edge platform may rely on controllers and schedulers that are no longer geographically co-located with the data processing resources. The functions, as microservices, may split into control planes, user and data planes, or even state machines, allowing for independent optimization and scaling techniques to be applied. Such user and data planes may be enabled through increased accelerators, both those residing in server platforms, such as FPGAs and Smart NICs, and through SDN-enabled merchant silicon and programmable ASICs.

The storage systems described above may also be optimized for use in big data analytics, including being leveraged as part of a composable data analytics pipeline where containerized analytics architectures, for example, make analytics capabilities more composable. Big data analytics may be generally described as the process of examining large and varied data sets to uncover hidden patterns, unknown correlations, market trends, customer preferences and other useful information that can help organizations make more-informed business decisions. As part of that process, semi-structured and unstructured data such as, for example, internet clickstream data, web server logs, social media content, text from customer emails and survey responses, mobile-phone call-detail records, IoT sensor data, and other data may be converted to a structured form.

The storage systems described above may also support (including implementing as a system interface) applications that perform tasks in response to human speech. For example, the storage systems may support the execution intelligent personal assistant applications such as, for example, Amazon's Alexa™, Apple Siri™, Google Voice™, Samsung Bixby™, Microsoft Cortana™, and others. While the examples described in the previous sentence make use of voice as input, the storage systems described above may also support chatbots, talkbots, chatterbots, or artificial conversational entities or other applications that are configured to conduct a conversation via auditory or textual methods. Likewise, the storage system may actually execute such an application to enable a user such as a system administrator to interact with the storage system via speech. Such applications are generally capable of voice interaction, music playback, making to-do lists, setting alarms, streaming podcasts, playing audiobooks, and providing weather, traffic, and other real time information, such as news, although in embodiments in accordance with the present disclosure, such applications may be utilized as interfaces to various system management operations.

The storage systems described above may also implement AI platforms for delivering on the vision of self-driving storage. Such AI platforms may be configured to deliver global predictive intelligence by collecting and analyzing large amounts of storage system telemetry data points to enable effortless management, analytics and support. In fact, such storage systems may be capable of predicting both capacity and performance, as well as generating intelligent advice on workload deployment, interaction and optimization. Such AI platforms may be configured to scan all incoming storage system telemetry data against a library of issue fingerprints to predict and resolve incidents in real-time, before they impact customer environments, and captures hundreds of variables related to performance that are used to forecast performance load.

The storage systems described above may support the serialized or simultaneous execution of artificial intelligence applications, machine learning applications, data analytics applications, data transformations, and other tasks that collectively may form an AI ladder. Such an AI ladder may effectively be formed by combining such elements to form a complete data science pipeline, where exist dependencies between elements of the AI ladder. For example, AI may require that some form of machine learning has taken place, machine learning may require that some form of analytics has taken place, analytics may require that some form of data and information architecting has taken place, and so on. As such, each element may be viewed as a rung in an AI ladder that collectively can form a complete and sophisticated AI solution.

The storage systems described above may also, either alone or in combination with other computing environments, be used to deliver an AI everywhere experience where AI permeates wide and expansive aspects of business and life. For example, AI may play an important role in the delivery of deep learning solutions, deep reinforcement learning solutions, artificial general intelligence solutions, autonomous vehicles, cognitive computing solutions, commercial UAVs or drones, conversational user interfaces, enterprise taxonomies, ontology management solutions, machine learning solutions, smart dust, smart robots, smart workplaces, and many others.

The storage systems described above may also, either alone or in combination with other computing environments, be used to deliver a wide range of transparently immersive experiences (including those that use digital twins of various “things” such as people, places, processes, systems, and so on) where technology can introduce transparency between people, businesses, and things. Such transparently immersive experiences may be delivered as augmented reality technologies, connected homes, virtual reality technologies, brain-computer interfaces, human augmentation technologies, nanotube electronics, volumetric displays, 4D printing technologies, or others.

The storage systems described above may also, either alone or in combination with other computing environments, be used to support a wide variety of digital platforms. Such digital platforms can include, for example, 5G wireless systems and platforms, digital twin platforms, edge computing platforms, IoT platforms, quantum computing platforms, serverless PaaS, software-defined security, neuromorphic computing platforms, and so on.

The storage systems described above may also be part of a multi-cloud environment in which multiple cloud computing and storage services are deployed in a single heterogeneous architecture. In order to facilitate the operation of such a multi-cloud environment, DevOps tools may be deployed to enable orchestration across clouds. Likewise, continuous development and continuous integration tools may be deployed to standardize processes around continuous integration and delivery, new feature rollout and provisioning cloud workloads. By standardizing these processes, a multi-cloud strategy may be implemented that enables the utilization of the best provider for each workload.

The storage systems described above may be used as a part of a platform to enable the use of crypto-anchors that may be used to authenticate a product's origins and contents to ensure that it matches a blockchain record associated with the product. Similarly, as part of a suite of tools to secure data stored on the storage system, the storage systems described above may implement various encryption technologies and schemes, including lattice cryptography. Lattice cryptography can involve constructions of cryptographic primitives that involve lattices, either in the construction itself or in the security proof. Unlike public-key schemes such as the RSA, Diffie-Hellman or Elliptic-Curve cryptosystems, which are easily attacked by a quantum computer, some lattice-based constructions appear to be resistant to attack by both classical and quantum computers.

A quantum computer is a device that performs quantum computing. Quantum computing is computing using quantum-mechanical phenomena, such as superposition and entanglement. Quantum computers differ from traditional computers that are based on transistors, as such traditional computers require that data be encoded into binary digits (bits), each of which is always in one of two definite states (0 or 1). In contrast to traditional computers, quantum computers use quantum bits, which can be in superpositions of states. A quantum computer maintains a sequence of qubits, where a single qubit can represent a one, a zero, or any quantum superposition of those two qubit states. A pair of qubits can be in any quantum superposition of 4 states, and three qubits in any superposition of 8 states. A quantum computer with n qubits can generally be in an arbitrary superposition of up to 2\hat{ }n different states simultaneously, whereas a traditional computer can only be in one of these states at any one time. A quantum Turing machine is a theoretical model of such a computer.

The storage systems described above may also be paired with FPGA-accelerated servers as part of a larger AI or ML infrastructure. Such FPGA-accelerated servers may reside near (e.g., in the same data center) the storage systems described above or even incorporated into an appliance that includes one or more storage systems, one or more FPGA-accelerated servers, networking infrastructure that supports communications between the one or more storage systems and the one or more FPGA-accelerated servers, as well as other hardware and software components. Alternatively, FPGA-accelerated servers may reside within a cloud computing environment that may be used to perform compute-related tasks for AI and ML jobs. Any of the embodiments described above may be used to collectively serve as a FPGA-based AI or ML platform. Readers will appreciate that, in some embodiments of the FPGA-based AI or ML platform, the FPGAs that are contained within the FPGA-accelerated servers may be reconfigured for different types of ML models (e.g., LSTMs, CNNs, GRUs). The ability to reconfigure the FPGAs that are contained within the FPGA-accelerated servers may enable the acceleration of a ML or AI application based on the most optimal numerical precision and memory model being used. Readers will appreciate that by treating the collection of FPGA-accelerated servers as a pool of FPGAs, any CPU in the data center may utilize the pool of FPGAs as a shared hardware microservice, rather than limiting a server to dedicated accelerators plugged into it.

The FPGA-accelerated servers and the GPU-accelerated servers described above may implement a model of computing where, rather than keeping a small amount of data in a CPU and running a long stream of instructions over it as occurred in more traditional computing models, the machine learning model and parameters are pinned into the high-bandwidth on-chip memory with lots of data streaming though the high-bandwidth on-chip memory. FPGAs may even be more efficient than GPUs for this computing model, as the FPGAs can be programmed with only the instructions needed to run this kind of computing model.

The storage systems described above may be configured to provide parallel storage, for example, through the use of a parallel file system such as BeeGFS. Such parallel files systems may include a distributed metadata architecture. For example, the parallel file system may include a plurality of metadata servers across which metadata is distributed, as well as components that include services for clients and storage servers.

The systems described above can support the execution of a wide array of software applications. Such software applications can be deployed in a variety of ways, including container-based deployment models. Containerized applications may be managed using a variety of tools. For example, containerized applications may be managed using Docker Swarm, Kubernetes, and others. Containerized applications may be used to facilitate a serverless, cloud native computing deployment and management model for software applications. In support of a serverless, cloud native computing deployment and management model for software applications, containers may be used as part of an event handling mechanisms (e.g., AWS Lambdas) such that various events cause a containerized application to be spun up to operate as an event handler.

The systems described above may be deployed in a variety of ways, including being deployed in ways that support fifth generation (‘5G’) networks. 5G networks may support substantially faster data communications than previous generations of mobile communications networks and, as a consequence may lead to the disaggregation of data and computing resources as modern massive data centers may become less prominent and may be replaced, for example, by more-local, micro data centers that are close to the mobile-network towers. The systems described above may be included in such local, micro data centers and may be part of or paired to multi-access edge computing (‘MEC’) systems. Such MEC systems may enable cloud computing capabilities and an IT service environment at the edge of the cellular network. By running applications and performing related processing tasks closer to the cellular customer, network congestion may be reduced and applications may perform better.

The storage systems described above may also be configured to implement NVMe Zoned Namespaces. Through the use of NVMe Zoned Namespaces, the logical address space of a namespace is divided into zones. Each zone provides a logical block address range that must be written sequentially and explicitly reset before rewriting, thereby enabling the creation of namespaces that expose the natural boundaries of the device and offload management of internal mapping tables to the host. In order to implement NVMe Zoned Name Spaces (‘ZNS’), ZNS SSDs or some other form of zoned block devices may be utilized that expose a namespace logical address space using zones. With the zones aligned to the internal physical properties of the device, several inefficiencies in the placement of data can be eliminated. In such embodiments, each zone may be mapped, for example, to a separate application such that functions like wear levelling and garbage collection could be performed on a per-zone or per-application basis rather than across the entire device. In order to support ZNS, the storage controllers described herein may be configured with to interact with zoned block devices through the usage of, for example, the Linux™ kernel zoned block device interface or other tools.

The storage systems described above may also be configured to implement zoned storage in other ways such as, for example, through the usage of shingled magnetic recording (SMR) storage devices. In examples where zoned storage is used, device-managed embodiments may be deployed where the storage devices hide this complexity by managing it in the firmware, presenting an interface like any other storage device. Alternatively, zoned storage may be implemented via a host-managed embodiment that depends on the operating system to know how to handle the drive, and only write sequentially to certain regions of the drive. Zoned storage may similarly be implemented using a host-aware embodiment in which a combination of a drive managed and host managed implementation is deployed.

The storage systems described herein may be used to form a data lake. A data lake may operate as the first place that an organization's data flows to, where such data may be in a raw format. Metadata tagging may be implemented to facilitate searches of data elements in the data lake, especially in embodiments where the data lake contains multiple stores of data, in formats not easily accessible or readable (e.g., unstructured data, semi-structured data, structured data). From the data lake, data may go downstream to a data warehouse where data may be stored in a more processed, packaged, and consumable format. The storage systems described above may also be used to implement such a data warehouse. In addition, a data mart or data hub may allow for data that is even more easily consumed, where the storage systems described above may also be used to provide the underlying storage resources necessary for a data mart or data hub. In embodiments, queries the data lake may require a schema-on-read approach, where data is applied to a plan or schema as it is pulled out of a stored location, rather than as it goes into the stored location.

The storage systems described herein may also be configured implement a recovery point objective (‘RPO’), which may be establish by a user, established by an administrator, established as a system default, established as part of a storage class or service that the storage system is participating in the delivery of, or in some other way. A “recovery point objective” is a goal for the maximum time difference between the last update to a source dataset and the last recoverable replicated dataset update that would be correctly recoverable, given a reason to do so, from a continuously or frequently updated copy of the source dataset. An update is correctly recoverable if it properly takes into account all updates that were processed on the source dataset prior to the last recoverable replicated dataset update.

In synchronous replication, the RPO would be zero, meaning that under normal operation, all completed updates on the source dataset should be present and correctly recoverable on the copy dataset. In best effort nearly synchronous replication, the RPO can be as low as a few seconds. In snapshot-based replication, the RPO can be roughly calculated as the interval between snapshots plus the time to transfer the modifications between a previous already transferred snapshot and the most recent to-be-replicated snapshot.

If updates accumulate faster than they are replicated, then an RPO can be missed. If more data to be replicated accumulates between two snapshots, for snapshot-based replication, than can be replicated between taking the snapshot and replicating that snapshot's cumulative updates to the copy, then the RPO can be missed. If, again in snapshot-based replication, data to be replicated accumulates at a faster rate than could be transferred in the time between subsequent snapshots, then replication can start to fall further behind which can extend the miss between the expected recovery point objective and the actual recovery point that is represented by the last correctly replicated update.

The storage systems described above may also be part of a shared nothing storage cluster. In a shared nothing storage cluster, each node of the cluster has local storage and communicates with other nodes in the cluster through networks, where the storage used by the cluster is (in general) provided only by the storage connected to each individual node. A collection of nodes that are synchronously replicating a dataset may be one example of a shared nothing storage cluster, as each storage system has local storage and communicates to other storage systems through a network, where those storage systems do not (in general) use storage from somewhere else that they share access to through some kind of interconnect. In contrast, some of the storage systems described above are themselves built as a shared-storage cluster, since there are drive shelves that are shared by the paired controllers. Other storage systems described above, however, are built as a shared nothing storage cluster, as all storage is local to a particular node (e.g., a blade) and all communication is through networks that link the compute nodes together.

In other embodiments, other forms of a shared nothing storage cluster can include embodiments where any node in the cluster has a local copy of all storage they need, and where data is mirrored through a synchronous style of replication to other nodes in the cluster either to ensure that the data isn't lost or because other nodes are also using that storage. In such an embodiment, if a new cluster node needs some data, that data can be copied to the new node from other nodes that have copies of the data.

In some embodiments, mirror-copy-based shared storage clusters may store multiple copies of all the cluster's stored data, with each subset of data replicated to a particular set of nodes, and different subsets of data replicated to different sets of nodes. In some variations, embodiments may store all of the cluster's stored data in all nodes, whereas in other variations nodes may be divided up such that a first set of nodes will all store the same set of data and a second, different set of nodes will all store a different set of data.

Readers will appreciate that RAFT-based databases (e.g., etcd) may operate like shared-nothing storage clusters where all RAFT nodes store all data. The amount of data stored in a RAFT cluster, however, may be limited so that extra copies don't consume too much storage. A container server cluster might also be able to replicate all data to all cluster nodes, presuming the containers don't tend to be too large and their bulk data (the data manipulated by the applications that run in the containers) is stored elsewhere such as in an S3 cluster or an external file server. In such an example, the container storage may be provided by the cluster directly through its shared-nothing storage model, with those containers providing the images that form the execution environment for parts of an application or service.

For further explanation, FIG. 3C illustrates an exemplary computing device 350 that may be specifically configured to perform one or more of the processes described herein. As shown in FIG. 3C, computing device 350 may include a communication interface 352, a processor 354, a storage device 356, and an input/output (“I/O”) module 358 communicatively connected one to another via a communication infrastructure 360. While an exemplary computing device 350 is shown in FIG. 3C, the components illustrated in FIG. 3C are not intended to be limiting. Additional or alternative components may be used in other embodiments. Components of computing device 350 shown in FIG. 3C will now be described in additional detail.

Communication interface 352 may be configured to communicate with one or more computing devices. Examples of communication interface 352 include, without limitation, a wired network interface (such as a network interface card), a wireless network interface (such as a wireless network interface card), a modem, an audio/video connection, and any other suitable interface.

Processor 354 generally represents any type or form of processing unit capable of processing data and/or interpreting, executing, and/or directing execution of one or more of the instructions, processes, and/or operations described herein. Processor 354 may perform operations by executing computer-executable instructions 362 (e.g., an application, software, code, and/or other executable data instance) stored in storage device 356.

Storage device 356 may include one or more data storage media, devices, or configurations and may employ any type, form, and combination of data storage media and/or device. For example, storage device 356 may include, but is not limited to, any combination of the non-volatile media and/or volatile media described herein. Electronic data, including data described herein, may be temporarily and/or permanently stored in storage device 356. For example, data representative of computer-executable instructions 362 configured to direct processor 354 to perform any of the operations described herein may be stored within storage device 356. In some examples, data may be arranged in one or more databases residing within storage device 356.

I/O module 358 may include one or more I/O modules configured to receive user input and provide user output. I/O module 358 may include any hardware, firmware, software, or combination thereof supportive of input and output capabilities. For example, I/O module 358 may include hardware and/or software for capturing user input, including, but not limited to, a keyboard or keypad, a touchscreen component (e.g., touchscreen display), a receiver (e.g., an RF or infrared receiver), motion sensors, and/or one or more input buttons.

I/O module 358 may include one or more devices for presenting output to a user, including, but not limited to, a graphics engine, a display (e.g., a display screen), one or more output drivers (e.g., display drivers), one or more audio speakers, and one or more audio drivers. In certain embodiments, I/O module 358 is configured to provide graphical data to a display for presentation to a user. The graphical data may be representative of one or more graphical user interfaces and/or any other graphical content as may serve a particular implementation. In some examples, any of the systems, computing devices, and/or other components described herein may be implemented by computing device 350.

For further explanation, FIG. 3D illustrates an example of a fleet of storage systems 376 for providing storage services (also referred to herein as ‘data services’). The fleet of storage systems 376 depicted in FIG. 3 includes a plurality of storage systems 374a, 374b, 374c, 374d, 374n that may each be similar to the storage systems described herein. The storage systems 374a, 374b, 374c, 374d, 374n in the fleet of storage systems 376 may be embodied as identical storage systems or as different types of storage systems. For example, two of the storage systems 374a, 374n depicted in FIG. 3D are depicted as being cloud-based storage systems, as the resources that collectively form each of the storage systems 374a, 374n are provided by distinct cloud services providers 370, 372. For example, the first cloud services provider 370 may be Amazon AWS whereas the second cloud services provider 372 is Microsoft Azure™, although in other embodiments one or more public clouds, private clouds, or combinations thereof may be used to provide the underlying resources that are used to form a particular storage system in the fleet of storage systems 376.

The example depicted in FIG. 3D includes an edge management service 382 for delivering storage services in accordance with some embodiments of the present disclosure. The storage services (also referred to herein as ‘data services’) that are delivered may include, for example, services to provide a certain amount of storage to a consumer, services to provide storage to a consumer in accordance with a predetermined service level agreement, services to provide storage to a consumer in accordance with predetermined regulatory requirements, and many others.

The edge management service 382 depicted in FIG. 3D may be embodied, for example, as one or more modules of computer program instructions executing on computer hardware such as one or more computer processors. Alternatively, the edge management service 382 may be embodied as one or more modules of computer program instructions executing on a virtualized execution environment such as one or more virtual machines, in one or more containers, or in some other way. In other embodiments, the edge management service 382 may be embodied as a combination of the embodiments described above, including embodiments where the one or more modules of computer program instructions that are included in the edge management service 382 are distributed across multiple physical or virtual execution environments.

The edge management service 382 may operate as a gateway for providing storage services to storage consumers, where the storage services leverage storage offered by one or more storage systems 374a, 374b, 374c, 374d, 374n. For example, the edge management service 382 may be configured to provide storage services to host devices 378a, 378b, 378c, 378d, 378n that are executing one or more applications that consume the storage services. In such an example, the edge management service 382 may operate as a gateway between the host devices 378a, 378b, 378c, 378d, 378n and the storage systems 374a, 374b, 374c, 374d, 374n, rather than requiring that the host devices 378a, 378b, 378c, 378d, 378n directly access the storage systems 374a, 374b, 374c, 374d, 374n.

The edge management service 382 of FIG. 3D exposes a storage services module 380 to the host devices 378a, 378b, 378c, 378d, 378n of FIG. 3D, although in other embodiments the edge management service 382 may expose the storage services module 380 to other consumers of the various storage services. The various storage services may be presented to consumers via one or more user interfaces, via one or more APIs, or through some other mechanism provided by the storage services module 380. As such, the storage services module 380 depicted in FIG. 3D may be embodied as one or more modules of computer program instructions executing on physical hardware, on a virtualized execution environment, or combinations thereof, where executing such modules causes enables a consumer of storage services to be offered, select, and access the various storage services.

The edge management service 382 of FIG. 3D also includes a system management services module 384. The system management services module 384 of FIG. 3D includes one or more modules of computer program instructions that, when executed, perform various operations in coordination with the storage systems 374a, 374b, 374c, 374d, 374n to provide storage services to the host devices 378a, 378b, 378c, 378d, 378n. The system management services module 384 may be configured, for example, to perform tasks such as provisioning storage resources from the storage systems 374a, 374b, 374c, 374d, 374n via one or more APIs exposed by the storage systems 374a, 374b, 374c, 374d, 374n, migrating datasets or workloads amongst the storage systems 374a, 374b, 374c, 374d, 374n via one or more APIs exposed by the storage systems 374a, 374b, 374c, 374d, 374n, setting one or more tunable parameters (i.e., one or more configurable settings) on the storage systems 374a, 374b, 374c, 374d, 374n via one or more APIs exposed by the storage systems 374a, 374b, 374c, 374d, 374n, and so on. For example, many of the services described below relate to embodiments where the storage systems 374a, 374b, 374c, 374d, 374n are configured to operate in some way. In such examples, the system management services module 384 may be responsible for using APIs (or some other mechanism) provided by the storage systems 374a, 374b, 374c, 374d, 374n to configure the storage systems 374a, 374b, 374c, 374d, 374n to operate in the ways described below.

In addition to configuring the storage systems 374a, 374b, 374c, 374d, 374n, the edge management service 382 itself may be configured to perform various tasks required to provide the various storage services. Consider an example in which the storage service includes a service that, when selected and applied, causes personally identifiable information (‘PII’) contained in a dataset to be obfuscated when the dataset is accessed. In such an example, the storage systems 374a, 374b, 374c, 374d, 374n may be configured to obfuscate PII when servicing read requests directed to the dataset. Alternatively, the storage systems 374a, 374b, 374c, 374d, 374n may service reads by returning data that includes the PII, but the edge management service 382 itself may obfuscate the PII as the data is passed through the edge management service 382 on its way from the storage systems 374a, 374b, 374c, 374d, 374n to the host devices 378a, 378b, 378c, 378d, 378n.

The storage systems 374a, 374b, 374c, 374d, 374n depicted in FIG. 3D may be embodied as one or more of the storage systems described above with reference to FIGS. 1A-3D, including variations thereof. In fact, the storage systems 374a, 374b, 374c, 374d, 374n may serve as a pool of storage resources where the individual components in that pool have different performance characteristics, different storage characteristics, and so on. For example, one of the storage systems 374a may be a cloud-based storage system, another storage system 374b may be a storage system that provides block storage, another storage system 374c may be a storage system that provides file storage, another storage system 374d may be a relatively high-performance storage system while another storage system 374n may be a relatively low-performance storage system, and so on. In alternative embodiments, only a single storage system may be present.

The storage systems 374a, 374b, 374c, 374d, 374n depicted in FIG. 3D may also be organized into different failure domains so that the failure of one storage system 374a should be totally unrelated to the failure of another storage system 374b. For example, each of the storage systems may receive power from independent power systems, each of the storage systems may be coupled for data communications over independent data communications networks, and so on. Furthermore, the storage systems in a first failure domain may be accessed via a first gateway whereas storage systems in a second failure domain may be accessed via a second gateway. For example, the first gateway may be a first instance of the edge management service 382 and the second gateway may be a second instance of the edge management service 382, including embodiments where each instance is distinct, or each instance is part of a distributed edge management service 382.

As an illustrative example of available storage services, storage services may be presented to a user that are associated with different levels of data protection. For example, storage services may be presented to the user that, when selected and enforced, guarantee the user that data associated with that user will be protected such that various recovery point objectives (‘RPO’) can be guaranteed. A first available storage service may ensure, for example, that some dataset associated with the user will be protected such that any data that is more than 5 seconds old can be recovered in the event of a failure of the primary data store whereas a second available storage service may ensure that the dataset that is associated with the user will be protected such that any data that is more than 5 minutes old can be recovered in the event of a failure of the primary data store.

An additional example of storage services that may be presented to a user, selected by a user, and ultimately applied to a dataset associated with the user can include one or more data compliance services. Such data compliance services may be embodied, for example, as services that may be provided to consumers (i.e., a user) the data compliance services to ensure that the user's datasets are managed in a way to adhere to various regulatory requirements. For example, one or more data compliance services may be offered to a user to ensure that the user's datasets are managed in a way so as to adhere to the General Data Protection Regulation (‘GDPR’), one or data compliance services may be offered to a user to ensure that the user's datasets are managed in a way so as to adhere to the Sarbanes-Oxley Act of 2002 (‘SOX’), or one or more data compliance services may be offered to a user to ensure that the user's datasets are managed in a way so as to adhere to some other regulatory act. In addition, the one or more data compliance services may be offered to a user to ensure that the user's datasets are managed in a way so as to adhere to some non-governmental guidance (e.g., to adhere to best practices for auditing purposes), the one or more data compliance services may be offered to a user to ensure that the user's datasets are managed in a way so as to adhere to a particular clients or organizations requirements, and so on.

Consider an example in which a particular data compliance service is designed to ensure that a user's datasets are managed in a way so as to adhere to the requirements set forth in the GDPR. While a listing of all requirements of the GDPR can be found in the regulation itself, for the purposes of illustration, an example requirement set forth in the GDPR requires that pseudonymization processes must be applied to stored data in order to transform personal data in such a way that the resulting data cannot be attributed to a specific data subject without the use of additional information. For example, data encryption techniques can be applied to render the original data unintelligible, and such data encryption techniques cannot be reversed without access to the correct decryption key. As such, the GDPR may require that the decryption key be kept separately from the pseudonymised data. One particular data compliance service may be offered to ensure adherence to the requirements set forth in this paragraph.

In order to provide this particular data compliance service, the data compliance service may be presented to a user (e.g., via a GUI) and selected by the user. In response to receiving the selection of the particular data compliance service, one or more storage services policies may be applied to a dataset associated with the user to carry out the particular data compliance service. For example, a storage services policy may be applied requiring that the dataset be encrypted prior to be stored in a storage system, prior to being stored in a cloud environment, or prior to being stored elsewhere. In order to enforce this policy, a requirement may be enforced not only requiring that the dataset be encrypted when stored, but a requirement may be put in place requiring that the dataset be encrypted prior to transmitting the dataset (e.g., sending the dataset to another party). In such an example, a storage services policy may also be put in place requiring that any encryption keys used to encrypt the dataset are not stored on the same system that stores the dataset itself. Readers will appreciate that many other forms of data compliance services may be offered and implemented in accordance with embodiments of the present disclosure.

The storage systems 374a, 374b, 374c, 374d, 374n in the fleet of storage systems 376 may be managed collectively, for example, by one or more fleet management modules. The fleet management modules may be part of or separate from the system management services module 384 depicted in FIG. 3D. The fleet management modules may perform tasks such as monitoring the health of each storage system in the fleet, initiating updates or upgrades on one or more storage systems in the fleet, migrating workloads for loading balancing or other performance purposes, and many other tasks. As such, and for many other reasons, the storage systems 374a, 374b, 374c, 374d, 374n may be coupled to each other via one or more data communications links in order to exchange data between the storage systems 374a, 374b, 374c, 374d, 374n.

The storage systems described herein may support various forms of data replication. For example, two or more of the storage systems may synchronously replicate a dataset between each other. In synchronous replication, distinct copies of a particular dataset may be maintained by multiple storage systems, but all accesses (e.g., a read) of the dataset should yield consistent results regardless of which storage system the access was directed to. For example, a read directed to any of the storage systems that are synchronously replicating the dataset should return identical results. As such, while updates to the version of the dataset need not occur at exactly the same time, precautions must be taken to ensure consistent accesses to the dataset. For example, if an update (e.g., a write) that is directed to the dataset is received by a first storage system, the update may only be acknowledged as being completed if all storage systems that are synchronously replicating the dataset have applied the update to their copies of the dataset. In such an example, synchronous replication may be carried out through the use of I/O forwarding (e.g., a write received at a first storage system is forwarded to a second storage system), communications between the storage systems (e.g., each storage system indicating that it has completed the update), or in other ways.

In other embodiments, a dataset may be replicated through the use of checkpoints. In checkpoint-based replication (also referred to as ‘nearly synchronous replication’), a set of updates to a dataset (e.g., one or more write operations directed to the dataset) may occur between different checkpoints, such that a dataset has been updated to a specific checkpoint only if all updates to the dataset prior to the specific checkpoint have been completed. Consider an example in which a first storage system stores a live copy of a dataset that is being accessed by users of the dataset. In this example, assume that the dataset is being replicated from the first storage system to a second storage system using checkpoint-based replication. For example, the first storage system may send a first checkpoint (at time t=0) to the second storage system, followed by a first set of updates to the dataset, followed by a second checkpoint (at time t=1), followed by a second set of updates to the dataset, followed by a third checkpoint (at time t=2). In such an example, if the second storage system has performed all updates in the first set of updates but has not yet performed all updates in the second set of updates, the copy of the dataset that is stored on the second storage system may be up-to-date until the second checkpoint. Alternatively, if the second storage system has performed all updates in both the first set of updates and the second set of updates, the copy of the dataset that is stored on the second storage system may be up-to-date until the third checkpoint. Readers will appreciate that various types of checkpoints may be used (e.g., metadata only checkpoints), checkpoints may be spread out based on a variety of factors (e.g., time, number of operations, an RPO setting), and so on.

In other embodiments, a dataset may be replicated through snapshot-based replication (also referred to as ‘asynchronous replication’). In snapshot-based replication, snapshots of a dataset may be sent from a replication source such as a first storage system to a replication target such as a second storage system. In such an embodiment, each snapshot may include the entire dataset or a subset of the dataset such as, for example, only the portions of the dataset that have changed since the last snapshot was sent from the replication source to the replication target. Readers will appreciate that snapshots may be sent on-demand, based on a policy that takes a variety of factors into consideration (e.g., time, number of operations, an RPO setting), or in some other way.

The storage systems described above may, either alone or in combination, by configured to serve as a continuous data protection store. A continuous data protection store is a feature of a storage system that records updates to a dataset in such a way that consistent images of prior contents of the dataset can be accessed with a low time granularity (often on the order of seconds, or even less), and stretching back for a reasonable period of time (often hours or days). These allow access to very recent consistent points in time for the dataset, and also allow access to access to points in time for a dataset that might have just preceded some event that, for example, caused parts of the dataset to be corrupted or otherwise lost, while retaining close to the maximum number of updates that preceded that event. Conceptually, they are like a sequence of snapshots of a dataset taken very frequently and kept for a long period of time, though continuous data protection stores are often implemented quite differently from snapshots. A storage system implementing a data continuous data protection store may further provide a means of accessing these points in time, accessing one or more of these points in time as snapshots or as cloned copies, or reverting the dataset back to one of those recorded points in time.

Over time, to reduce overhead, some points in the time held in a continuous data protection store can be merged with other nearby points in time, essentially deleting some of these points in time from the store. This can reduce the capacity needed to store updates. It may also be possible to convert a limited number of these points in time into longer duration snapshots. For example, such a store might keep a low granularity sequence of points in time stretching back a few hours from the present, with some points in time merged or deleted to reduce overhead for up to an additional day. Stretching back in the past further than that, some of these points in time could be converted to snapshots representing consistent point-in-time images from only every few hours.

Although some embodiments are described largely in the context of a storage system, readers of skill in the art will recognize that embodiments of the present disclosure may also take the form of a computer program product disposed upon computer readable storage media for use with any suitable processing system. Such computer readable storage media may be any storage medium for machine-readable information, including magnetic media, optical media, solid-state media, or other suitable media. Examples of such media include magnetic disks in hard drives or diskettes, compact disks for optical drives, magnetic tape, and others as will occur to those of skill in the art. Persons skilled in the art will immediately recognize that any computer system having suitable programming means will be capable of executing the steps described herein as embodied in a computer program product. Persons skilled in the art will recognize also that, although some of the embodiments described in this specification are oriented to software installed and executing on computer hardware, nevertheless, alternative embodiments implemented as firmware or as hardware are well within the scope of the present disclosure.

In some examples, a non-transitory computer-readable medium storing computer-readable instructions may be provided in accordance with the principles described herein. The instructions, when executed by a processor of a computing device, may direct the processor and/or computing device to perform one or more operations, including one or more of the operations described herein. Such instructions may be stored and/or transmitted using any of a variety of known computer-readable media.

A non-transitory computer-readable medium as referred to herein may include any non-transitory storage medium that participates in providing data (e.g., instructions) that may be read and/or executed by a computing device (e.g., by a processor of a computing device). For example, a non-transitory computer-readable medium may include, but is not limited to, any combination of non-volatile storage media and/or volatile storage media. Exemplary non-volatile storage media include, but are not limited to, read-only memory, flash memory, a solid-state drive, a magnetic storage device (e.g., a hard disk, a floppy disk, magnetic tape, etc.), ferroelectric random-access memory (“RAM”), and an optical disc (e.g., a compact disc, a digital video disc, a Blu-ray disc, etc.). Exemplary volatile storage media include, but are not limited to, RAM (e.g., dynamic RAM).

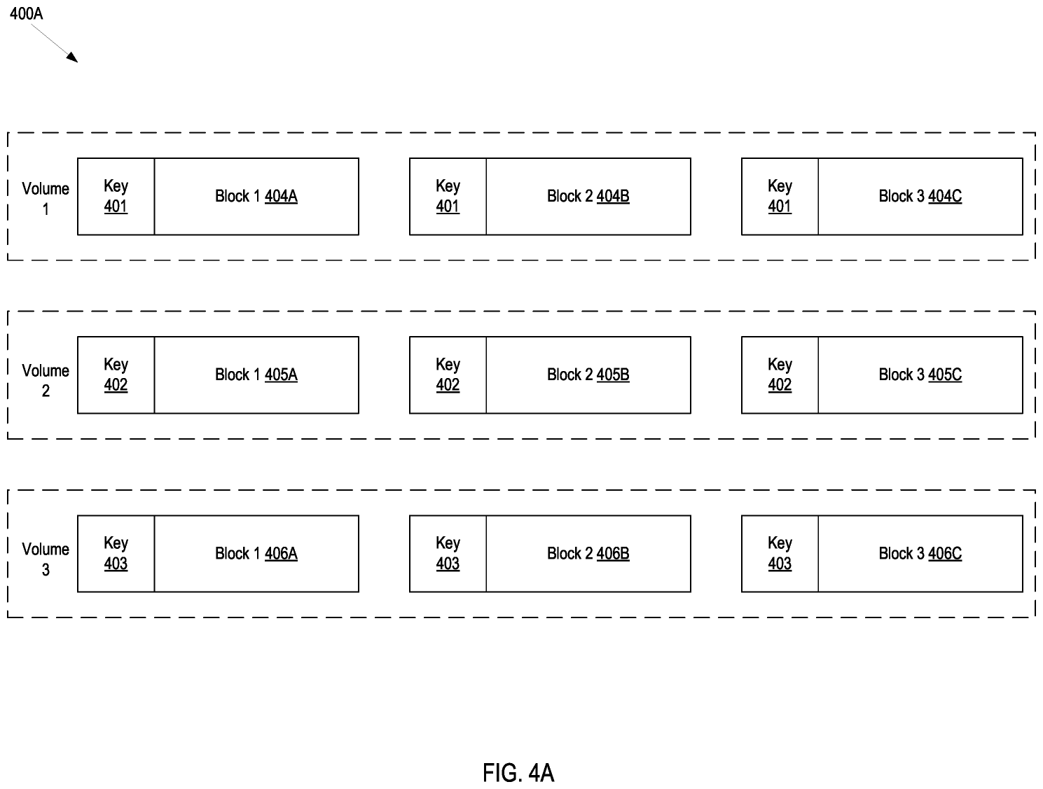

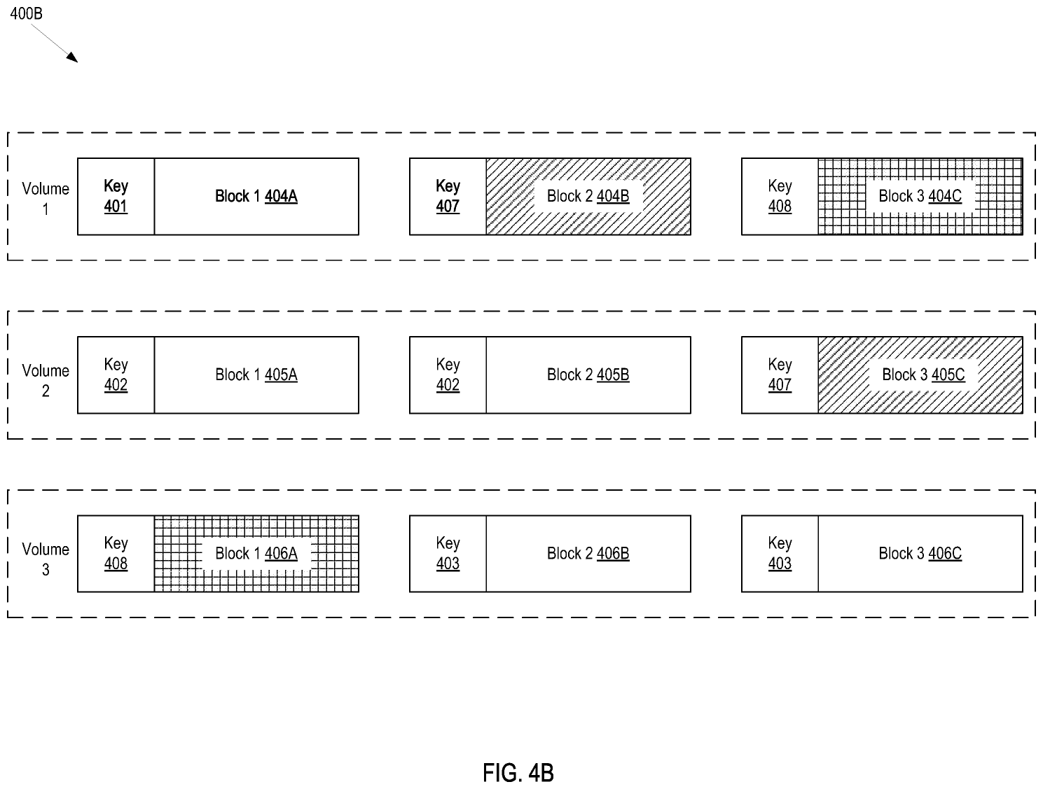

FIG. 4A illustrates a first block diagram 400A for deduplication-aware per-tenant encryption in accordance with some embodiments of the present disclosure. In one embodiment, block diagram 400A represents an example that does not include data deduplication between tenants. In one exemplary embodiment, Volume 1 belongs to a first tenant, Volume 2 belongs to a second tenant, and Volume 3 belongs to a third tenant. Volume 1, belonging to the first tenant, may include Block 1 404A, Block 2 404B, and Block 3 404C. Volume 2, belonging to the second tenant, may include Block 1 405A, Block 2 405B, and Block 3 405C. Volume 3, belonging to the third tenant, may include Block 1 406A, Block 2 406B, and Block 3 406C.

In one embodiment, the data stored on each of the blocks of Volumes 1, 2, and 3, is distinct from the data stored on each of the other blocks. In other words, none of the data is deduplicatable. In this embodiment, each of the blocks belonging to Volume 1 (e.g., the first tenant) may be encrypted with an encryption key 401, belonging to the first tenant. In another embodiment, the blocks of Volume 1 may be encrypted with a variety of encryption keys, all belonging to the first tenant. Likewise, the blocks of Volume 2 and Volume 3 may be encrypted with encryption keys belonging to the second tenant and third tenant, respectively. Any number of encryption keys may be used to encrypt the blocks of the volumes belonging to the tenants.

Each tenant may separately manage the encryption key or keys used to encrypt and decrypt the data stored on the blocks belonging to each respective tenant. In one embodiment, each volume may be assigned a volume key and each tenant may be assigned (or may select) a tenant key. In the example illustrated by FIG. 4A, in which no data is deduplicated between volumes belonging to separate tenants, each volume key may be encrypted with the tenant key belonging to each tenant, respectively. The encrypted volume key may then be provided to each respective tenant. In other embodiments (e.g., as described with respect to FIG. 4B, volume keys may be encrypted with shared keys instead of individual tenant keys).

In one embodiment, encryption keys are stored in a tenant key table. In the example embodiment illustrated by FIG. 4A, the tenant key table may be similar to Table 1, below.

TABLE 1

| Volume | | Key |
|---|---|---|
| key | | Tnk-key provided by tenant |
| index | Tenants | Kn-volume encryption key |
| 1 | T1 | T1k(K1) |
| 2 | T2 | T2k(K2) |
| 3 | T3 | T3k(K3) |

Tenant key tables may store a volume key index (e.g., identifying the storage volume), a tenant identifier (ID), encryption keys or encryption key identifiers relevant to the identified storage volume, and/or any additional information (e.g., metadata) that may be useful.

In one embodiment, volumes may be encrypted with a volume key that itself is encrypted with a tenant key that only the tenant can provide (e.g., either through Key Management Interoperability Protocol (KMIP) or some other schema). In the above example of Volume 1, which belongs to T1, Volume 1 is encrypted using the volume encryption key K1, which is in turn encrypted with tenant encryption key T1k. This information may be kept in a tenant key table e.g., Table 1. In one embodiment, each block of a volume may include (e.g., in a metadata header) an index into the tenant key table, which may identify the tenant and/or volume key. In another embodiment, each volume stores such metadata on behalf of each block that it includes. In yet another embodiment, such metadata is stored elsewhere internally or externally with respect to the storage system. For example, a remote key server storing such metadata may be maintained.

FIG. 4B illustrates a second block diagram 400B for deduplication-aware per-tenant encryption in accordance with some embodiments of the present disclosure. In one embodiment, block diagram 400B represents an example that includes data deduplication between tenants. Some aspects and components of diagram 400B (including numbering) are the same, or similar to, those in block diagram 400A of FIG. 4A merely for clarity and brevity. Such aspects and components may be the same or different than those illustrated by block diagram 400A of FIG. 4A. It should also be noted that the specific embodiments described with respect to FIGS. 4A and 4B are examples and merely for illustrative purposes. The deduplication-aware per-tenant encryption systems and methods described herein are equally capable of operating on embodiments having various alternative structures and arrangements.

In one exemplary embodiment, Volume 1 belongs to a first tenant, Volume 2 belongs to a second tenant, and Volume 3 belongs to a third tenant. Volume 1, belonging to the first tenant, may include Block 1 404A, Block 2 404B, and Block 3 404C. Volume 2, belonging to the second tenant, may include Block 1 405A, Block 2 405B, and Block 3 405C. Volume 3, belonging to the third tenant, may include Block 1 406A, Block 2 406B, and Block 3 406C.

In one embodiment, some of the data stored on each of the blocks of Volumes 1, 2, and 3, is the same as data stored on some of the other blocks belonging to different tenants. In other words, some of the data is deduplicatable. For example, the data in Block 2 404B of Volume 1 (e.g., belonging to the first tenant) may be the same as the data stored in Block 3 405C of Volume 2 (e.g., belonging to the second tenant). Likewise, the data in Block 3 404C of Volume 1 (e.g., belonging to the first tenant) may be the same as the data stored in Block 1 406A of Volume 3 (e.g., belonging to the third tenant). Such repeated data may benefit from deduplication.

In this embodiment, each of the blocks belonging to Volume 1 (e.g., the first tenant) that do not contain shared data may be encrypted with an encryption key 401, belonging to the first tenant. In another embodiment, the blocks of Volume 1 may be encrypted with a variety of encryption keys, all belonging to the first tenant. Likewise, the blocks of Volume 2 and Volume 3 that do not include shared data may be encrypted with encryption keys belonging to the second tenant and third tenant, respectively. Any number of encryption keys may be used to encrypt the blocks of the volumes belonging to the tenants.

As described above, each tenant may separately manage the encryption key or keys used to encrypt and decrypt the data stored on the blocks belonging to each respective tenant. In one embodiment, each volume may be assigned a volume key and each tenant may be assigned (or may select) a tenant key. In the example illustrated by FIG. 4B, in which some data is deduplicated between volumes belonging to separate tenants, each volume key may be encrypted with the tenant key belonging to each tenant, respectively. The encrypted volume key may then be provided to each respective tenant. Such keys may be used for the data that is not deduplicatable. For the blocks that contain data that may be deduplicatable (e.g., 404B and 405C), a separate, shared encryption key may be generated. The deduplicatable blocks may be encrypted using the shared encryption key, which may then separately be encrypted with each tenants' encryption key and provided to the respective tenants.

For example, upon determining that the data of blocks 404B and 405C is deduplicatable, the data in each block may be decrypted using the tenant and volume key schema described with respect to FIG. 4A. Blocks 404B and 405C may then be encrypted with a new, shared key. Shared keys may be generated or identified in storage (e.g., a shared key may already exist if previously generated for two or more tenants that share existing data). The shared encryption key may then be encrypted with the tenant key of the first tenant, and provided to the first tenant. Likewise, the shared encryption key may be encrypted with the tenant key of the second tenant, and provided to the second tenant. Advantageously, this allows the shared data to be encrypted using a common (e.g., shared) encryption key, and thus duplicated, while allowing only the tenants who share the data access with their respective tenant keys.

In one embodiment, encryption keys are stored in a tenant key table. In the example embodiment illustrated by FIG. 4B, the tenant key table may be similar to Table 2, below.

TABLE 2

| Volume | | Key |
|---|---|---|
| key | | Tnk-key provided by tenant |
| index | Tenants | Kn-volume encryption key |
| 1 | T1 | T1k(K1) |
| 2 | T2 | T2k(K2) |
| 3 | T3 | T3k(K3) |
| 4 | T1, T2 | T1k(K4) |
| | | T2k(K4) |
| 5 | T1, T3 | T1k(K5) |
| | | T3k(K5) |

As described above, tenant key tables may store a volume key index (e.g., identifying the storage volume), a tenant identifier (ID), encryption keys or encryption key identifiers relevant to the identified storage volume, and/or any additional information (e.g., metadata) that may be useful.

In one embodiment, volumes may be encrypted with a volume key that itself is encrypted with a tenant key that only the tenant can provide (e.g., either through Key Management Interoperability Protocol (KMIP) or some other schema). In the above example Block 2 404B of Volume 1, which belongs to T1, is the same as Block 3 405C of Volume 2, which belongs to T2. Block 2 404B and Block 3 405C may be encrypted using the shared volume key K4, which is in turn separately encrypted with tenant encryption key T1k and T2k. The resulting encrypted encryption keys may be provided to the respective tenants (e.g., T1 and T2), thus allowing them access to the data. This information may be kept in a tenant key table e.g., Table 2. In one embodiment, each block of a volume may include (e.g., in a metadata header) an index into the tenant key table, which may identify the tenant and/or volume key. In another embodiment, each volume stores such metadata on behalf of each block that it includes. In yet another embodiment, such metadata is stored elsewhere internally or externally with respect to the storage system. For example, a remote key server storing such metadata may be maintained.

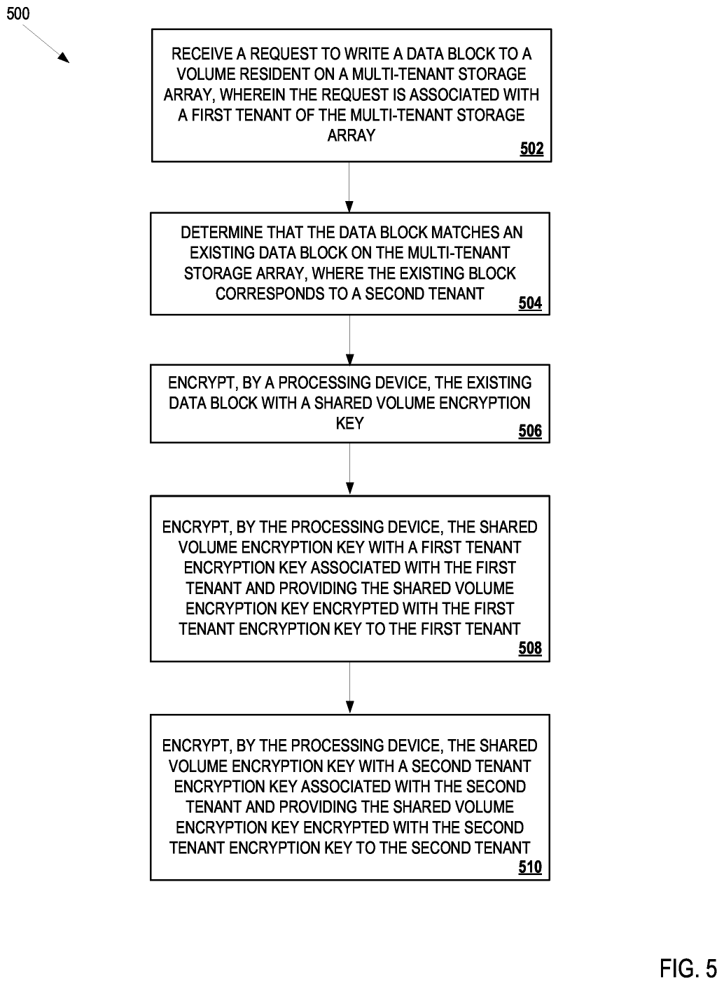

FIG. 5 illustrates a first flow diagram for deduplication-aware per-tenant encryption in accordance with some embodiments of the present disclosure. The method 500 may be performed by processing logic that comprises hardware (e.g., circuitry, dedicated logic, programmable logic, microcode, etc.), software (e.g., instructions run on a processing device to perform hardware simulation), or a combination thereof. In one embodiment, processing logic is executed by a kernel of an operating system associated with the hardware described. It should be noted that the operations described with respect to flow diagrams 500 and 600 may be performed in any order and combination. For example, the operations of flow diagram 500 may be performed with or in place of the operations of flow diagrams 600 and vice versa.

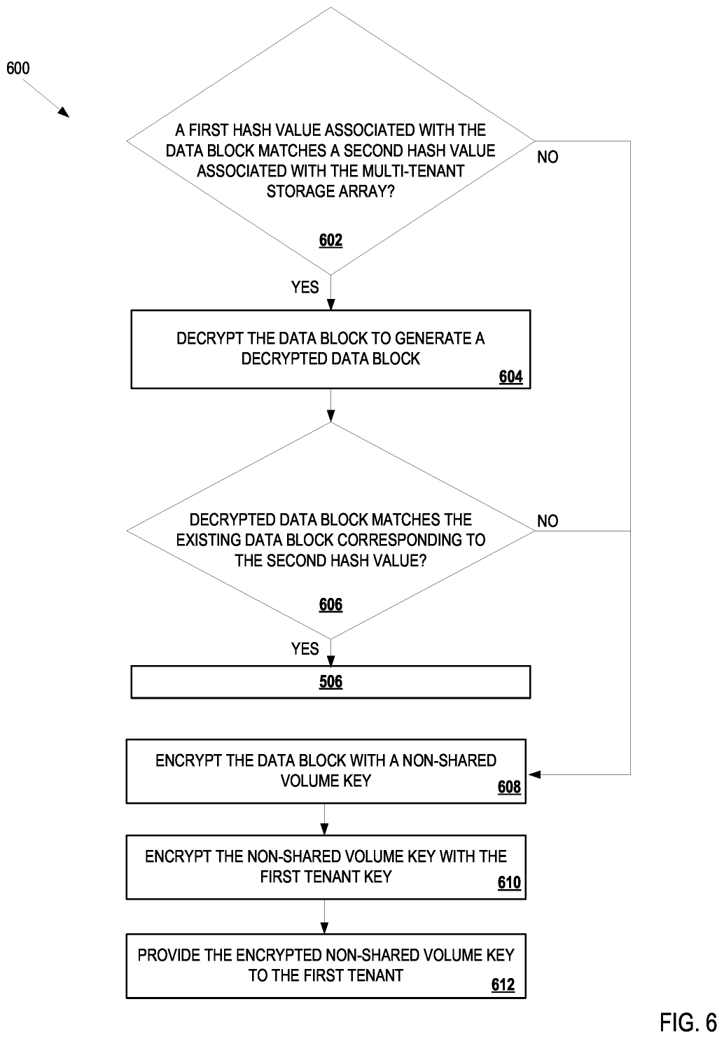

Referring to FIG. 5, at block 502, processing logic receives a request to write a data block to a volume resident on a multi-tenant storage array. In one embodiment, the request is associated with a first tenant of the multi-tenant storage array. At block 504, processing logic determines whether the data block matches an existing data block on the multi-tenant storage array (e.g., is deduplicatable). In one embodiment, the existing block corresponds to a second tenant. Additional details describing the operations of block 504 are provided with respect to FIG. 6.

In response to determining that the decrypted data block does match the existing data block processing logic may perform the operations of blocks 506, 508, and 510. At block 506, processing logic encrypts, by a processing device, the existing data block with a shared volume encryption key. In one embodiment, processing logic may determine whether a suitable shared volume encryption key already exists. If so, processing logic may retrieve the existing shared volume encryption key for use. If the key does not already exist, processing logic may generate the shared volume encryption key for use.

At block 508, processing logic encrypts, by the processing device, the shared volume encryption key with a first tenant encryption key associated with the first tenant and provides the shared volume encryption key encrypted with the first tenant encryption key to the first tenant. At block 510, processing logic encrypts, by the processing device, the shared volume encryption key with a second tenant encryption key associated with the second tenant and providing the shared volume encryption key encrypted with the second tenant encryption key to the second tenant.

In one embodiment, deduplicated data may be overwritten or erased, resulting in data that is no longer deduplicated. In such a case, processing logic may receive a request from the first tenant to overwrite (or erase) the data block, encrypt the data block with a non-shared volume key, and encrypt the non-shared volume key with the second tenant key. Processing logic may then provide the encrypted non-shared volume key to the second tenant. In one embodiment, if the data is still deduplicated after one tenant overwrites or erases the data (e.g., the data is deduplicated for more than two tenants), the operations described with respect to blocks 502-510 may be repeated to generate a shared volume key for the remaining tenants that share the deduplicated data.

FIG. 6 illustrates a second flow diagram for deduplication-aware per-tenant encryption in accordance with some embodiments of the present disclosure. The method 600 may be performed by processing logic that comprises hardware (e.g., circuitry, dedicated logic, programmable logic, microcode, etc.), software (e.g., instructions run on a processing device to perform hardware simulation), or a combination thereof. In one embodiment, processing logic is executed by a kernel of an operating system associated with the hardware described. It should be noted that the operations described with respect to flow diagrams 500 and 600 may be performed in any order and combination. For example, the operations of flow diagram 600 may be performed with or in place of the operations of flow diagrams 500 and vice versa. In one embodiment, the operations described with respect to FIG. 6 may be performed in place of block 504 of FIG. 5.

Beginning at block 602, processing logic determines if a first hash value associated with the data block matches a second hash value associated with the multi-tenant storage array. If so, processing flow continues to block 604 where processing logic decrypts the data block to generate a decrypted data block. In one embodiment, the data block includes the first hash value. In another embodiment, the first hash value may be determined from the data block. In one embodiment, to decrypt the data block to generate the decrypted data block, processing logic may determine that the first tenant owns the first data block and retrieve the first tenant encryption key. In one embodiment, to determine that the first tenant owns the first data block, processing logic may retrieve an identifier of the first tenant from a tenant key table. To retrieve the first tenant encryption key, processing logic may retrieve the first tenant encryption key from a key management server. At block 606, processing logic determines if the decrypted data block matches the existing data block corresponding to the second hash value. If so, processing logic may determine that the data is deduplicatable and continue to block 506 of FIG. 5.

If, at block 604, processing logic determines that a first hash value associated with the data block does not match a second hash value (e.g., any other hash value) associated with the multi-tenant storage array, processing flow may continue to block 608. If, at block 606, processing logic determines that the decrypted data block does not match the existing data block corresponding to the second hash value, processing flow may likewise continue to block 608. At block 608, processing logic encrypts the first data block with a non-shared volume key, encrypts the non-shared volume key with the first tenant key (block 610), and provides the encrypted non-shared volume key to the first tenant (block 612).

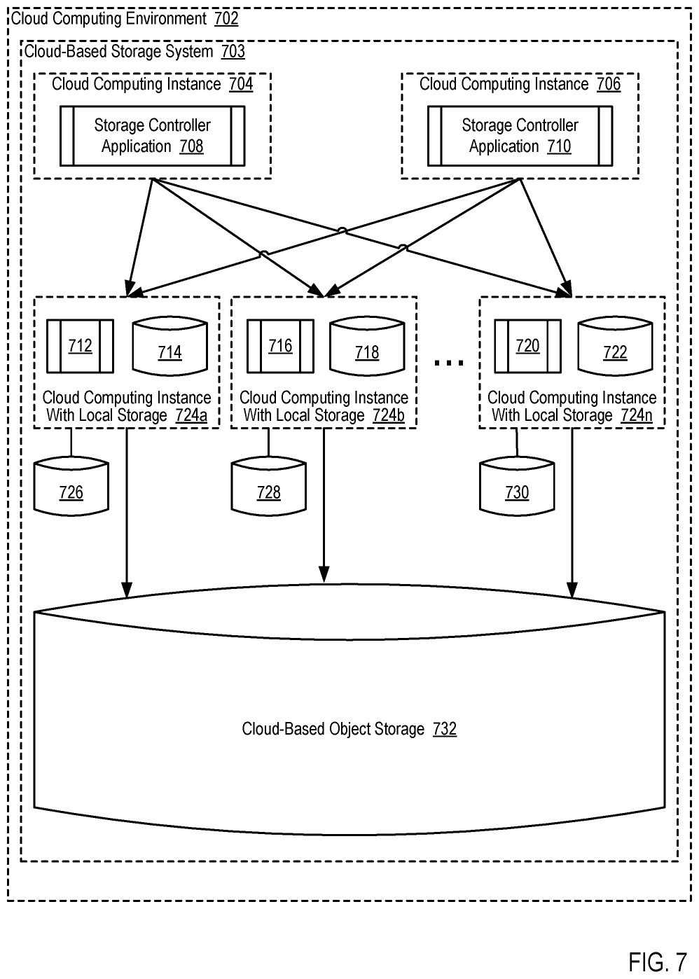

For further explanation, FIG. 7 sets forth an example of a cloud-based storage system 703 in accordance with some embodiments of the present disclosure. In the example depicted in FIG. 7, the cloud-based storage system 703 is created entirely in a cloud computing environment 702 such as, for example, Amazon Web Services (‘AWS’), Microsoft Azure, Google Cloud Platform, IBM Cloud, Oracle Cloud, and others. The cloud-based storage system 703 may be used to provide services similar to the services that may be provided by the storage systems described above. For example, the cloud-based storage system 703 may be used to provide block storage services to users of the cloud-based storage system 703, the cloud-based storage system 703 may be used to provide storage services to users of the cloud-based storage system 703 through the use of solid-state storage, and so on.

The cloud-based storage system 703 depicted in FIG. 7 includes two cloud computing instances 704, 706 that each are used to support the execution of a storage controller application 708, 710. The cloud computing instances 704, 706 may be embodied, for example, as instances of cloud computing resources (e.g., virtual machines) that may be provided by the cloud computing environment 702 to support the execution of software applications such as the storage controller application 708, 710. In one embodiment, the cloud computing instances 704, 706 may be embodied as Amazon Elastic Compute Cloud (‘EC2’) instances. In such an example, an Amazon Machine Image (AMP) that includes the storage controller application 708, 710 may be booted to create and configure a virtual machine that may execute the storage controller application 708, 710.

In the example method depicted in FIG. 7, the storage controller application 708, 710 may be embodied as a module of computer program instructions that, when executed, carries out various storage tasks. For example, the storage controller application 708, 710 may be embodied as a module of computer program instructions that, when executed, carries out the same tasks as the controllers (110A, 110B in FIG. 1A) described above such as writing data received from the users of the cloud-based storage system 703 to the cloud-based storage system 703, erasing data from the cloud-based storage system 703, retrieving data from the cloud-based storage system 703 and providing such data to users of the cloud-based storage system 703, monitoring and reporting of disk utilization and performance, performing redundancy operations, such as Redundant Array of Independent Drives (‘RAID’) or RAID-like data redundancy operations, compressing data, encrypting data, deduplicating data, and so forth. Readers will appreciate that because there are two cloud computing instances 704, 706 that each include the storage controller application 708, 710, in some embodiments one cloud computing instance 704 may operate as the primary controller as described above while the other cloud computing instance 706 may operate as the secondary controller as described above. In such an example, in order to save costs, the cloud computing instance 704 that operates as the primary controller may be deployed on a relatively high-performance and relatively expensive cloud computing instance while the cloud computing instance 706 that operates as the secondary controller may be deployed on a relatively low-performance and relatively inexpensive cloud computing instance. Readers will appreciate that the storage controller application 708, 710 depicted in FIG. 7 may include identical source code that is executed within different cloud computing instances 704, 706.

Consider an example in which the cloud computing environment 702 is embodied as AWS and the cloud computing instances are embodied as EC2 instances. In such an example, AWS offers many types of EC2 instances. For example, AWS offers a suite of general purpose EC2 instances that include varying levels of memory and processing power. In such an example, the cloud computing instance 704 that operates as the primary controller may be deployed on one of the instance types that has a relatively large amount of memory and processing power while the cloud computing instance 706 that operates as the secondary controller may be deployed on one of the instance types that has a relatively small amount of memory and processing power. In such an example, upon the occurrence of a failover event where the roles of primary and secondary are switched, a double failover may actually be carried out such that: 1) a first failover event where the cloud computing instance 706 that formerly operated as the secondary controller begins to operate as the primary controller, and 2) a third cloud computing instance (not shown) that is of an instance type that has a relatively large amount of memory and processing power is spun up with a copy of the storage controller application, where the third cloud computing instance begins operating as the primary controller while the cloud computing instance 706 that originally operated as the secondary controller begins operating as the secondary controller again. In such an example, the cloud computing instance 704 that formerly operated as the primary controller may be terminated. Readers will appreciate that in alternative embodiments, the cloud computing instance 704 that is operating as the secondary controller after the failover event may continue to operate as the secondary controller and the cloud computing instance 706 that operated as the primary controller after the occurrence of the failover event may be terminated once the primary role has been assumed by the third cloud computing instance (not shown).

Readers will appreciate that while the embodiments described above relate to embodiments where one cloud computing instance 704 operates as the primary controller and the second cloud computing instance 706 operates as the secondary controller, other embodiments are within the scope of the present disclosure. For example, each cloud computing instance 704, 706 may operate as a primary controller for some portion of the address space supported by the cloud-based storage system 703, each cloud computing instance 704, 706 may operate as a primary controller where the servicing of I/O operations directed to the cloud-based storage system 703 are divided in some other way, and so on. In fact, in other embodiments where costs savings may be prioritized over performance demands, only a single cloud computing instance may exist that contains the storage controller application. In such an example, a controller failure may take more time to recover from as a new cloud computing instance that includes the storage controller application would need to be spun up rather than having an already created cloud computing instance take on the role of servicing I/O operations that would have otherwise been handled by the failed cloud computing instance.

The cloud-based storage system 703 depicted in FIG. 7 includes cloud computing instances 724a, 724b, 724n with local storage 714, 718, 722. The cloud computing instances 724a, 724b, 724n depicted in FIG. 7 may be embodied, for example, as instances of cloud computing resources that may be provided by the cloud computing environment 702 to support the execution of software applications. The cloud computing instances 724a, 724b, 724n of FIG. 7 may differ from the cloud computing instances 704, 706 described above as the cloud computing instances 724a, 724b, 724n of FIG. 7 have local storage 714, 718, 722 resources whereas the cloud computing instances 704, 706 that support the execution of the storage controller application 708, 710 need not have local storage resources. The cloud computing instances 724a, 724b, 724n with local storage 714, 718, 722 may be embodied, for example, as EC2 M5 instances that include one or more SSDs, as EC2 R5 instances that include one or more SSDs, as EC2 I3 instances that include one or more SSDs, and so on. In some embodiments, the local storage 714, 718, 722 must be embodied as solid-state storage (e.g., SSDs) rather than storage that makes use of hard disk drives.

In the example depicted in FIG. 7, each of the cloud computing instances 724a, 724b, 724n with local storage 714, 718, 722 can include a software daemon 712, 716, 720 that, when executed by a cloud computing instance 724a, 724b, 724n can present itself to the storage controller applications 708, 710 as if the cloud computing instance 724a, 724b, 724n were a physical storage device (e.g., one or more SSDs). In such an example, the software daemon 712, 716, 720 may include computer program instructions similar to those that would normally be contained on a storage device such that the storage controller applications 708, 710 can send and receive the same commands that a storage controller would send to storage devices. In such a way, the storage controller applications 708, 710 may include code that is identical to (or substantially identical to) the code that would be executed by the controllers in the storage systems described above. In these and similar embodiments, communications between the storage controller applications 708, 710 and the cloud computing instances 724a, 724b, 724n with local storage 714, 718, 722 may utilize iSCSI, NVMe over TCP, messaging, a custom protocol, or in some other mechanism.

In the example depicted in FIG. 7, each of the cloud computing instances 724a, 724b, 724n with local storage 714, 718, 722 may also be coupled to block-storage 726, 728, 730 that is offered by the cloud computing environment 702. The block-storage 726, 728, 730 that is offered by the cloud computing environment 702 may be embodied, for example, as Amazon Elastic Block Store (‘EBS’) volumes. For example, a first EBS volume 726 may be coupled to a first cloud computing instance 724a, a second EBS volume 728 may be coupled to a second cloud computing instance 724b, and a third EBS volume 730 may be coupled to a third cloud computing instance 724n. In such an example, the block-storage 726, 728, 730 that is offered by the cloud computing environment 702 may be utilized in a manner that is similar to how the NVRAM devices described above are utilized, as the software daemon 712, 716, 720 (or some other module) that is executing within a particular cloud comping instance 724a, 724b, 724n may, upon receiving a request to write data, initiate a write of the data to its attached EBS volume as well as a write of the data to its local storage 714, 718, 722 resources. In some alternative embodiments, data may only be written to the local storage 714, 718, 722 resources within a particular cloud comping instance 724a, 724b, 724n. In an alternative embodiment, rather than using the block-storage 726, 728, 730 that is offered by the cloud computing environment 702 as NVRAM, actual RAM on each of the cloud computing instances 724a, 724b, 724n with local storage 714, 718, 722 may be used as NVRAM, thereby decreasing network utilization costs that would be associated with using an EBS volume as the NVRAM.

In the example depicted in FIG. 7, the cloud computing instances 724a, 724b, 724n with local storage 714, 718, 722 may be utilized, by cloud computing instances 704, 706 that support the execution of the storage controller application 708, 710 to service I/O operations that are directed to the cloud-based storage system 703. Consider an example in which a first cloud computing instance 704 that is executing the storage controller application 708 is operating as the primary controller. In such an example, the first cloud computing instance 704 that is executing the storage controller application 708 may receive (directly or indirectly via the secondary controller) requests to write data to the cloud-based storage system 703 from users of the cloud-based storage system 703. In such an example, the first cloud computing instance 704 that is executing the storage controller application 708 may perform various tasks such as, for example, deduplicating the data contained in the request, compressing the data contained in the request, determining where to the write the data contained in the request, and so on, before ultimately sending a request to write a deduplicated, encrypted, or otherwise possibly updated version of the data to one or more of the cloud computing instances 724a, 724b, 724n with local storage 714, 718, 722. Either cloud computing instance 704, 706, in some embodiments, may receive a request to read data from the cloud-based storage system 703 and may ultimately send a request to read data to one or more of the cloud computing instances 724a, 724b, 724n with local storage 714, 718, 722.

Readers will appreciate that when a request to write data is received by a particular cloud computing instance 724a, 724b, 724n with local storage 714, 718, 722, the software daemon 712, 716, 720 or some other module of computer program instructions that is executing on the particular cloud computing instance 724a, 724b, 724n may be configured to not only write the data to its own local storage 714, 718, 722 resources and any appropriate block storage 726, 728, 730 that are offered by the cloud computing environment 702, but the software daemon 712, 716, 720 or some other module of computer program instructions that is executing on the particular cloud computing instance 724a, 724b, 724n may also be configured to write the data to cloud-based object storage 732 that is attached to the particular cloud computing instance 724a, 724b, 724n. The cloud-based object storage 732 that is attached to the particular cloud computing instance 724a, 724b, 724n may be embodied, for example, as Amazon Simple Storage Service (‘S3’) storage that is accessible by the particular cloud computing instance 724a, 724b, 724n. In other embodiments, the cloud computing instances 704, 706 that each include the storage controller application 708, 710 may initiate the storage of the data in the local storage 714, 718, 722 of the cloud computing instances 724a, 724b, 724n and the cloud-based object storage 732.

Readers will appreciate that the software daemon 712, 716, 720 or other module of computer program instructions that writes the data to block storage (e.g., local storage 714, 718, 722 resources) and also writes the data to cloud-based object storage 732 may be executed on processing units of dissimilar types (e.g., different types of cloud computing instances, cloud computing instances that contain different processing units). In fact, the software daemon 712, 716, 720 or other module of computer program instructions that writes the data to block storage (e.g., local storage 714, 718, 722 resources) and also writes the data to cloud-based object storage 732 can be migrated between different types of cloud computing instances based on demand.

Readers will appreciate that, as described above, the cloud-based storage system 703 may be used to provide block storage services to users of the cloud-based storage system 703. While the local storage 714, 718, 722 resources and the block-storage 726, 728, 730 resources that are utilized by the cloud computing instances 724a, 724b, 724n may support block-level access, the cloud-based object storage 732 that is attached to the particular cloud computing instance 724a, 724b, 724n supports only object-based access. In order to address this, the software daemon 712, 716, 720 or some other module of computer program instructions that is executing on the particular cloud computing instance 724a, 724b, 724n may be configured to take blocks of data, package those blocks into objects, and write the objects to the cloud-based object storage 732 that is attached to the particular cloud computing instance 724a, 724b, 724n.

Consider an example in which data is written to the local storage 714, 718, 722 resources and the block-storage 726, 728, 730 resources that are utilized by the cloud computing instances 724a, 724b, 724n in 1 MB blocks. In such an example, assume that a user of the cloud-based storage system 703 issues a request to write data that, after being compressed and deduplicated by the storage controller application 708, 710 results in the need to write 5 MB of data. In such an example, writing the data to the local storage 714, 718, 722 resources and the block-storage 726, 728, 730 resources that are utilized by the cloud computing instances 724a, 724b, 724n is relatively straightforward as 5 blocks that are 1 MB in size are written to the local storage 714, 718, 722 resources and the block-storage 726, 728, 730 resources that are utilized by the cloud computing instances 724a, 724b, 724n. In such an example, the software daemon 712, 716, 720 or some other module of computer program instructions that is executing on the particular cloud computing instance 724a, 724b, 724n may be configured to: 1) create a first object that includes the first 1 MB of data and write the first object to the cloud-based object storage 732; 2) create a second object that includes the second 1 MB of data and write the second object to the cloud-based object storage 732; 3) create a third object that includes the third 1 MB of data and write the third object to the cloud-based object storage 732, and so on. As such, in some embodiments, each object that is written to the cloud-based object storage 732 may be identical (or nearly identical) in size. Readers will appreciate that in such an example, metadata that is associated with the data itself may be included in each object (e.g., the first 1 MB of the object is data and the remaining portion is metadata associated with the data).

Readers will appreciate that the cloud-based object storage 732 may be incorporated into the cloud-based storage system 703 to increase the durability of the cloud-based storage system 703. Continuing with the example described above where the cloud computing instances 724a, 724b, 724n are EC2 instances, readers will understand that EC2 instances are only guaranteed to have a monthly uptime of 99.9% and data stored in the local instance store only persists during the lifetime of the EC2 instance. As such, relying on the cloud computing instances 724a, 724b, 724n with local storage 714, 718, 722 as the only source of persistent data storage in the cloud-based storage system 703 may result in a relatively unreliable storage system. Likewise, EBS volumes are designed for 99.999% availability. As such, even relying on EBS as the persistent data store in the cloud-based storage system 703 may result in a storage system that is not sufficiently durable. Amazon S3, however, is designed to provide 99.999999999% durability, meaning that a cloud-based storage system 703 that can incorporate S3 into its pool of storage is substantially more durable than various other options.

Readers will appreciate that while a cloud-based storage system 703 that can incorporate S3 into its pool of storage is substantially more durable than various other options, utilizing S3 as the primary pool of storage may result in storage system that has relatively slow response times and relatively long I/O latencies. As such, the cloud-based storage system 703 depicted in FIG. 7 not only stores data in S3 but the cloud-based storage system 703 also stores data in local storage 714, 718, 722 resources and block-storage 726, 728, 730 resources that are utilized by the cloud computing instances 724a, 724b, 724n, such that read operations can be serviced from local storage 714, 718, 722 resources and the block-storage 726, 728, 730 resources that are utilized by the cloud computing instances 724a, 724b, 724n, thereby reducing read latency when users of the cloud-based storage system 703 attempt to read data from the cloud-based storage system 703.

In some embodiments, all data that is stored by the cloud-based storage system 703 may be stored in both: 1) the cloud-based object storage 732, and 2) at least one of the local storage 714, 718, 722 resources or block-storage 726, 728, 730 resources that are utilized by the cloud computing instances 724a, 724b, 724n. In such embodiments, the local storage 714, 718, 722 resources and block-storage 726, 728, 730 resources that are utilized by the cloud computing instances 724a, 724b, 724n may effectively operate as cache that generally includes all data that is also stored in S3, such that all reads of data may be serviced by the cloud computing instances 724a, 724b, 724n without requiring the cloud computing instances 724a, 724b, 724n to access the cloud-based object storage 732. Readers will appreciate that in other embodiments, however, all data that is stored by the cloud-based storage system 703 may be stored in the cloud-based object storage 732, but less than all data that is stored by the cloud-based storage system 703 may be stored in at least one of the local storage 714, 718, 722 resources or block-storage 726, 728, 730 resources that are utilized by the cloud computing instances 724a, 724b, 724n. In such an example, various policies may be utilized to determine which subset of the data that is stored by the cloud-based storage system 703 should reside in both: 1) the cloud-based object storage 732, and 2) at least one of the local storage 714, 718, 722 resources or block-storage 726, 728, 730 resources that are utilized by the cloud computing instances 724a, 724b, 724n.

As described above, when the cloud computing instances 724a, 724b, 724n with local storage 714, 718, 722 are embodied as EC2 instances, the cloud computing instances 724a, 724b, 724n with local storage 714, 718, 722 are only guaranteed to have a monthly uptime of 99.9% and data stored in the local instance store only persists during the lifetime of each cloud computing instance 724a, 724b, 724n with local storage 714, 718, 722. As such, one or more modules of computer program instructions that are executing within the cloud-based storage system 703 (e.g., a monitoring module that is executing on its own EC2 instance) may be designed to handle the failure of one or more of the cloud computing instances 724a, 724b, 724n with local storage 714, 718, 722. In such an example, the monitoring module may handle the failure of one or more of the cloud computing instances 724a, 724b, 724n with local storage 714, 718, 722 by creating one or more new cloud computing instances with local storage, retrieving data that was stored on the failed cloud computing instances 724a, 724b, 724n from the cloud-based object storage 732, and storing the data retrieved from the cloud-based object storage 732 in local storage on the newly created cloud computing instances. Readers will appreciate that many variants of this process may be implemented.

Consider an example in which all cloud computing instances 724a, 724b, 724n with local storage 714, 718, 722 failed. In such an example, the monitoring module may create new cloud computing instances with local storage, where high-bandwidth instances types are selected that allow for the maximum data transfer rates between the newly created high-bandwidth cloud computing instances with local storage and the cloud-based object storage 732. Readers will appreciate that instances types are selected that allow for the maximum data transfer rates between the new cloud computing instances and the cloud-based object storage 732 such that the new high-bandwidth cloud computing instances can be rehydrated with data from the cloud-based object storage 732 as quickly as possible. Once the new high-bandwidth cloud computing instances are rehydrated with data from the cloud-based object storage 732, less expensive lower-bandwidth cloud computing instances may be created, data may be migrated to the less expensive lower-bandwidth cloud computing instances, and the high-bandwidth cloud computing instances may be terminated.

Readers will appreciate that in some embodiments, the number of new cloud computing instances that are created may substantially exceed the number of cloud computing instances that are needed to locally store all of the data stored by the cloud-based storage system 703. The number of new cloud computing instances that are created may substantially exceed the number of cloud computing instances that are needed to locally store all of the data stored by the cloud-based storage system 703 in order to more rapidly pull data from the cloud-based object storage 732 and into the new cloud computing instances, as each new cloud computing instance can (in parallel) retrieve some portion of the data stored by the cloud-based storage system 703. In such embodiments, once the data stored by the cloud-based storage system 703 has been pulled into the newly created cloud computing instances, the data may be consolidated within a subset of the newly created cloud computing instances and those newly created cloud computing instances that are excessive may be terminated.

Consider an example in which 1000 cloud computing instances are needed in order to locally store all valid data that users of the cloud-based storage system 703 have written to the cloud-based storage system 703. In such an example, assume that all 1,000 cloud computing instances fail. In such an example, the monitoring module may cause 100,000 cloud computing instances to be created, where each cloud computing instance is responsible for retrieving, from the cloud-based object storage 732, distinct 1/100,000^{th} chunks of the valid data that users of the cloud-based storage system 703 have written to the cloud-based storage system 703 and locally storing the distinct chunk of the dataset that it retrieved. In such an example, because each of the 100,000 cloud computing instances can retrieve data from the cloud-based object storage 732 in parallel, the caching layer may be restored 100 times faster as compared to an embodiment where the monitoring module only create 1000 replacement cloud computing instances. In such an example, over time the data that is stored locally in the 100,000 could be consolidated into 1,000 cloud computing instances and the remaining 99,000 cloud computing instances could be terminated.

Readers will appreciate that various performance aspects of the cloud-based storage system 703 may be monitored (e.g., by a monitoring module that is executing in an EC2 instance) such that the cloud-based storage system 703 can be scaled-up or scaled-out as needed. Consider an example in which the monitoring module monitors the performance of the cloud-based storage system 703 via communications with one or more of the cloud computing instances 704, 706 that each are used to support the execution of a storage controller application 708, 710, via monitoring communications between cloud computing instances 704, 706, 724a, 724b, 724n, via monitoring communications between cloud computing instances 704, 706, 724a, 724b, 724n and the cloud-based object storage 732, or in some other way. In such an example, assume that the monitoring module determines that the cloud computing instances 704, 706 that are used to support the execution of a storage controller application 708, 710 are undersized and not sufficiently servicing the I/O requests that are issued by users of the cloud-based storage system 703. In such an example, the monitoring module may create a new, more powerful cloud computing instance (e.g., a cloud computing instance of a type that includes more processing power, more memory, etc. . . . ) that includes the storage controller application such that the new, more powerful cloud computing instance can begin operating as the primary controller. Likewise, if the monitoring module determines that the cloud computing instances 704, 706 that are used to support the execution of a storage controller application 708, 710 are oversized and that cost savings could be gained by switching to a smaller, less powerful cloud computing instance, the monitoring module may create a new, less powerful (and less expensive) cloud computing instance that includes the storage controller application such that the new, less powerful cloud computing instance can begin operating as the primary controller.

Consider, as an additional example of dynamically sizing the cloud-based storage system 703, an example in which the monitoring module determines that the utilization of the local storage that is collectively provided by the cloud computing instances 724a, 724b, 724n has reached a predetermined utilization threshold (e.g., 95%). In such an example, the monitoring module may create additional cloud computing instances with local storage to expand the pool of local storage that is offered by the cloud computing instances. Alternatively, the monitoring module may create one or more new cloud computing instances that have larger amounts of local storage than the already existing cloud computing instances 724a, 724b, 724n, such that data stored in an already existing cloud computing instance 724a, 724b, 724n can be migrated to the one or more new cloud computing instances and the already existing cloud computing instance 724a, 724b, 724n can be terminated, thereby expanding the pool of local storage that is offered by the cloud computing instances. Likewise, if the pool of local storage that is offered by the cloud computing instances is unnecessarily large, data can be consolidated and some cloud computing instances can be terminated.

Readers will appreciate that the cloud-based storage system 703 may be sized up and down automatically by a monitoring module applying a predetermined set of rules that may be relatively simple of relatively complicated. In fact, the monitoring module may not only take into account the current state of the cloud-based storage system 703, but the monitoring module may also apply predictive policies that are based on, for example, observed behavior (e.g., every night from 10 PM until 6 AM usage of the storage system is relatively light), predetermined fingerprints (e.g., every time a virtual desktop infrastructure adds 100 virtual desktops, the number of IOPS directed to the storage system increase by X), and so on. In such an example, the dynamic scaling of the cloud-based storage system 703 may be based on current performance metrics, predicted workloads, and many other factors, including combinations thereof.

Readers will further appreciate that because the cloud-based storage system 703 may be dynamically scaled, the cloud-based storage system 703 may even operate in a way that is more dynamic. Consider the example of garbage collection. In a traditional storage system, the amount of storage is fixed. As such, at some point the storage system may be forced to perform garbage collection as the amount of available storage has become so constrained that the storage system is on the verge of running out of storage. In contrast, the cloud-based storage system 703 described here can always ‘add’ additional storage (e.g., by adding more cloud computing instances with local storage). Because the cloud-based storage system 703 described here can always ‘add’ additional storage, the cloud-based storage system 703 can make more intelligent decisions regarding when to perform garbage collection. For example, the cloud-based storage system 703 may implement a policy that garbage collection only be performed when the number of IOPS being serviced by the cloud-based storage system 703 falls below a certain level. In some embodiments, other system-level functions (e.g., deduplication, compression) may also be turned off and on in response to system load, given that the size of the cloud-based storage system 703 is not constrained in the same way that traditional storage systems are constrained.

Readers will appreciate that embodiments of the present disclosure resolve an issue with block-storage services offered by some cloud computing environments as some cloud computing environments only allow for one cloud computing instance to connect to a block-storage volume at a single time. For example, in Amazon AWS, only a single EC2 instance may be connected to an EBS volume. Through the use of EC2 instances with local storage, embodiments of the present disclosure can offer multi-connect capabilities where multiple EC2 instances can connect to another EC2 instance with local storage (‘a drive instance’). In such embodiments, the drive instances may include software executing within the drive instance that allows the drive instance to support I/O directed to a particular volume from each connected EC2 instance. As such, some embodiments of the present disclosure may be embodied as multi-connect block storage services that may not include all of the components depicted in FIG. 7.

In some embodiments, especially in embodiments where the cloud-based object storage 732 resources are embodied as Amazon S3, the cloud-based storage system 703 may include one or more modules (e.g., a module of computer program instructions executing on an EC2 instance) that are configured to ensure that when the local storage of a particular cloud computing instance is rehydrated with data from S3, the appropriate data is actually in S3. This issue arises largely because S3 implements an eventual consistency model where, when overwriting an existing object, reads of the object will eventually (but not necessarily immediately) become consistent and will eventually (but not necessarily immediately) return the overwritten version of the object. To address this issue, in some embodiments of the present disclosure, objects in S3 are never overwritten. Instead, a traditional ‘overwrite’ would result in the creation of the new object (that includes the updated version of the data) and the eventual deletion of the old object (that includes the previous version of the data).

In some embodiments of the present disclosure, as part of an attempt to never (or almost never) overwrite an object, when data is written to S3 the resultant object may be tagged with a sequence number. In some embodiments, these sequence numbers may be persisted elsewhere (e.g., in a database) such that at any point in time, the sequence number associated with the most up-to-date version of some piece of data can be known. In such a way, a determination can be made as to whether S3 has the most recent version of some piece of data by merely reading the sequence number associated with an object—and without actually reading the data from S3. The ability to make this determination may be particularly important when a cloud computing instance with local storage crashes, as it would be undesirable to rehydrate the local storage of a replacement cloud computing instance with out-of-date data. In fact, because the cloud-based storage system 703 does not need to access the data to verify its validity, the data can stay encrypted and access charges can be avoided.

In the example depicted in FIG. 7, and as described above, the cloud computing instances 704, 706 that are used to support the execution of the storage controller applications 708, 710 may operate in a primary/secondary configuration where one of the cloud computing instances 704, 706 that are used to support the execution of the storage controller applications 708, 710 is responsible for writing data to the local storage 714, 718, 722 that is attached to the cloud computing instances with local storage 724a, 724b, 724n. In such an example, however, because each of the cloud computing instances 704, 706 that are used to support the execution of the storage controller applications 708, 710 can access the cloud computing instances with local storage 724a, 724b, 724n, both of the cloud computing instances 704, 706 that are used to support the execution of the storage controller applications 708, 710 can service requests to read data from the cloud-based storage system 703.

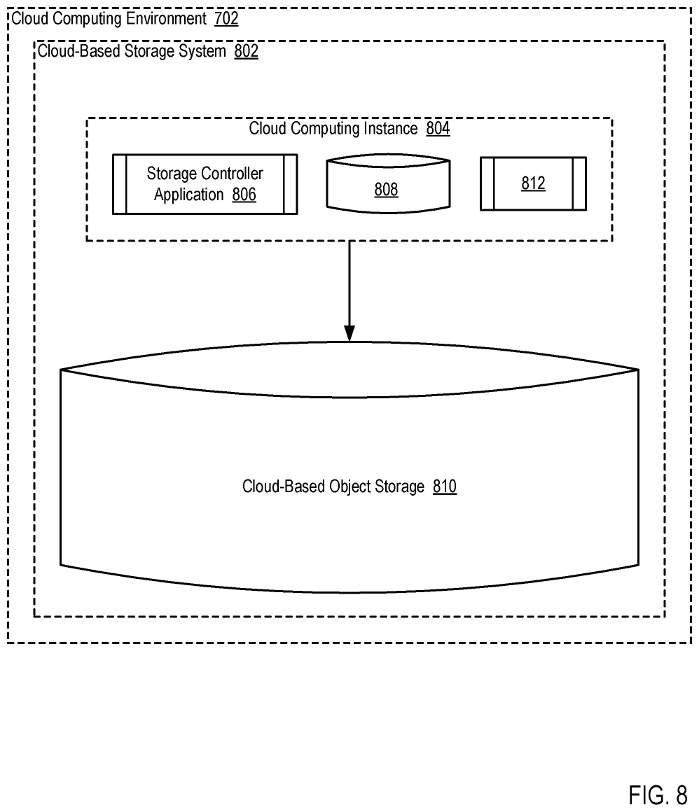

For further explanation, FIG. 8 sets forth an example of an additional cloud-based storage system 802 in accordance with some embodiments of the present disclosure. In the example depicted in FIG. 8, the cloud-based storage system 802 is created entirely in a cloud computing environment 702 such as, for example, AWS, Microsoft Azure, Google Cloud Platform, IBM Cloud, Oracle Cloud, and others. The cloud-based storage system 802 may be used to provide services similar to the services that may be provided by the storage systems described above. For example, the cloud-based storage system 802 may be used to provide block storage services to users of the cloud-based storage system 802, the cloud-based storage system 703 may be used to provide storage services to users of the cloud-based storage system 703 through the use of solid-state storage, and so on.

The cloud-based storage system 802 depicted in FIG. 8 may operate in a manner that is somewhat similar to the cloud-based storage system 703 depicted in FIG. 7, as the cloud-based storage system 802 depicted in FIG. 8 includes a storage controller application 806 that is being executed in a cloud computing instance 804. In the example depicted in FIG. 8, however, the cloud computing instance 804 that executes the storage controller application 806 is a cloud computing instance 804 with local storage 808. In such an example, data written to the cloud-based storage system 802 may be stored in both the local storage 808 of the cloud computing instance 804 and also in cloud-based object storage 810 in the same manner that the cloud-based object storage 810 was used above. In some embodiments, for example, the storage controller application 806 may be responsible for writing data to the local storage 808 of the cloud computing instance 804 while a software daemon 812 may be responsible for ensuring that the data is written to the cloud-based object storage 810 in the same manner that the cloud-based object storage 810 was used above. In other embodiments, the same entity (e.g., the storage controller application) may be responsible for writing data to the local storage 808 of the cloud computing instance 804 and also responsible for ensuring that the data is written to the cloud-based object storage 810 in the same manner that the cloud-based object storage 810 was used above

Readers will appreciate that a cloud-based storage system 802 depicted in FIG. 8 may represent a less expensive, less robust version of a cloud-based storage system than was depicted in FIG. 7. In yet alternative embodiments, the cloud-based storage system 802 depicted in FIG. 8 could include additional cloud computing instances with local storage that supported the execution of the storage controller application 806, such that failover can occur if the cloud computing instance 804 that executes the storage controller application 806 fails. Likewise, in other embodiments, the cloud-based storage system 802 depicted in FIG. 8 can include additional cloud computing instances with local storage to expand the amount local storage that is offered by the cloud computing instances in the cloud-based storage system 802.

Readers will appreciate that many of the failure scenarios described above with reference to FIG. 7 would also apply cloud-based storage system 802 depicted in FIG. 8. Likewise, the cloud-based storage system 802 depicted in FIG. 8 may be dynamically scaled up and down in a similar manner as described above. The performance of various system-level tasks may also be executed by the cloud-based storage system 802 depicted in FIG. 8 in an intelligent way, as described above.

Readers will appreciate that, in an effort to increase the resiliency of the cloud-based storage systems described above, various components may be located within different availability zones. For example, a first cloud computing instance that supports the execution of the storage controller application may be located within a first availability zone while a second cloud computing instance that also supports the execution of the storage controller application may be located within a second availability zone. Likewise, the cloud computing instances with local storage may be distributed across multiple availability zones. In fact, in some embodiments, an entire second cloud-based storage system could be created in a different availability zone, where data in the original cloud-based storage system is replicated (synchronously or asynchronously) to the second cloud-based storage system so that if the entire original cloud-based storage system went down, a replacement cloud-based storage system (the second cloud-based storage system) could be brought up in a trivial amount of time.

Readers will appreciate that the cloud-based storage systems described herein may be used as part of a fleet of storage systems. In fact, the cloud-based storage systems described herein may be paired with on-premises storage systems. In such an example, data stored in the on-premises storage may be replicated (synchronously or asynchronously) to the cloud-based storage system, and vice versa.

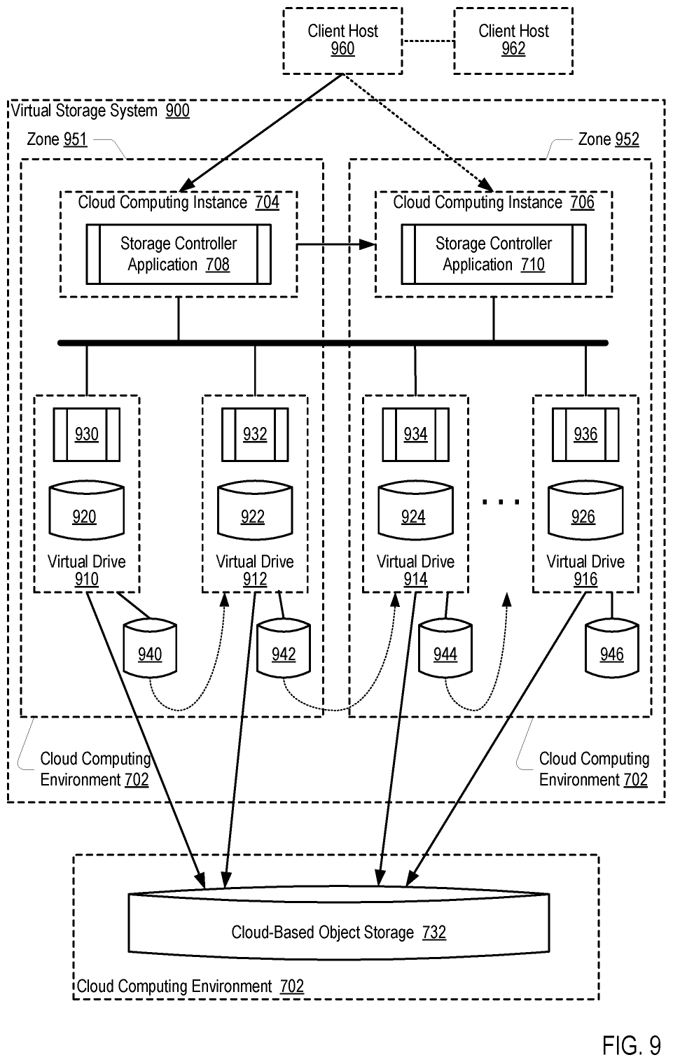

For further explanation, FIG. 9 illustrates an example virtual storage system architecture 900 in accordance with some embodiments. The virtual storage system architecture may include similar cloud-based computing resources as the cloud-based storage systems described above with reference to FIG. 7 and FIG. 8.

As described above with reference to FIGS. 1A-3E, in some embodiments of a physical storage system, a physical storage system may include one or more controllers providing storage services to one or more hosts, and with the physical storage system including durable storage devices, such as solid state drives or hard disks, and also including some fast durable storage, such as NVRAM. In some examples, the fast durable storage may be used for staging or transactional commits or for speeding up acknowledgement of operation durability to reduce latency for host requests.

Generally, fast durable storage is often used for intent logging, fast completions, or quickly ensuring transactional consistency, where such (and similar) purposes are referred to herein as staging memory. Generally, both physical and virtual storage systems may have one or more controllers, and may have specialized storage components, such as in the case of physical storage devices, specialized storage devices. Further, in some cases, in physical and virtual storage systems, staging memory may be organized and reorganized in a variety of ways, such as in examples described later. In some examples, in whatever way that memory components or memory devices are constructed, generated, or organized, there may be a set of storage system logic that executes to implement a set of advertised storage services and that stores bulk data for indefinite durations, and there may also be some quantity of staging memory.

In some examples, controller logic that operates a physical storage system, such as physical storage systems 1A-3E, may be carried out within a virtual storage system by providing suitable virtual components to, individually or in the aggregate, serve as substitutes for hardware components in a physical storage system—where the virtual components are configured to operate the controller logic and to interact with other virtual components that are configured to replace physical components other than the controller.

Continuing with this example, virtual components, executing controller logic, may implement and/or adapt high availability models used to keep a virtual storage system operating in case of failures. As another example, virtual components, executing controller logic, may implement protocols to keep the virtual storage system from losing data in the face of transient failures that may exceed what the virtual storage system may tolerate while continuing to operate.

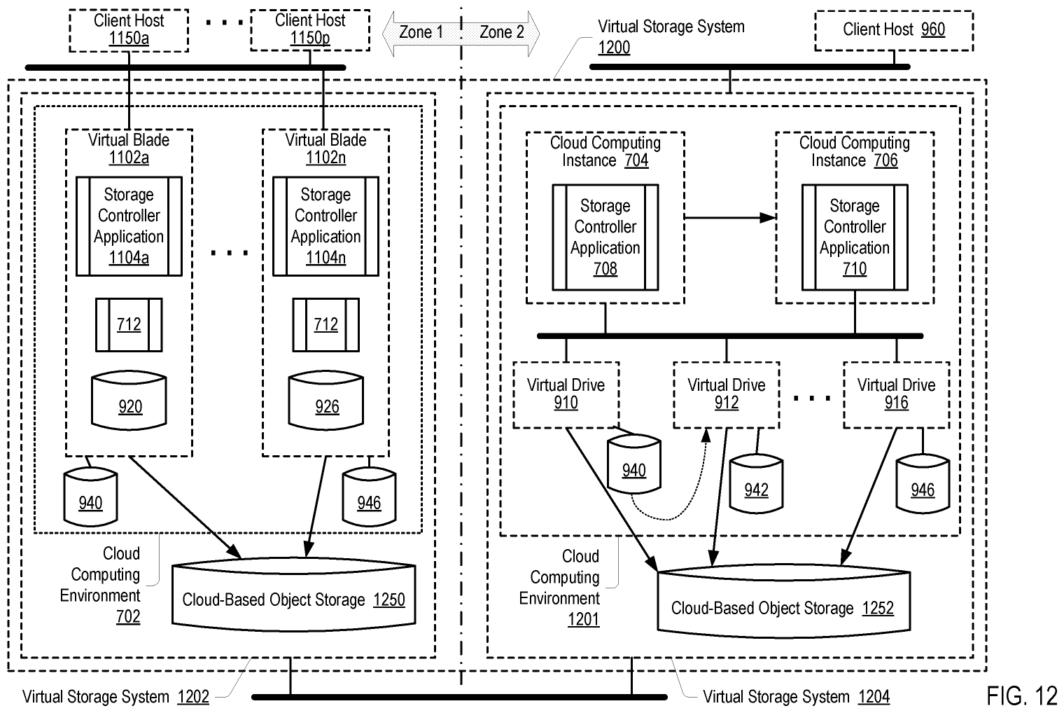

In some implementations, and particularly with regard to the various virtual storage system architectures described with reference to FIGS. 12-17, a computing environment may include a set of available, advertised constructs that are typical to cloud-based infrastructures as service platforms, such as cloud infrastructures provided by Amazon Web Services™, Microsoft Azure™, and/or Google Cloud Platform™. In some implementations, example constructs, and construct characteristics within such cloud platforms may include:
Compute instances, where a compute instance may execute or run as virtual machines flexibly allocated to physical host servers;
Division of computing resources into separate geographic regions, where computing resources may be distributed or divided among separate, geographic regions, such that users within a same region or same zone as a given cloud computing resource may experience faster and/or higher bandwidth access as compared to users in a different region or different zone than computing resources;
Division of resources within geographic regions into “availability” zones with separate availability and survivability in cases of wide-scale data center outages, network failures, power grid failures, administrative mistakes, and so on. Further, in some examples, resources within a particular cloud platform that are in separate availability zones within a same geographic region generally have fairly high bandwidth and reasonably low latency between each other;
Local instance storage, such as hard drives, solid-state drives, rack-local storage, that may provide private storage to a compute instance. Other examples of local instance storage are described above with reference to FIGS. 7-8;
Block stores that are relatively high-speed and durable, and which may be connected to a virtual machine, but whose access may be migrated. Some examples include EBS (Elastic Block Store™) in AWS, Managed Disks in Microsoft Azure™, and Compute Engine persistent disks in Google Cloud Platform™. EBS in AWS operates within a single availability zone, but is otherwise reasonably reliable and available, and intended for long-term use by compute instances, even if those compute instances can move between physical systems and racks;
Object stores, such as Amazon S3™ or an object store using a protocol derived from, compatible with S3, or that has some similar characteristics to S3 (for example, Microsoft's Azure Blob Storage™). Generally, object stores are very durable, surviving widespread outages through inter-availability zone and cross-geography replication;
Cloud platforms, which may support a variety of object stores or other storage types that may vary in their combinations of capacity prices, access prices, expected latency, expected throughput, availability guarantees, or durability guarantees. For example, in AWS™, Standard and Infrequent Access S3 storage classes (referenced herein as standard and write-mostly storage classes) differ in availability (but not durability) as well as in capacity and access prices (with the infrequent access storage tier being less expensive on capacity, but more expensive for retrieval, and with 1/10th the expected availability). Infrequent Access S3 also supports an even less expensive variant that is not tolerant to complete loss of an availability zone, which is referred to herein as a single-availability-zone durable store. AWS further supports archive tiers such as Glacier™ and Deep Glacier™ that provide their lowest capacity prices, but with very high access latency on the order of minutes to hours for Glacier, and up to 12 hours with limits on retrieval frequency for Deep Glacier. Glacier and Deep Glacier are referred to herein as examples of archive and deep archive storage classes;
Databases, and often multiple different types of databases, including high-scale key-value store databases with reasonable durability (similar to high-speed, durable block stores) and convenient sets of atomic update primitives. Some examples of durable key-value databases include AWS DynamoDB™, Google Cloud Platform Big Table™, and/or Microsoft Azure's CosmoDB™; and
Dynamic functions, such as code snippets that can be configured to run dynamically within the cloud platform infrastructure in response to events or actions associated with the configuration. For example, in AWS, these dynamic functions are called AWS Lambdas™, and Microsoft Azure and Google Cloud Platform refers to such dynamic functions as Azure Functions™ and Cloud Functions™, respectively.

In some implementations, local instance storage is not intended to be provisioned for long-term use, and in some examples, local instance storage may not be migrated as virtual machines migrate between host systems. In some cases, local instance storage may also not be shared between virtual machines, and may come with few durability guarantees due to their local nature (likely surviving local power and software faults, but not necessarily more wide spread failures). Further, in some examples, local instance storage, as compared to object storage, may be reasonably inexpensive and may not be billed based on I/Os issued against them, which is often the case with the more durable block storage services.

In some implementations, objects within object stores are easy to create (for example, a web service PUT operation to create an object with a name within some bucket associated with an account) and to retrieve (for example, a web service GET operation), and parallel creates and retrievals across a sufficient number of objects may yield enormous bandwidth. However, in some cases, latency is generally very poor, and modifications or replacement of objects may complete in unpredictable amounts of time, or it may be difficult to determine when an object is fully durable and consistently available across the cloud platform infrastructure. Further, generally, availability, as opposed to durability, of object stores is often low, which is often an issue with many services running in cloud environments.

In some implementations, as an example baseline, a virtual storage system may include one or more of the following virtual components and concepts for constructing, provisioning, and/or defining a virtual storage system built on a cloud platform:
Virtual controller, such as a virtual storage system controller running on a compute instance within a cloud platform's infrastructure or cloud computing environment. In some examples, a virtual controller may run on virtual machines, in containers, or on bare metal servers;
Virtual drives, where a virtual drive may be a specific storage object that is provided to a virtual storage system controller to represent a dataset; for example, a virtual drive may be a volume or an emulated disk drive that within the virtual storage system may serve analogously to a physical storage system “storage device”. Further, virtual drives may be provided to virtual storage system controllers by “virtual drive servers”;
Virtual drive servers may be implemented by compute instances, where virtual drive servers may present storage, such as virtual drives, out of available components provided by a cloud platform, such as various types of local storage options, and where virtual drive servers implement logic that provides virtual drives to one or more virtual storage system controllers, or in some cases, provides virtual drives to one or more virtual storage systems.
Staging memory, which may be fast and durable, or at least reasonably fast and reasonably durable, where reasonably durable may be specified according to a durability metric, and where reasonably fast may be specified according to a performance metric, such as IOPS;
Virtual storage system dataset, which may be a defined collection of data and metadata that represents coherently managed content that represents a collection of file systems, volumes, objects, and other similar addressable portions of memory;
Object storage, which may provide back-end, durable object storage to the staging memory. As illustrated in FIG. 9, cloud-based object storage 732 may be managed by the virtual drives 910-916;
Segments, which may be specified as medium-sized chunks of data. For example, a segment may be defined to be within a range of 1 MB-64 MB, where a segment may hold a combination of data and metadata; and
Virtual storage system logic, which may be a set of algorithms running at least on the one or more virtual controllers 708, 710, and in some cases, with some virtual storage system logic also running on one or more virtual drives 910-916.

In some implementations, a virtual controller may take in or receive I/O operations and/or configuration requests from client hosts 960, 962 (possibly through intermediary servers, not depicted) or from administrative interfaces or tools, and then ensure that I/O requests and other operations run through to completion.

In some examples, virtual controllers may present file systems, block-based volumes, object stores, and/or certain kinds of bulk storage databases or key/value stores, and may provide data services such as snapshots, replication, migration services, provisioning, host connectivity management, deduplication, compression, encryption, secure sharing, and other such storage system services.

In the example virtual storage system 900 architecture illustrated in FIG. 9, a virtual storage system 900 includes two virtual controllers, where one virtual controller is running within one time zone, time zone 951, and another virtual controller is running within another time zone, time zone 952. In this example, the two virtual controllers are depicted as, respectively, storage controller application 708 running within cloud computing instance 704 and storage controller application 710 running within cloud computing instance 706.

In some implementations, a virtual drive server, as discussed above, may represent to a host something similar to physical storage device, such as a disk drive or a solid-state drive, where the physical storage device is operating within the context of a physical storage system.

However, while in this example, the virtual drive presents similarly to a host as a physical storage device, the virtual drive is implemented by a virtual storage system architecture—where the virtual storage system architecture may be any of those depicted among FIGS. 4-16. Further, in contrast to virtual drives that have as an analog a physical storage device, as implemented within the example virtual storage system architectures, a virtual drive server, may not have an analog within the context of a physical storage system. Specifically, in some examples, a virtual drive server may implement logic that goes beyond what is typical of storage devices in physical storage systems, and may in some cases rely on atypical storage system protocols between the virtual drive server and virtual storage system controllers that do not have an analog in physical storage systems. However, conceptually, a virtual drive server may share similarities to a scale-out shared-nothing or software-defined storage systems.

In some implementations, with reference to FIG. 9, the respective virtual drive servers 910-916 may implement respective software applications or daemons 930-936 to provide virtual drives whose functionality is similar or even identical to that of a physical storage device which allows for greater ease in porting storage system software or applications that are designed for physical storage systems. For example, they could implement a standard SAS, SCSI or NVMe protocol, or they could implement these protocols but with minor or significant non-standard extensions.

In some implementations, with reference to FIG. 9, staging memory may be implemented by one or more virtual drives 910-916, where the one or more virtual drives 910-916 store data within respective block-store volumes 940-946 and local storage 920-926. In this example, the block storage volumes may be AWS EBS volumes that may be attached, one after another, as depicted in FIG. 9, to two or more other virtual drives. As illustrated in FIG. 9, block storage volume 940 is attached to virtual drive 912, block storage volume 942 is attached to virtual drive 914, and so on.

In some implementations, a segment may be specified to be part of an erasure coded set, such as based on a RAID-style implementation, where a segment may store calculated parity content based on erasure codes (e.g., RAID-5 P and Q data) computed from content of other segments. In some examples, contents of segments may be created once, and after the segment is created and filled in, not modified until the segment is discarded or garbage collected.

In some implementations, virtual storage system logic may also run from other virtual storage system components, such as dynamic functions. Virtual storage system logic may provide a complete implementation of the capabilities and services advertised by the virtual storage system 900, where the virtual storage system 900 uses one or more available cloud platform components, such as those described above, to implement these services reliably and with appropriate durability.

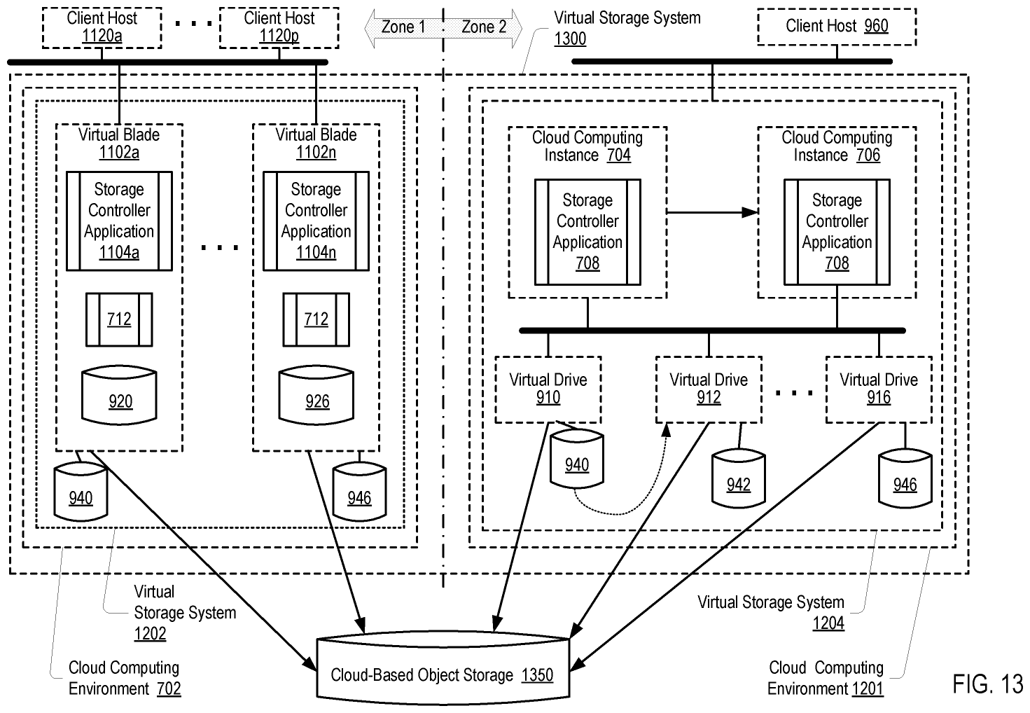

While the example virtual storage system 900 illustrated in FIG. 9 includes two virtual controllers, more generally, other virtual storage system architectures may have more or fewer virtual controllers, as illustrated in FIGS. 13-16. Further, in some implementations, and similar to the physical storage systems described in FIGS. 1A-3E, a virtual storage system may include an active virtual controller and one or more passive virtual controllers.

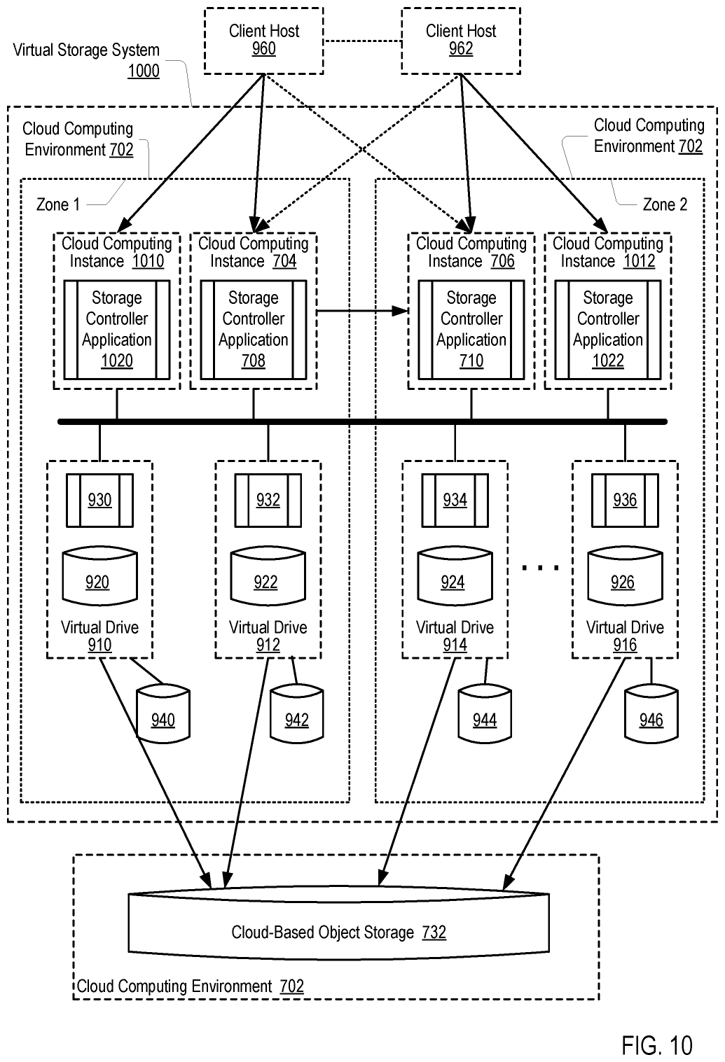

For further explanation, FIG. 10 illustrates an example virtual storage system architecture 1000 in accordance with some embodiments. The virtual storage system architecture may include similar cloud-based computing resources as the cloud-based storage systems described above with reference to FIGS. 7-9.

In this implementation, a virtual storage system may run virtual storage system logic, as specified above with reference to FIG. 9, concurrently on multiple virtual controllers, such as by dividing up a dataset or by careful implementation of concurrent distributed algorithms. In this example, the multiple virtual controllers 1020, 708, 710, 1022 are implemented within respective cloud computing instances 1010, 704, 706, 1012.

As described above with reference to FIG. 9, in some implementations, a particular set of hosts may be directed preferentially or exclusively to a subset of virtual controllers for a dataset, while a particular different set of hosts may be directed preferentially or exclusively to a different subset of controllers for that same dataset. For example, SCSI ALUA (Asymmetric Logical Unit Access), or NVMe ANA (Asymmetric Namespace Access) or some similar mechanism, could be used to establish preferred (sometimes called “optimized”) path preferences from one host to a subset of controllers where traffic is generally directed to the preferred subset of controllers but where, such as in the case of faulted requests or network failures or virtual storage system controller failures, that traffic could be redirected to a different subset of virtual storage system controllers. Alternately, SCSI/NVMe volume advertisements or network restrictions, or some similar alternative mechanism, could force all traffic from a particular set of hosts exclusively to one subset of controllers, or could force traffic from a different particular set of hosts to a different subset of controllers.

As illustrated in FIG. 10, a virtual storage system may preferentially or exclusively direct I/O requests from host 960 to virtual storage controllers 1020 and 708 with storage controllers 710 and perhaps 1022 potentially being available to host 960 for use in cases of faulted requests, and may preferentially or exclusively direct I/O requests from host 962 to virtual storage controllers 710 and 1022 with storage controllers 708 and perhaps 1020 potentially being available to host 962 for use in cases of faulted requests. In some implementations, a host may be directed to issue I/O requests to one or more virtual storage controllers within the same availability zone as the host, with virtual storage controllers in a different availability zone from the host being available for use in cases of faults.

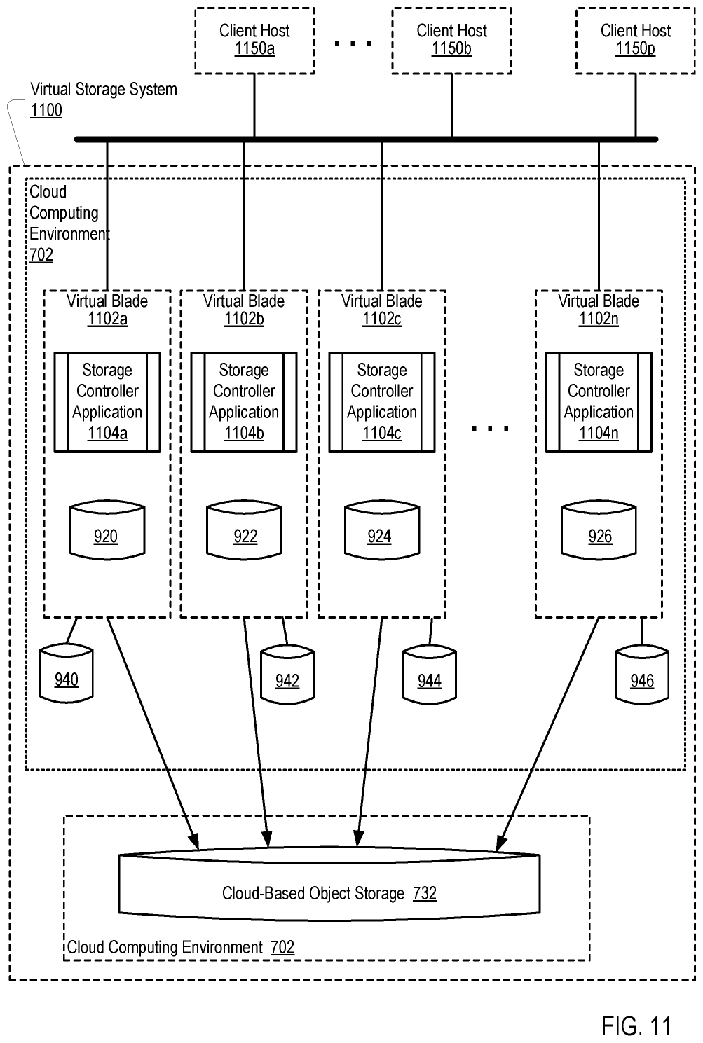

For further explanation, FIG. 11 illustrates an example virtual storage system architecture 1100 in accordance with some embodiments. The virtual storage system architecture may include similar cloud-based computing resources as the cloud-based storage systems described above with reference to FIGS. 7-10.

In some implementations, boundaries between virtual controllers and virtual drive servers that host virtual drives may be flexible. Further, in some examples, the boundaries between virtual components may not be visible to client hosts 1150a-1150p, and client hosts 1150a-1150p may not detect any distinction between two differently architected virtual storage systems that provides a same set of storage system services.

For example, virtual controllers and virtual drives may be merged into a single virtual entity that may provide similar functionality to a traditional, blade-based scale-out storage system. In this example, virtual storage system 1100 includes n virtual blades, virtual blades 1402a-1402n, where each respective virtual blade 1102a-1102n may include a respective virtual controller 1104a-1104n, and also include respective local storage 920-926,940-946, but where the storage function may make use of a platform provided object store as might be the case with virtual drive implementations described previously.

In some implementations, because virtual drive servers support general purpose compute, this virtual storage system architecture supports functions migrating between virtual storage system controllers and virtual drive servers. Further, in other cases, this virtual storage system architecture supports other kinds of optimizations, such as optimizations described above that may be performed within staging memory. Further, virtual blades may be configured with varying levels of processing power, where the performance specifications of a given one or more virtual blades may be based on expected optimizations to be performed.

For further explanation, FIG. 12 illustrates an example virtual storage system architecture 1200 in accordance with some embodiments. The virtual storage system architecture may include similar cloud-based computing resources as the cloud-based storage systems described above with reference to FIG. 7-11.

In this implementation, a virtual storage system 1200 may be adapted to different availability zones, where such a virtual storage system 1200 may use cross-storage system synchronous replication logic to isolate as many parts of an instance of a virtual storage system as possible within one availability zone. For example, the presented virtual storage system 1200 may be constructed from a first virtual storage system 1202 in one availability zone, zone 1, that synchronously replicates data to a second virtual storage system 1204 in another availability zone, zone 2, such that the presented virtual storage system can continue running and providing its services even in the event of a loss of data or availability in one availability zone or the other. Such an implementation could be further implemented to share use of durable objects, such that the storing of data into the object store is coordinated so that the two virtual storage systems do not duplicate the stored content. Further, in such an implementation, the two synchronously replicating storage systems may synchronously replicate updates to the staging memories and perhaps local instance stores within each of their availability zones, to greatly reduce the chance of data loss, while coordinating updates to object stores as a later asynchronous activity to greatly reduce the cost of capacity stored in the object store.

In this example, virtual storage system 1204 is implemented within cloud computing environments 1201. Further, in this example, virtual storage system 1202 may use cloud-based object storage 1250, and virtual storage system 1204 may use cloud-based storage 1252, where in some cases, such as AWS S3, the different object storages 1250, 1252 may be a same cloud object storage with different buckets.

Continuing with this example, virtual storage system 1202 may, in some cases, synchronously replicate data to other virtual storage systems, or physical storage systems, in other availability zones (not depicted).

In some implementations, the virtual storage system architecture of virtual storage systems 1202 and 1204 may be distinct, and even incompatible—where synchronous replication may depend instead on synchronous replication models being protocol compatible. Synchronous replication is described in greater detail above with reference to FIGS. 3D and 3E.

In some implementations, virtual storage system 1202 may be implemented similarly to virtual storage system 1100, described above with reference to FIG. 11, and virtual storage system 1204 may be implemented similarly to virtual storage system 900, described above with reference to FIG. 9.

For further explanation, FIG. 13 illustrates an example virtual storage system architecture 1200 in accordance with some embodiments. The virtual storage system architecture may include similar cloud-based computing resources as the cloud-based storage systems described above with reference to FIGS. 7-12.

In some implementations, similar to the example virtual storage system 1200 described above with reference to FIG. 12, a virtual storage system 1300 may include multiple virtual storage systems 1202, 1204 that coordinate to perform synchronous replication from one virtual storage system to another virtual storage system.

However, in contrast to the example virtual storage system 1200 described above, the virtual storage system 1300 illustrated in FIG. 13 provides a single cloud-based object storage 1350 that is shared among the virtual storage systems 1202, 1204.

In this example, the shared cloud-based object storage 1350 may be treated as an additional data replica target, with delayed updates using mechanisms and logic associated with consistent, but non-synchronous replication models. In this way, a single cloud-based object storage 1350 may be shared consistently between multiple, individual virtual storage systems 1202, 1204 of a virtual storage system 1300.

In each of these example virtual storage systems, virtual storage system logic may generally incorporate distributed programming concepts to carry out the implementation of the core logic of the virtual storage system. In other words, as applied to the virtual storage systems, the virtual system logic may be distributed between virtual storage system controllers, scale-out implementations that combine virtual system controllers and virtual drive servers, and implementations that split or otherwise optimize processing between the virtual storage system controllers and virtual drive servers.

A virtual storage system may dynamically adjust cloud platform resource usage in response to changes in cost requirements based upon cloud platform pricing structures, as described in greater detail below.

Under various conditions, budgets, capacities, usage and/or performance needs may change, and a user may be presented with cost projections and a variety of costing scenarios that may include increasing a number of server or storage components, the available types of components, the platforms that may provide suitable components, and/or models for both how alternatives to a current setup might work and cost in the future. In some examples, such cost projections may include costs of migrating between alternatives given that network transfers incur a cost, where migrations tend to include administrative overhead, and for a duration of a transfer of data between types of storage or vendors, additional total capacity may be needed until necessary services are fully operational.

Further, in some implementations, instead of pricing out what is being used and providing options for configurations based on potential costs, a user may, instead, provide a budget, or otherwise specify an expense threshold, and the storage system service may generate a virtual storage system configuration with specified resource usage such that the storage system service operates within the budget or expense threshold.

Continuing with this example of a storage system service operating within a budget or expense threshold—with regard to compute resources, while limiting compute resources limits performance, costs may be managed based on modifying configurations of virtual application servers, virtual storage system controllers, and other virtual storage system components by adding, removing, or replacing with faster or slower virtual storage system components. In some examples, if costs or budgets are considered over given lengths of time, such as monthly, quarterly, or yearly billing, then by ratcheting down the cost of virtual compute resources in response to lowered workloads, more compute resources may be available in response to increases in workloads.

Further, in some examples, in response to determining that given workloads may be executed at flexible times, those workloads may be scheduled to execute during periods of time that are less expensive to operate or initiate compute resources within the virtual storage system. In some examples, costs and usage may be monitored over the course of a billing period to determine whether usage earlier in the billing period may affect the ability to run at expected or acceptable performance levels later in the billing period, or whether lower than expected usage during parts of a billing period suggest there is sufficient budget remaining to run optional work or to suggest that renegotiating terms would reduce costs.

Continuing with this example, such a model of dynamic adjustments to a virtual storage system in response to cost or resource constraints may be extend from compute resources to also include storage resources. However, a different consideration for storage resources is that storage resources have less elastic costs than compute resources because stored data continues to occupy storage resources over a given period of time.

Further, in some examples, there may be transfer costs within cloud platforms associated with migrating data between storage services that have different capacity and transfer prices. Each of these costs of maintaining virtual storage system resources must be considered and may serve as a basis for configuring, deploying, and modifying compute and/or storage resources within a virtual storage system.

In some cases, the virtual storage system may adjust in response to storage costs based on cost projections that may include comparing continuing storage costs using existing resources as compared to a combination of transfer costs of the storage content and storage costs of less expensive storage resources (such as storage provided by a different cloud platform, or to or from storage hardware in customer-managed data centers, or to or from customer-managed hardware kept in a collocated shared management data center). In this way, over a given time span that is long enough to support data transfers, and in some cases based on predictable use patterns, a budget limit-based virtual storage system model may adjust in response to different cost or budget constraints or requirements.

In some implementations, as capacity grows in response to an accumulation of stored data, and as workloads, over a period of time, fluctuate around some average or trend line, a dynamically configurable virtual storage system may calculate whether a cost of transferring an amount of data to some less expensive type of storage class or less expensive location of storage may be possible within a given budget or within a given budget change. In some examples, the virtual storage system may determine storage transfers based on costs over a period of time that includes a billing cycle or multiple billing cycles, and in this way, preventing a budget or cost from being exceeded in a subsequent billing cycle.

In some implementations, a cost managed or cost constrained virtual storage system, in other words, a virtual storage system that reconfigures itself in response to cost constraints or other resource constraints, may also make use of write-mostly, archive, or deep archive storage classes that are available from cloud infrastructure providers. Further, in some cases, the virtual storage system may operate in accordance with the models and limitations described elsewhere with regard to implementing a storage system to work with differently behaving storage classes.

For example, a virtual storage system may make automatic use of a write-mostly storage class based on a determination that a cost or budget may be saved and reused for other purposes if data that is determined to have a low likelihood of access is consolidated, such as into segments that consolidate data with similar access patterns or similar access likelihood characteristics.

Further, in some cases, consolidated segments of data may then be migrated to a write-mostly storage class, or other lower cost storage class. In some examples, use of local instance stores on virtual drives may result in cost reductions that allow virtual storage system resource adjustments that result in reducing costs to satisfy cost or budget change constraints. In some cases, the local instance stores may use write-mostly object stores as a backend, and because read load is often taken up entirely by the local instance stores, the local instance stores may operate mostly as a cache rather than storing complete copies of a current dataset.

In some examples, a single-availability, durable store may also be used if a dataset may be identified that is not required or expected to survive loss of an availability zone, and such use may serve as a cost savings basis in dynamically reconfiguring a virtual storage system. In some cases, use of a single-availability zone for a dataset may include an explicit designation of the dataset, or indirect designation through some storage policy.

Further, the designation or storage policy may also include an association with a specific availability zone; however, in some cases, the specific availability zone may be determined by a dataset association with, for example, host systems that are accessing a virtual storage system from within a particular availability zone. In other words, in this example, the specific availability zone may be determined to be a same availability zone that includes a host system.

In some implementations, a virtual storage system may base a dynamic reconfiguration on use of archive or deep archive storage classes, if the virtual storage system is able to provide or satisfy performance requirements while storage operations are limited by the constraints of archive and/or deep archive storage classes. Further, in some cases, transfer of old snapshot or continuous data protection datasets, or other datasets that are no longer active, may be enabled to be transferred to archive storage classes based on a storage policy specifying a data transfer in response to a particular activity level, or based on a storage policy specify a data transfer in response to data not being accessed for a specified period of time. In other examples, the virtual storage system may transfer data to an archive storage class in response to a specific user request.

Further, given that retrieval from an archive storage class may take minutes, hours, or days, users of the particular dataset being stored in an archive or deep archive storage class may be requested by the virtual storage system to provide specific approval of the time required to retrieve the dataset. In some examples, in the case of using deep archive storage classes, there may also be limits on how frequently data access is allowed, which may put further constraints on the circumstances in which the dataset may be stored in archive or deep archive storage classes.

Implementing a virtual storage system to work with differently behaving storage classes may be carried out using a variety of techniques, as described in greater detail below.

In various implementations, some types of storage, such as a write-mostly storage class may have lower prices for storing and keeping data than for accessing and retrieving data. In some examples, if data may be identified or determined to be rarely retrieved, or retrieved below a specified threshold frequency, then costs may be reduced by storing the data within a write-mostly storage class. In some cases, such a write-mostly storage class may become an additional tier of storage that may be used by virtual storage systems with access to one or more cloud infrastructures that provide such storage classes.

For example, a storage policy may specify that a write-mostly storage class, or other archive storage class, may be used for storing segments of data from snapshots, checkpoints, or historical continuous data protection datasets that have been overwritten or deleted from recent instances of the datasets they track. Further, in some cases, these segments may be transferred based on exceeding a time limit without being accessed, where the time limit may be specified in a storage policy, and where the time limit corresponds to a low likelihood of retrieval—outside of inadvertent deletion or corruption that may require access to an older historical copy of a dataset, or a fault or larger-scale disaster that may require some forensic investigation, a criminal event, an administrative error such as inadvertently deleting more recent data or the encryption or deletion or a combination of parts or all of a dataset and its more recent snapshots, clones, or continuous data protection tracking images as part of a ransomware attack.

In some implementations, use of a cloud-platform write-mostly storage class may create cost savings that may then be used to provision compute resources to improve performance of the virtual storage system. In some examples, if a virtual storage system tracks and maintains storage access information, such as using an age and snapshot/clone/continuous-data-protection-aware garbage collector or segment consolidation and/or migration algorithm, then the virtual storage system may use a segment model as part of establishing efficient metadata references while minimizing an amount of data transferred to the mostly-write storage class.

Further, in some implementations, a virtual storage system that integrates snapshots, clones, or continuous-data-protection tracking information may also reduce an amount of data that may be read back from a write-mostly storage repository as data already resident in less expensive storage classes, such as local instance stores on virtual drives or objects stored in a cloud platform's standard storage class, may be used for data that is still available from these local storage sources and has not been overwritten or deleted since the time of a snapshot, clone, or continuous-data-protection recovery point having been written to write-mostly storage. Further, in some examples, data retrieved from a write-mostly storage class may be written into some other storage class, such as virtual drive local instance stores, for further use, and in some cases, to avoid being charged again for retrieval.

In some implementations, an additional level of recoverable content may be provided based on the methods and techniques described above with regard to recovering from loss of staging memory content, where the additional level of recoverable content may be used to provide reliability back to some consistent points in the past entirely from data stored in one of these secondary stores including objects stored in these other storage classes.

Further, in this example, recoverability may be based on recording the information necessary to roll back to some consistent point, such as a snapshot or checkpoint, using information that is held entirely within that storage class. In some examples, such an implementation may be based on a storage class including a complete past image of a dataset instead of only data that has been overwritten or deleted, where overwriting or deleting may prevent data from being present in more recent content from the dataset. While this example implementation may increase costs, as a result, the virtual storage system may provide a valuable service such as recovery from a ransomware attack, where protection from a ransomware attack may be based on requiring additional levels of permission or access that restrict objects stored in the given storage class from being deleted or overwritten.

In some implementations, in addition to or instead of using a write-mostly storage class, a virtual storage system may also use archive storage classes and/or deep archive storage classes for content that is—relative to write-mostly storage classes—even less likely to be accessed or that may only be needed in the event of disasters that are expected to be rare, but for which a high expense is worth the ability to retrieve the content. Examples of such low access content may include historical versions of a dataset, or snapshots, or clones that may, for example, be needed in rare instances, such as a discovery phase in litigation or some other similar disaster, particularly if another party may be expected to pay for retrieval.

However, as noted above, keeping historical versions of a dataset, or snapshots, or clones in the event of a ransomware attack may be another example. In some examples, such as the event of litigation, and to reduce an amount of data stored, a virtual storage system may only store prior versions of data within datasets that have been overwritten or deleted. In other examples, such as in the event of ransomware or disaster recovery, as described above, a virtual storage system may store a complete dataset in archive or deep archive storage class, in addition to storing controls to eliminate the likelihood of unauthorized deletions or overwrites of the objects stored in the given archive or deep archive storage class, including storing any data needed to recover a consistent dataset from at least a few different points in time.

In some implementations, a difference between how a virtual storage system makes use of: (a) objects stored in a write-mostly storage class and (b) objects stored in archive or deep archive storage classes, may include accessing a snapshot, clone, or continuous-data-protection checkpoint that accesses a given storage class. In the example of a write-mostly storage class, objects may be retrieved with a similar, or perhaps identical, latency to objects stored in a standard storage class provided by the virtual storage system cloud platform, where the cost for storage in the write-mostly storage class may be higher than the standard storage class.

In some examples, a virtual storage system may implement use of the write-mostly storage class as a minor variant of a regular model for accessing content that correspond to segments only currently available from objects in the standard storage class. In particular, in this example, data may be retrieved when some operation is reading that data, such as by reading from a logical offset of a snapshot of a tracking volume. In some cases, a virtual storage system may request agreement from a user to pay extra fees for any such retrievals at the time access to the snapshot, or other type of stored image, is requested, and the retrieved data may be stored into local instance stores associated with a virtual drive or copied (or converted) into objects in a standard storage class to avoid continuing to pay higher storage retrieval fees using the other storage class that is not included within the architecture of the virtual storage system.

In some implementations, in contrast to the negligible latencies in write-mostly storage classes discussed above, latencies or procedures associated with retrieving objects from archive or deep archive storage classes may make implementation impractical. In some cases, if it requires hours or days to retrieve objects from an archive or deep archive storage class, then an alternative procedure may be implemented. For example, a user may request access to a snapshot that is known to require at least some segments stored in objects stored in an archive or deep archive storage class, and in response, instead of reading any such segments on demand, the virtual storage system may determine a list of segments that include the requested dataset (or snapshot, clone, or continuous data protection recovery point) and that are stored into objects in the archive or deep archive storage.

In this way, in this example, the virtual storage system may request that the segments in the determined list of segments be retrieved to be copied into, say, objects in a standard storage class or into virtual drives to be stored in local instance stores. In this example, the retrieval of the list of segments may take hours or days, but from a performance and cost basis, it is preferable to request the entire list of segments at once instead of making individual requests on demand. Finishing with this example, after the list of segments has been retrieved from the archive or deep archive storage, then access may be provided to the retrieved snapshot, clone, or continuous data protection recovery point.

Readers will appreciate that although the embodiments described above relate to embodiments in which data that was stored in the portion of the block storage of the cloud-based storage system that has become unavailable is essentially brought back into the block-storage layer of the cloud-based storage system by retrieving the data from the object storage layer of the cloud-based storage system, other embodiments are within the scope of the present disclosure. For example, because data may be distributed across the local storage of multiple cloud computing instances using data redundancy techniques such as RAID, in some embodiments the lost data may be brought back into the block-storage layer of the cloud-based storage system through a RAID rebuild.

Readers will further appreciate that although the preceding paragraphs describe cloud-based storage systems and the operation thereof, the cloud-based storage systems described above may be used to offer block storage as-a-service as the cloud-based storage systems may be spun up and utilized to provide block service in an on-demand, as-needed fashion. In such an example, providing block storage as a service in a cloud computing environment, can include: receiving, from a user, a request for block storage services; creating a volume for use by the user; receiving I/O operations directed to the volume; and forwarding the I/O operations to a storage system that is co-located with hardware resources for the cloud computing environment.

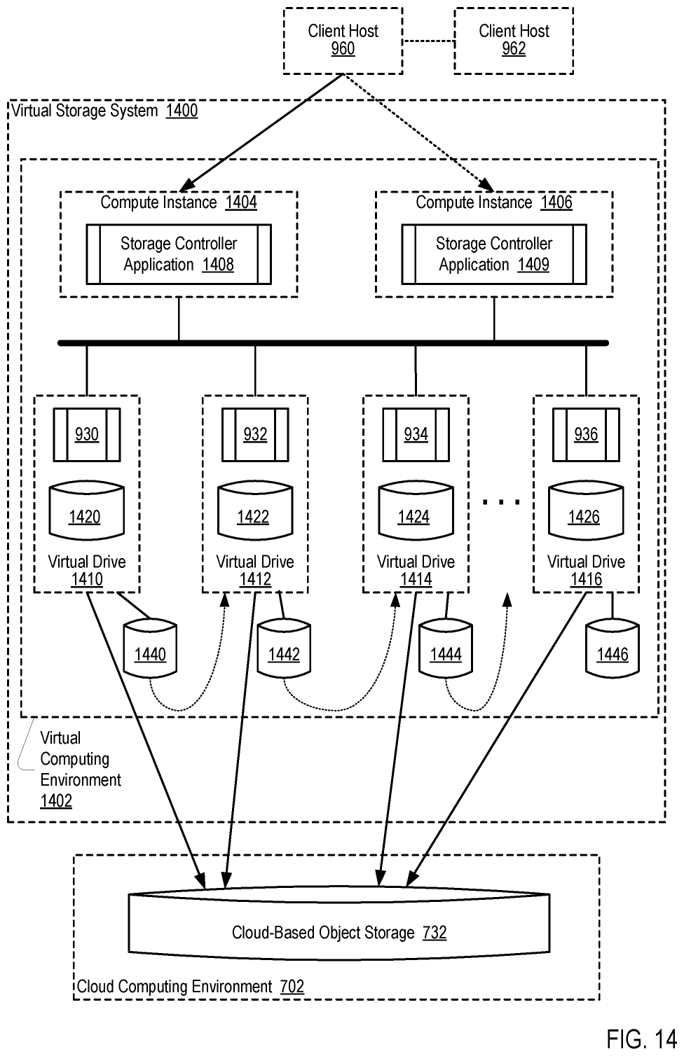

For further explanation, FIG. 14 illustrates an example virtual storage system 1400 architecture in accordance with some embodiments. The virtual storage system architecture may include similar virtual components and architectures as the cloud-based storage systems described above with reference to FIGS. 7-13. However, the virtual storage system 1400 architecture depicted in FIG. 14 is an on-premises virtual storage system provisioned in a virtual environment 1402 supported by on-premises physical storage resources. Here, “on-premises” refers to physical storage resources owned or leased by an enterprise or organization and located in a private data center, as opposed to cloud-based storage resources provided in a public cloud infrastructure by a cloud services provider. While an on-premises virtual storage system is distinguishable from a cloud-based virtual storage system in that the configuration of the underlying physical storage resources may be serviced, managed, and administered by the enterprise personnel, the virtual environment 1402 may itself be a cloud computing environment such as a private cloud platform that presents an abstraction of the on-premises physical resources. Accordingly, the management and configuration of storage services provided by the on-premises virtual storage system 1400 may be divorced from the management and configuration of the physical on-premises resources that host the virtual storage system 1400, thus allowing the on-premises virtual storage system to be administered in the same manner and using the same interfaces as it would be if it were provisioned on resources provided by a cloud servers provider. As will be explained in greater detail below, the virtual environment 1402 hosted on on-premises resources allows the virtual components of the virtual storage system 1400 to be replicated to or reconstructed in the cloud computing environment (or the reverse), for example, to facilitate scale-out of the virtual storage system, migration of the virtual storage system, and movement of a virtual storage system dataset between an on-premises virtual storage system and a cloud-based virtual storage system.

In the example depicted in FIG. 14, the virtual storage system 1400 includes one or more virtual controllers that are implemented in one or more compute instances, where a compute instance may execute or run as virtual machines flexibly allocated to on-premises physical host servers. Like the storage controllers 708, 710, a virtual controller may take in or receive I/O operations and/or configuration requests from client hosts 960, 962 (possibly through intermediary servers, not depicted) or from administrative interfaces or tools, and then ensure that I/O requests and other operations run through to completion. In some examples, virtual controllers may present file systems, block-based volumes, object stores, and/or certain kinds of bulk storage databases or key/value stores, and may provide data services such as snapshots, replication, migration services, provisioning, host connectivity management, deduplication, compression, encryption, secure sharing, and other such storage system services.

In the example depicted in FIG. 14, two virtual controllers are depicted as, respectively, storage controller application 1408 running within compute instance 1404 and storage controller application 1409 running within compute instance 1406. The compute instances 1404, 1406 may execute on virtual machines within the virtual environment 1402 that hosted on the on-premises physical resources. For example, multiple compute instances running the storage controller application may be hosted on disparate servers within one or more data centers, such that, in the event of a fault in one server, the storage controller application in a compute instance hosted on a different server may continue to service storage operations directed to the virtual storage system.

In the example depicted in FIG. 14, the virtual storage system 1400 includes one or more virtual drives 1410-1416 that are implemented in one or more compute instances, where a compute instance may execute or run as virtual machines flexibly allocated to on-premises physical host servers. Analogous to the virtual drives 910-916, the virtual drives 1410-1416 provide block-level storage and object storage to virtual controllers such as the storage controller applications 1408,1409. In some implementations, staging memory may be implemented by one or more virtual drives 1410-1416, where the one or more virtual drives 1410-916 store data within respective block-store volumes 1440-1446 and local storage 1420-1426. In some examples, the local storage 1420-1426 may be one or more SSDs of the respective on-premises physical resource hosting the compute instance in which the virtual drive is implemented.

In some implementations, the block storage volumes 1440-1446 may be block storage volumes in an on-premises physical storage system or array of physical storage systems. For example, the block storage volumes 1440-1446 may be synchronously replicated across an array of physical storage systems. In some implementations, the location and provisioning of block storage volumes 1440-1446 within the on-premises resources is not visible to the host application or an administrator of the storage services provided by the virtual storage system, such that the block storage volumes 1440-1446 may behave like cloud-based block storage volumes (e.g., an Amazon EBS volume). The block storage volumes may be attached, one after another, as depicted in FIG. 9, to two or more other virtual drives. In some implementations, the block storage volume may be a cloud-based block storage volume provided by a cloud services provider (e.g., an AWS EBS volume).

In the example depicted in FIG. 14, the virtual drives 1410-1416 are coupled on an object store, such as cloud-based object storage 732, that provides provide back-end, durable object storage. As illustrated in FIG. 14, cloud-based object storage 732 may be managed by the virtual drives 1410-1416. In some implementations, the software daemon 1230-1236 or some other module of computer program instructions that is executing on the virtual drive instance 1410-1416 may be configured to not only write the data to its own local storage 1420-1426 resources and any appropriate block storage 1440-1446 that are offered by the virtual computing environment 1402, but the software daemon 1230-1236 or some other module of computer program instructions that is executing on the particular virtual drive 1410-1416 may also be configured to write the data to cloud-based object storage 732 that is attached to the particular virtual drive. For example, data written to the storage resources of the virtual drives 1410-1416 hosted on-premises may be automatically replicated to the cloud-based object storage, as previously discussed.

Readers will appreciate the on-premises virtual storage system 1400 constructed utilizing the architecture set forth above allows a host application or administrator to treat the on-premises virtual storage system 1400 as if it were a cloud-based virtual storage system, such that the virtual storage system 1400 allows a user to provision storage resources from multiple storage tiers based on performance and durability characteristics while remaining agnostic to the configuration of the on-premises physical resources that are utilized to support the virtual storage system. Readers will also appreciate that the on-premises virtual storage system 1400 can provide a set of storage services and interfaces that are similar, if not identical, to a cloud-based virtual storage system, thus facilitating interoperability between the on-premises storage resources and cloud-native applications. For example, the on-premises virtual storage system 1400 provides the same set of virtual controllers, drive instances, block level storage services, object storage services, and interfaces as those provided by the cloud-based virtual storage systems depicted in FIGS. 7-13. In one example, the same API used to construct the on-premises virtual storage system 1400 may be used to construct the cloud-based virtual storage systems depicted in FIGS. 7-13. Readers will also appreciate that the on-premises virtual storage system 1400 may be easily scaled out to a cloud computing environment or migrated to and from the cloud computing environment; for example, in accordance with a cost model. For example, a virtual storage system service may spin up an instance of the virtual controller and/or an instance of a virtual drive in the cloud computing environment and connect those instances to the on-premises virtual storage system 1400.

In some implementations, the on-premises virtual storage system 1400 may be provided to a customer as a “cloud in a box” that includes the virtual environment, hardware infrastructure, and storage resources for hosting the on-premises virtual storage system 1400. In this example, the on-premises virtual storage system 1400 may include VM templates for creating the virtual machines that host the virtual controllers and virtual drives. Likewise, the on-premises virtual storage system 1400 may include a preinstalled storage controller application that is compatible with a storage controller application used to manage other on-premises physical resources such as an NFS or storage array. By implementing a storage controller application that may be hosted on a cloud-based virtual storage system or an on-premises virtual storage system, and that is compatible with a storage controller application for physical storage resources, a unified data experience may be provided to the customer. Moreover, by providing on-premises virtual storage system utilizing the customer's on-premises physical resources, the customer may allow its personnel to configure virtual storage systems as if they were cloud-based storage systems (e.g., by setting quotas, creating volumes and other storage components, monitoring performance, defining access control, applying policies), while leaving the administration of the physical environment (e.g., provisioning virtual storage systems, moving virtual storage systems across physical infrastructure, load balancing, replication policies) to the customer's or provider's technical personnel.

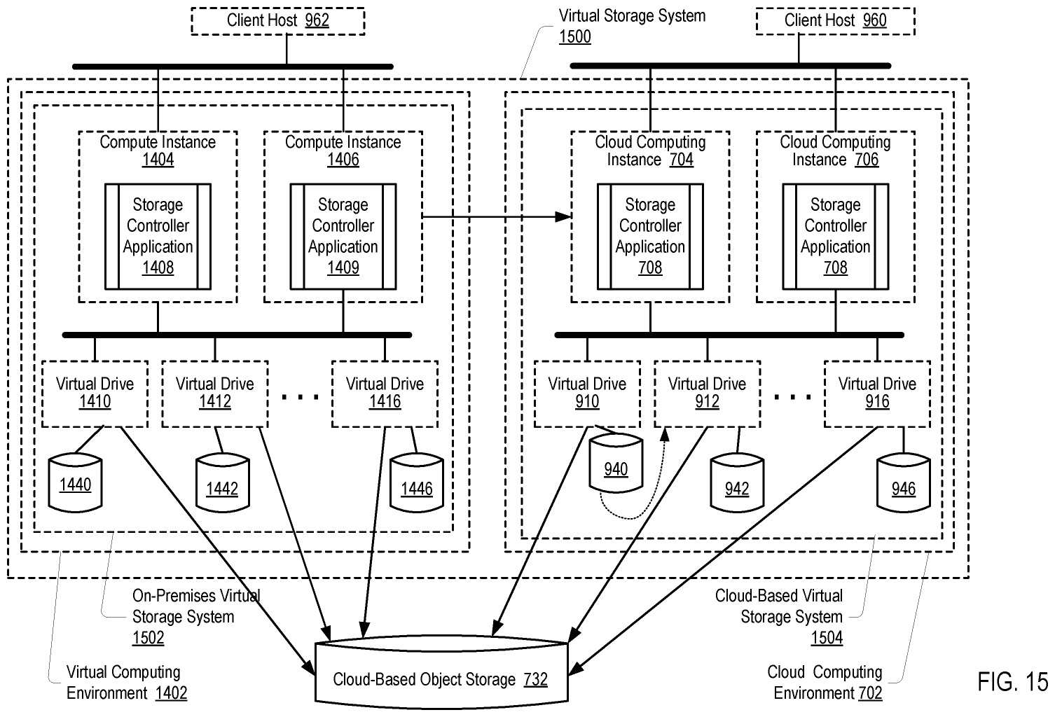

For further explanation, FIG. 15 illustrates an example virtual storage system 1500 architecture in accordance with some embodiments. The virtual storage system architecture may include similar virtual components as the cloud-based virtual storage systems and on-premises virtual storage systems described above with reference to FIGS. 7-14.

In this implementation, a virtual storage system 1500 includes an instance of on-premises virtual storage system 1502 and an instance of cloud-based virtual storage system 1504. In some examples, the virtual storage system 1500 is constructed by reconstructing the on-premises virtual storage system 1502 in the cloud computing environment 402 to create the cloud-based virtual storage system 1504, for example, as part of a scale out operation or migration of a virtual storage system dataset to the cloud computing environment 402. In some examples, the virtual storage system 1500 is constructed by reconstructing the cloud-based virtual storage system 1504 in the virtual computing environment 1402 to create the on-premises virtual storage system 1502, for example, to reduce latency by moving the virtual storage system closer to the physical storage resources in a data center on-premises. In some examples, the on-premises virtual storage system 1502 and the cloud-based virtual storage system 1504 may be configured to synchronously replicate data between the two virtual storage systems, such that the presented virtual storage system 1500 can continue running and providing its services even in the event of a loss of data or availability in either virtual storage system instance. In the example depicted in FIG. 15, the on-premises virtual storage system 1502 and the cloud-based virtual storage system 1504 share the cloud-based object storage 732 as durable back-end storage, also it will be appreciated that in some implementations the on-premises virtual storage system 1502 and the cloud-based virtual storage system 1504 may be attached to respective object stores or respective buckets in an object store.

Consider an example where a dataset or portion thereof is migrated from the on-premises virtual storage system 1502 to the cloud-based virtual storage system 1504, for example, in response to a user request or detection of a fault. Virtual storage system logic may spin up instances of the virtual controllers and virtual drives of the on-premises virtual storage system 1502 in cloud computing instances of the cloud computing environment (e.g., by implementing a virtual controller in an AWS EC2 instance and a virtual drive in an AWS EC2 instance with local instance store). Virtual storage system logic may then migrate the data in the local storage and/or block storage volume of the on-premises virtual storage system 1502 to the local storage and block storage volume of the cloud computing environment (e.g., by coping data to the AWS EC2 instance with local storage and an attached EBS volume. In the event of a fault in the on-premises virtual storage system 1502, the local storage and block storage volume of the cloud-based virtual storage system 1504 may be rehydrated with data from the shared cloud-based object storage. Further, the virtual storage system logic may apply the same connectivity, policies, and other configurations of the on-premises virtual storage system 1502 to the cloud-based virtual storage system 1504. The process may be reversed, for example, by creating compute instances in the virtual environment 1402 and migrating the virtual controller and virtual drives from cloud-computing instances to the compute instances of the virtual environment 1402, and copying the data from the local storage and block storage of the cloud-based virtual storage system 1504 to the on-premises virtual storage system 1502. In some examples, the compute instances 1404, 1406 and drive instances 1410-1416 may be AWS EC2 instances that are hosted in the virtual environment 1402 of the on-premises physical resources. In some examples, the on-premises virtual storage system 1502 and the cloud-based virtual storage system 1504 may be configured to synchronously replicate data between the two virtual storage systems, such that the presented virtual storage system 1500 can continue running and providing its services even in the event of a loss of data or availability in either virtual storage system instance. Such an implementation could be further implemented to share use of durable objects, such that the storing of data into the object store is coordinated so that the two virtual storage systems 1502, 1504 do not duplicate the stored content. Further, in such an implementation, the two synchronously replicating virtual storage systems 1502, 1504 may synchronously replicate updates to the staging memories and perhaps local instance stores, to greatly reduce the chance of data loss, while coordinating updates to object stores as a later asynchronous activity to greatly reduce the cost of capacity stored in the object store.

It is often desirable to migrate data between physical storage systems and cloud-based storage systems, or from an outdated, underperforming, or otherwise inferior storage system to a new storage system. One approach for migrating data from an old storage system to a new storage system is to perform a byte-for-byte copy of the data from the old system to the new system. This requires downtime for both storage systems because read/write operations cannot be performed during the copy process. Another approach for migrating data from an old storage system to a new storage system is to run host-side software to manage the migration. The host-side software copies data from the old system to the new system, services writes via the new system, and determines when to read from the old or new system. However, this requires licensing and installing such software on every host, which can be an expensive and tedious endeavor. This approach also requires copying data and sending all the copied data over the host's network, which consumes network resources and processing resources of the host. Therefore, it would be advantageous to provide a storage system that can manage the migration without making the data unavailable during the migration.

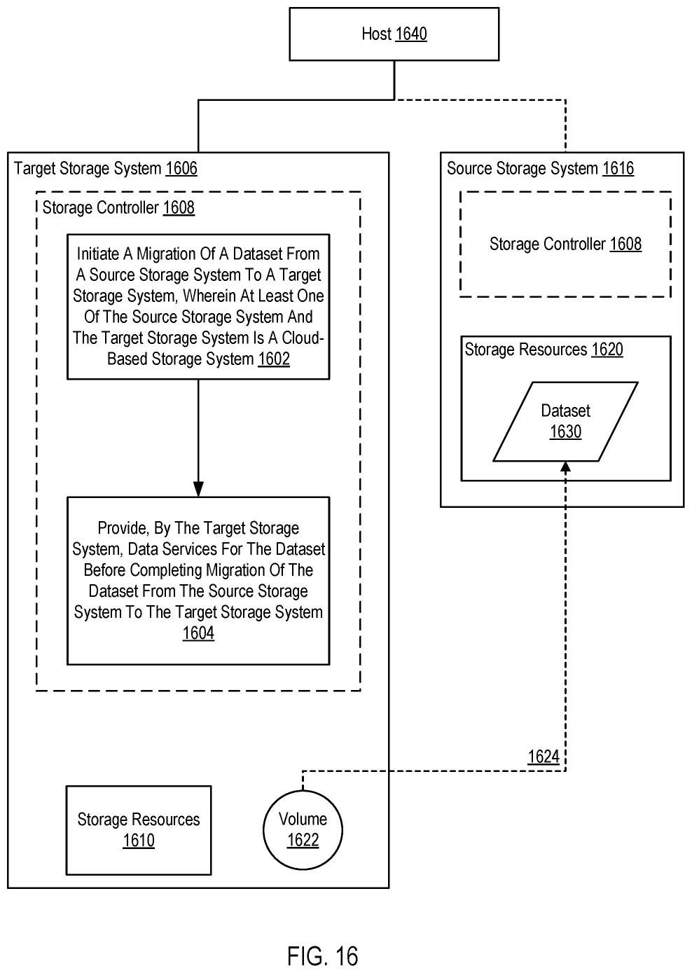

For further explanation, FIG. 16 sets forth a flow chart illustrating an example method in accordance with some embodiments of the present disclosure. Although depicted in less detail, the storage system 1606 depicted in FIG. 16 may be similar to the storage systems described above, including combinations of the storage systems described above. In fact, the storage system 1606 depicted in FIG. 16 may include the same, fewer, or additional components as the storage systems described above.

The example method of FIG. 16 includes initiating 1602 a migration of a dataset 1630 from a source storage system 1616 to a target storage system 1606, wherein at least one of the source storage system 1616 and the target storage system 1606 is a cloud-based storage system. In some examples, the target storage system 1606 generally includes at least one storage controller 1608 (e.g., a primary and secondary controller) and one or more persistent storage resources 1610 (e.g., storage drives) implementing block-based storage. The storage controller 1608 presents read/write access to the persistent storage resources 1610. Read/write access is provided through a variety of APIs presented by the storage controller 1608. In some implementations, the storage controller also provides data services. Such data services can include snapshots, cloning, replication, data reduction, and virtual copying, to name a few.

In some embodiments, the target storage system 1606 is a cloud-based storage system and the source storage system 1616 is a physical storage system. The target storage system 1606 can be, for example, any of the cloud-based storage systems discussed above. For example, the target storage system 1606 can be the cloud-based storage system 703 of FIG. 7, the cloud-based storage system 802 of FIG. 8, the virtual storage system 900 of FIG. 9, the virtual storage system 1000 of FIG. 10, the virtual storage system 1100 of FIG. 11, and so on. As such, the storage controller 1608 is embodied in one or more cloud computing instances that host a storage controller application. The storage resources 1610 can be embodied in the local storage of one or more ‘virtual drive’ cloud computing instances, block storage attached to cloud computing instances, and/or cloud-based object storage. In some implementations, data is striped across the virtual drives or across the attached block storage. Consider an example where the target storage system 1606 is similar to the cloud-based storage system 703 of FIG. 7. In this example, the storage controller 1608 is embodied in a storage controller application (e.g., storage controller application 708, 710) in one or more cloud computing instances (e.g., cloud computing instances 704, 706). Continuing this example, the storage resources 1610 of the target storage system 1606 may include the local storage of one or more ‘virtual drive’ cloud computing instances (e.g., the local storage 714, 718, 722 of the cloud computing instances 724a, 724b, 724n of FIG. 7), block storage attached to those cloud computing instances (e.g., block storage 726, 728, 730 of FIG. 7), and cloud-based object storage (e.g., the cloud-based object storage 732 of FIG. 7). In other examples, the target storage system 1606 can be a cloud-based storage system that does not utilize a virtual drive. In one such example, the storage controller 1608 can be embodied in one or more cloud computing instances that host a storage controller application and the storage resources 1610 can be embodied in block storage devices provided by the cloud infrastructure. The cloud-computing instance hosting the storage controller application is coupled to these block storage devices, which may or may not be backed by object storage.

In some examples, the target storage system 1606 is more particularly a virtual storage system as discussed above. Where the target storage system 1606 is a virtual storage system in a cloud computing environment, the target storage system 1606 can be implemented across different availability zones or other high availability partitions of the cloud-computing environment. As such, the storage controller 1608 of the target storage system 1606 can be embodied in multiple cloud computing instances on cloud infrastructure located in different zones, while the storage resources 1610 of the target storage system 1606 can include virtual drives (i.e., cloud computing instances with local storage) and attached block storage on cloud infrastructure located in different zones. The storage resources 1610 also include cloud-based object storage. Consider an example in which the target storage system 1606 is similar to the virtual storage system 900 of FIG. 9. In this example, the target storage system 1606 is implemented across multiple availability zones (e.g., availability zones 951, 952), where the storage controller 1608 is embodied in a storage controller application (e.g., storage controller application 708, 710) in one or more cloud computing instances (e.g., cloud computing instances 704, 706) distributed across the availability zones. Continuing this example, the storage resources 1610 of the target storage system 1606 may include virtual drives (e.g., virtual drives 910-916) and/or cloud infrastructure block storage (e.g., block storage 940-946) distributed across multiple availability zones, and may also include cloud-based object storage resources. The target storage system 1606 can include synchronous replication logic that enables the virtual drives or cloud-based block storage devices in one zone to synchronously replicate data with virtual drives or cloud-based block storage devices in another zone. Thus, when migrating the dataset 1630 from the source storage system 1616 to the target storage system 1606, migrated data may be synchronously replicated among storage resources located in different zones.

The source storage system 1616 can be, for example, a physical storage array such as the storage array 102A of FIG. 1A. As such, the storage controller 1618 is a physical host for a storage controller application. In these examples, the source storage system 1616 generally includes one or more persistent storage resources 1620 (e.g., storage drives) storing the dataset 1630 to be migrated. In some examples, the source storage system 1616 is an on-premises storage system in an organization's data center or in a colocation facility. In other examples, the source storage system 1616 is hosted in a data center of a storage-as-a-service provider.

In some examples, the storage controller application of the target storage system 1606 and the storage controller application of the source storage system 1616 are the same application. For example, initiating 1602 a migration of a dataset 1630 from a source storage system 1616 to a target storage system 1606 can include initiating a migration of the dataset 1630 from an organization's on-premises storage array or hosted storage array to a cloud-based storage system, where the storage array and the cloud-based storage system share a set of APIs for software defined storage. In some examples, the organization's on-premises storage array or hosted storage array and the software defined storage for the cloud-based storage system are provided by the same vendor.

In other embodiments, the target storage system 1606 is a physical storage system and the source storage system 1616 is a cloud-based storage system. The target storage system 1606 can be, for example, a physical storage array such as the storage array 102A of FIG. 1A. As such, the storage controller 1608 is a physical host for a storage controller application. In these examples, the target storage system 1606 generally includes one or more persistent storage resources 1620 (e.g., storage drives). In some examples, the target storage system 1606 is an on-premises storage system in an organization's data center or in a colocation facility. In other examples, the target storage system 1606 is hosted in a data center of a storage-as-a-service provider. In other words, the organization is a customer of a vendor that supplies both the source physical storage system 1616 and the software define storage services for the cloud-based target storage system 1606.

In these embodiments, the cloud-based source storage system 1616 can be, for example, any of the cloud-based storage systems discussed above. For example, the source storage system 1616 can be the cloud-based storage system 703 of FIG. 7, the cloud-based storage system 802 of FIG. 8, the virtual storage system 900 of FIG. 9, the virtual storage system 1000 of FIG. 10, the virtual storage system 1100 of FIG. 11, and so on. As such, the storage controller 1618 is embodied in one or more cloud computing instance that hosts a storage controller application. The storage resources 1620 can be embodied in the local storage of one or more ‘virtual drive’ cloud computing instances, block storage attached to cloud computing instances, and/or cloud-based object storage that stores the dataset 1630. In some implementations, data is striped across the virtual drives or across the attached block storage. Consider an example where the source storage system 1616 is similar to the cloud-based storage system 703 of FIG. 7. In this example, the storage controller 1618 is embodied in a storage controller application (e.g., storage controller application 708, 710) in one or more cloud computing instances (e.g., cloud computing instances 704, 706). Continuing this example, the storage resources 1620 of the source storage system 1616 may include the local storage of one or more ‘virtual drive’ cloud computing instances (e.g., the local storage 714, 718, 722 of the cloud computing instances 724a, 724b, 724n of FIG. 7), block storage attached to those cloud computing instances (e.g., block storage 726, 728, 730 of FIG. 7), and cloud-based object storage (e.g., the cloud-based object storage 732 of FIG. 7). In other examples, the source storage system 1616 can be a cloud-based storage system that does not utilize a virtual drive. In one such example, the storage controller 1618 can be embodied in one or more cloud computing instances that host a storage controller application and the storage resources 1620 can be embodied in block storage devices provided by the cloud infrastructure. The cloud-computing instance hosting the storage controller application is coupled to these block storage devices, which may or may not be backed by object storage.

In some examples, the source storage system 1616 is more particularly a virtual storage system as discussed above. Where the source storage system 1616 is a virtual storage system in a cloud computing environment, the source storage system 1616 can be implemented across different availability zones or other high availability partitions of the cloud-computing environment. As such, the storage controller 1618 of the source storage system 1616 can be embodied in multiple cloud computing instances on cloud infrastructure located in different zones, while the storage resources 1620 of the source storage system 1616 can include virtual drives (i.e., cloud computing instances with local storage) and attached block storage on cloud infrastructure located in different zones. The storage resources 1620 also include the cloud-based object storage. Consider an example in which the source storage system 1616 is similar to the virtual storage system 900 of FIG. 9. In this example, the source storage system 1616 is implemented across multiple availability zones (e.g., availability zones 951, 952), where the storage controller 1618 is embodied in a storage controller application (e.g., storage controller application 708, 710) in one or more cloud computing instances (e.g., cloud computing instances 704, 706) distributed across the availability zones. Continuing this example, the storage resources 1620 of the source storage system 1616 include virtual drives (e.g., virtual drives 910-916) and their attached block storage (e.g., block storage 940-946) that are distributed across multiple availability zones, as well as cloud-based object storage resources. The source storage system 1616 can include synchronous replication logic that enables the virtual drives in one zone to synchronously replicate data with virtual drives in another zone. Thus, when migrating the dataset 1630 from the source storage system 1616 to the target storage system 1606, the dataset 1630 can be migrated from any of the storage resources 1620 that includes a replica of the dataset 1630. For example, the dataset 1630 can be migrated from storage resources 1620 in an availability zone that includes the physical location of the source storage system 1616 to reduce latency in data transfer operations.

In some examples, the storage controller application of the target storage system 1606 and the storage controller application of the source storage system 1616 are the same application. For example, initiating 1602 a migration of a dataset 1630 from a source storage system 1616 to a target storage system 1606 can include initiating a migration of the dataset 1630 from a cloud-based storage system to an organization's on-premises storage array or hosted storage array, where the storage array and the cloud-based storage system share a set of APIs for software defined storage. In some examples, the organization's on-premises storage array or hosted storage array and the software defined storage for the cloud-based storage system are provided by the same vendor. In other words, the organization is a customer of a vendor that supplies both the source physical storage system 1606 and the software defined storage services for the cloud-based target storage system 1616.

In yet additional embodiments, the target storage system 1606 and the source storage system 1616 are both cloud-based storage systems. The cloud-based target storage system 1606 can be, for example, any of the cloud-based storage systems discussed above. For example, the target storage system 1606 can be the cloud-based storage system 703 of FIG. 7, the cloud-based storage system 802 of FIG. 8, the virtual storage system 900 of FIG. 9, the virtual storage system 1000 of FIG. 10, the virtual storage system 1100 of FIG. 11, and so on. In some examples, the cloud-based source storage system 1616 is different from the cloud-based target storage system 1606 in that the cloud-based source storage system 1616 utilizes a different storage controller application or different software defined storage architecture, or in that the cloud-based source storage system 1616 lacks a storage controller application or software defined storage. In some examples, the cloud-based source storage system 1616 is different from the cloud-based target storage system 1606 in that the cloud-based source storage system 1616 lacks a set of data services (e.g., snapshotting, replication, data reduction, etc.) provided by the cloud-based target storage system 1606. In some examples, the cloud-based source storage system 1616 is different from the cloud-based target storage system 1606 in that the cloud-based target storage system 1606 is based on a cloud template (e.g., Amazon AWS CloudFormation Template) and the cloud-based source storage system 1616 is based on a different template or no template at all. In some examples, the storage resource 1620 of the cloud-based source storage system 1616 can include an Amazon EBS volume, a Microsoft Azure Disk, a Google Cloud Persistent Disk, or another third-party cloud storage offering.

In some examples, the target storage system initiates migration of the dataset 1630 in response to receiving a request to migrate the dataset 1630 from the source storage system 1616 to the target storage system 1606. In some examples, receiving the request to migrate the dataset 1630 from the source storage system 1616 to the target storage system 1606 is carried out by the storage controller 1608 of the target storage system 1606 receiving the request through an administration interface of the target storage system 1606. The request includes identification information for the dataset 1630 stored on the source storage system 1616, which can be a range of addresses, a volume, a file system folder, or other data objects and constructs, or the entirety of data stored on the source storage system 1616.

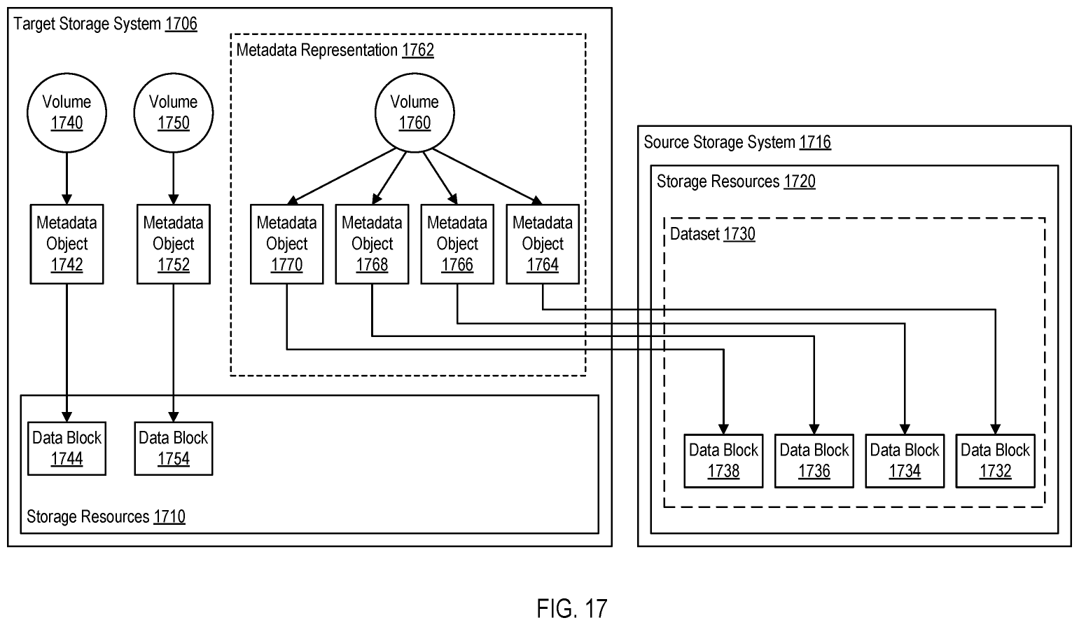

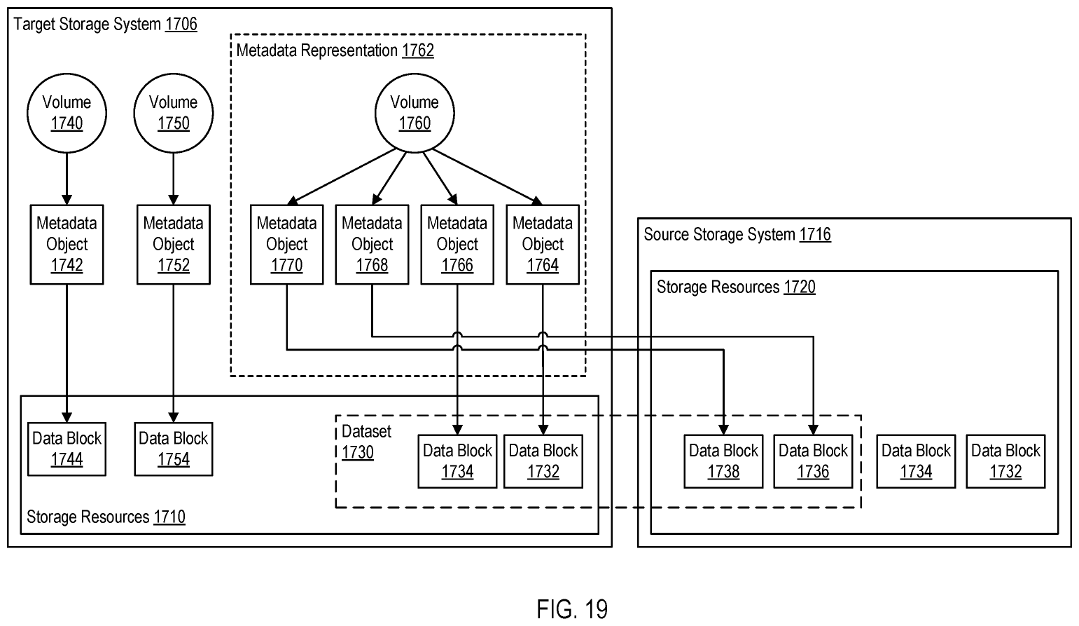

In some implementations, the target storage system 1606 includes one or more metadata representations that provide a layer of indirection between volumes in the target storage system 1606 and the storage resources 1610 of the target storage system 1606. That is, the storage resources 1610 store data of a number of volumes, each volume having a metadata representation that provides a data path between a logical address in the volume and the physical location of the data in the storage resources 1610. The metadata representations can be implemented as a structured collection of metadata objects that, together, represent a logical volume of storage data, or a portion of a logical volume. Such metadata representations are stored within a storage system 1606, and one or more metadata representations may be generated and maintained for each of multiple storage objects, such as volumes, or portions of volumes, stored within a storage system 1606. While other types of structured collections of the metadata objects are possible, in one example, metadata representations can be structured as a directed acyclic graph (DAG) of nodes that are metadata objects, where changes to the metadata representation can occur in response to changes to, or additions to, underlying data represented by the metadata representation. These nodes form an indirection layer, where nodes may include pointers to other nodes or to physical locations of stored data. The leaf nodes of a metadata representation can include pointers to the stored data for a volume, or portion of a volume, where a logical address, or a volume and offset, is used to identify and navigate through the metadata representation to reach one or more leaf nodes that reference stored data corresponding to the logical address. Thus, for example, when a particular block of data is overwritten with new data, the new data can be written to a new location and a leaf node (i.e., a metadata object) corresponding to the logical address of the old data can be updated to point to the new location. Volume implementations and metadata representations will be described in more detail below with reference to FIGS. 17 and 19.

In some examples, initiating 1602 a migration of a dataset 1630 from a source storage system 1616 to a target storage system 1606 is carried out by the target storage system 1606 creating a mapping to the dataset 1630 stored in the source storage system 1616, wherein at least one of the source storage system 1616 and the target storage system 1606 is a cloud-based storage system. In some implementations, as depicted in FIG. 16, creating a mapping 1624 to the dataset 1630 stored in the source storage system 1616 includes creating a new volume 1622 in the target storage system 1606 and mapping the new volume 1622 to the dataset 1630 stored in the source storage system 1616. For example, mapping the new volume 1622 to the dataset 1630 in the source storage system 1616 can include creating a metadata representation for the new volume 1622 that maps to the dataset 1630 stored in the source storage system 1616. In some implementations, an address space of the dataset 1630 on the source storage system is divided into logical extents. A metadata object is created for each extent, where the metadata object includes one or more pointers or references to physical locations of data corresponding to the extent. Initially, the address space of the dataset 1630 may be mapped to the source storage system 1616 as one volume-length extent, where new extents corresponding to smaller portions (e.g., 1 MB) of data in the dataset are added to the metadata representation as new data is written in the dataset 1630. Accordingly, the new volume 1622 maps to logical addresses corresponding to the metadata objects, which in turn map to physical locations of data on the source storage system (and the target storage system where new data may have been written). Thus, a logical path is created in which APIs of the storage controller 1608 provide access to the dataset 1630 stored on the source storage system 1616 through metadata mappings between the new volume 1622 and the stored data on the source storage system 1616. In some examples, the new volume 1622 is created in response to a request, received by the target storage system, to migrate the dataset 1630.

For further explanation, FIG. 17 sets forth a block diagram of an example storage system 1706 for integrating arbitrary storage into a virtualized storage system in accordance with some embodiments of the present disclosure. The example storage system 1706 includes a number of volumes 1740, 1750 and storage resources 1710. The volumes 11640, 1750 map to data blocks 1742, 1752 in the storage resources 1710 through metadata objects 1744, 1754, respectively. In the interest of clarity, metadata representations for each of the volumes 11640, 1750 include only one data block and one metadata object, though it should be understood that volumes 11640, 1750 would map to thousands of data blocks in the storage resources through thousands of metadata objects. Further, while in this example the metadata representations for volumes 11640, 1750 are shown with only two levels of indirection in the interest of clarity, in other examples metadata representations may span across multiple levels and may include hundreds or thousands of metadata objects that point to other metadata objects before reaching a pointer to a physical location.

To initiate migration of the dataset 1730 from the source storage system 1716 to the target storage system 1706, a new volume 1760 is created for the dataset 1730. In the example of FIG. 17, the dataset 1730 includes four data blocks 1732, 1734, 1736, 1738 stored in storage resources 1720 of the source storage system 1716. While only four data blocks 1732, 1734, 1736, 1738 in the dataset 1730 are shown in FIG. 17 for ease of illustration, it will be understood that the dataset 1730 may include any amount of data in any number of locations and in any size partition. In creating the new volume 1760 (also referred to as a ‘migration volume’), a metadata representation 1762 is created in which the new volume 1760 includes pointers to metadata objects 1764, 1766, 1768, 1770 corresponding to logical addresses in the address space of the dataset 1730. Those metadata objects 1764, 1766, 1768, 1770 in turn point, respectively, to the physical locations of data blocks 1732, 1734, 1736, 1738 in the storage resources 820 of the source storage system 1716. Thus, a logical address can be used by the storage controller of the target storage system 1706 to navigate through the metadata representation 1762 of the new volume 1760 to reach a leaf node (i.e., metadata objects 1764, 1766, 1768, 1770) that references stored data (i.e., data blocks 1732, 1734, 1736, 1738) on the source storage system 1716 corresponding to the logical address.

Returning to FIG. 16, the method depicted there also includes providing 1604, by the target storage system 1606, read/write access to the dataset 1630 before completing migration of the dataset 1630 from the source storage system 1616 to the target storage system 1606. The mapping 1624 created between the volume 1622 in the target storage system 1606 and the dataset 1630 in the source storage system is used by the storage controller 1608 to provide read/write access to the dataset 1630 before migration of the dataset 1630 to the target storage system 1606 is completed. In some implementations, the read/write access is provided before any portion of the dataset 1630 has been copied to the storage resources 1610 of the target storage system 1606. In some examples, read/write access is provided to a host 1640 through one or more APIs of the storage controller 1608. Thus, upon providing 1604, by the target storage system 1606, read/write access to the dataset 1630 before completing migration of the dataset 1630, a host 1640 that utilizes the dataset 1630 can redirect to the target storage system 1606 and issue read/write access requests to the target storage system 1606 instead of the source storage system 1616.

In some examples, providing 1604, by the target storage system 1606, read/write access to the dataset 1630 before completing migration of the dataset 1630 from the source storage system 1616 to the target storage system 1606 is carried out by the storage controller 1606 presenting the migration volume 1622 as an accessible volume and exposing one or more APIs for read/write access to that volume. Using FIG. 17 as an example, the volume 1760 is presented as an accessible volume before any of the data blocks 1732, 1734, 1736, 1738 have been migrated to the storage resources 1710 of the target storage system. The volume 1760 is made accessible using the metadata representation 1762. Thus, in providing 1604 read/write access to the dataset 1630, the storage controller 1606 can navigate a metadata structure that points to the data in the dataset 1630 on the storage system 1616 to provide read/write access to that data.

Thus, in accordance with embodiments of the present disclosure, the migration is managed by the target storage system instead of host-side software copying data from the source storage system to the target storage system, servicing write operations via the target storage system, and determining which storage system to use for read operations. Further, the migration is performed without disabling read and/or write access to any portion of the dataset. Read/write access is enabled for the entire dataset, including data in the dataset that has not yet been migrated.

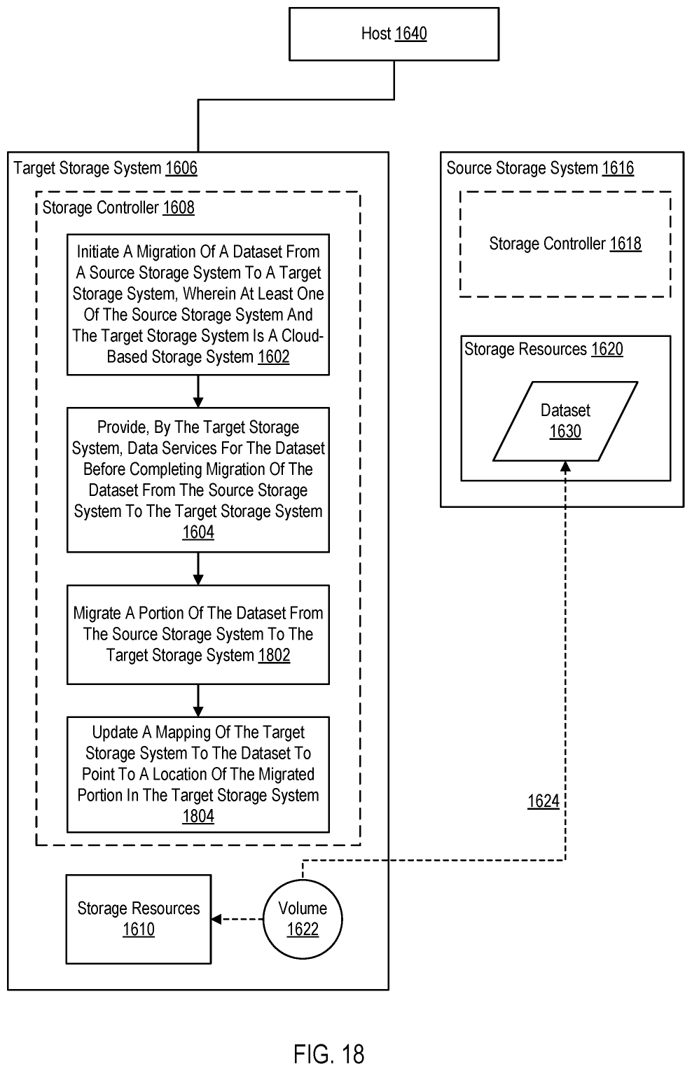

For further explanation, FIG. 18 sets forth another example method of integrating arbitrary storage into a virtualized storage system in accordance with some embodiments of the present disclosure. Like the example method of FIG. 16, the method of FIG. 18 includes initiating 1602 a migration of a dataset 1630 from a source storage system 1616 to a target storage system 1606, wherein at least one of the source storage system 1616 and the target storage system 1606 is a cloud-based storage system; and providing 1604, by the target storage system 1606, read/write access to the dataset 1630 before completing migration of the dataset 1630 from the source storage system 1616 to the target storage system 1606.

The example method of FIG. 18 also includes migrating 1802 a portion of the dataset 1630 from the source storage system 1616 to the target storage system 1606. In some implementations, the target storage system 1606 begins copying portions of the dataset 1630 from the source storage system 1616 to the storage resources 1610 of the target storage system. The migration of the dataset 1630 is performed without participation by the host. Advantageously, data traffic on the host network is reduced because data does not need to be read by the host from the source storage system and written to the target storage system, which can also consume processing resources on the host. That is, the migration of the dataset 1630 can be performed without the participation of a host.

In some examples, migrating 1802 the portion of the dataset 1630 from the source storage system 1616 to the target storage system 1606 is carried out by a background process executing in the storage controller 1608 that crawls through the dataset 1630 by reading data of the dataset 1630 from the source storage system 1616 and writing the data to a storage location in the storage resources 1610 of the target storage system 1606. In some implementations, data in the dataset 1630 is copied from the source storage system 1616 to the target storage system 1606 based on accesses to the dataset 1630. For, a read request that hits on an unmigrated portion of data can trigger the migration of that data from the source storage system 1616 to the target storage system 1606. Thus, a read request directed to data associated with a particular logical address can trigger the migration of a data block or data region that includes the data. In another example, a write request that hits on an unmigrated portion of data can trigger the migration of that data from the source storage system 1616 to the target storage system 1606. Thus, a write request directed to data associated with a particular logical address can trigger the migration of a data block or data region.

In some examples, the dataset 1630 in the source storage system 1616 is encrypted. In these examples, the target storage system 1606 is provided with one or more encryption keys for decrypting the dataset 1630 as it is copied from the source storage system 1616 to the target storage system 1606.

The example method of FIG. 18 also includes updating 1804 a mapping of the target storage system 1606 to the dataset 1630 to point to a location of the migrated portion in the target storage system 1606. As data is copied from the source storage system 1616 to storage resources 1610 of the target storage system 1606, the metadata representation of the volume 1622 is updated. That is, for a particular portion of data in the dataset 1630, a metadata object that points to a storage location of that data in the source storage system 1616 is updated to point to a destination storage location in the target storage resources 1610. As can be seen in FIG. 18, the volume 1622 maps to portions of the dataset 1630 and to locations in the storage resources 1610. Thus, in response to receiving a read request that targets a logical address corresponding to a migrated portion of data, the storage controller 1608 will navigate the metadata representation of the volume 1622 to retrieve the data from the storage resources 1610 of the target storage system 1606 instead of the source storage system 1620. Accordingly, after all of the dataset 1630 has been migrated from the source storage system 1616 to the target storage system 1606, the volume 1622 corresponding to the dataset 1630 will map only to storage locations within the storage resources 1610 of the target storage system. If the target storage system 1606 has been given the appropriate permissions, the target storage system can destroy the copy of the dataset 1630 in the source storage system 1616.

For further explanation and continuing the example of FIG. 17, FIG. 19 sets forth another diagram of the example storage system 1706 during a migration of the dataset 1630 from the source storage system 1716 to the target storage system 1706. In the example of FIG. 19, it can be seen that some data blocks 1732, 1734 of the dataset 1630 have been copied to the storage resources 1710 of the target storage system 1706. As such, metadata objects 1764, 1766 have been updated to point to data blocks 1732, 1734 in the storage resources 1710 of the target storage system, while metadata objects 1768, 1770 still point to unmigrated data blocks 1736, 1738 in the source storage system 1716. Thus, any read/write access request targeting a logical address of the migrated data blocks 1732, 1734 will be serviced on the storage resources 1710 of the target storage system 1706. For example, the storage controller navigates the metadata representation 1762 of the volume 1760 mapped to the dataset 1730 to find data blocks 1732, 1734 in the storage resources 1710. A read access request targeting a logical address of the unmigrated data blocks 1736, 1738 will be serviced by reading from the source storage system 1716. A write access request targeting a logical address of the unmigrated data blocks 1736, 1738 can be performed in accordance with a variety of failure modes, which will be described in further detail below.

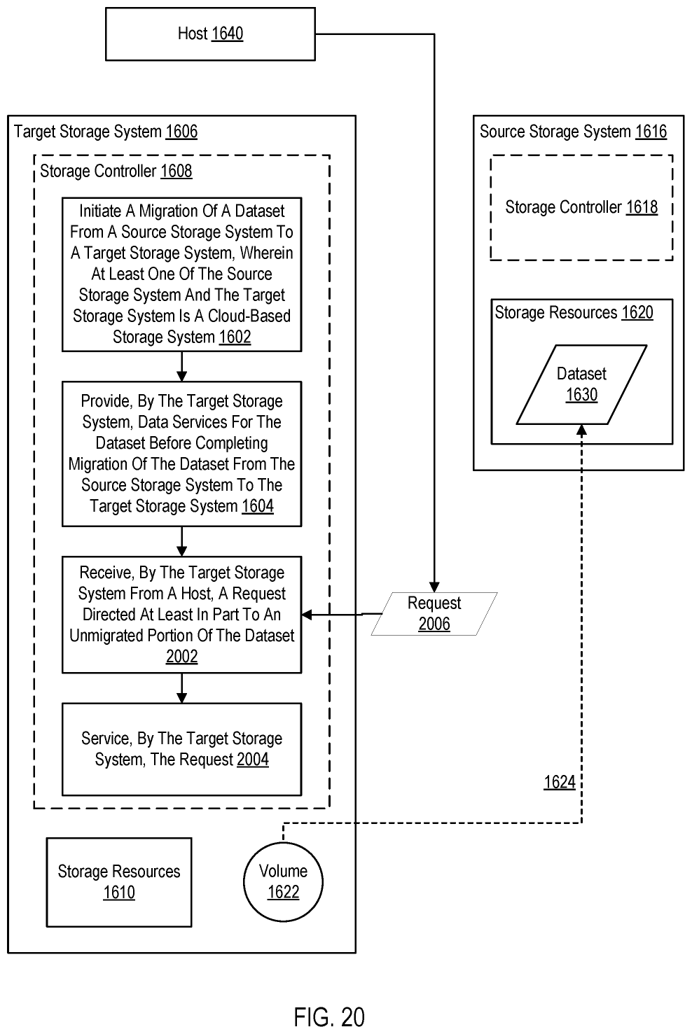

For further explanation, FIG. 20 sets forth another example method of integrating arbitrary storage into a virtualized storage system in accordance with some embodiments of the present disclosure. Like the example method of FIG. 16, the method of FIG. 20 includes initiating 1602 a migration of a dataset 1630 from a source storage system 1616 to a target storage system 1606, wherein at least one of the source storage system 1616 and the target storage system 1606 is a cloud-based storage system; and providing 1604, by the target storage system 1606, read/write access to the dataset 1630 before completing migration of the dataset 1630 from the source storage system 1616 to the target storage system 1606.

The example method of FIG. 20 also includes receiving 2002, by the target storage system from a host 1640, a request 2006 directed at least in part to an unmigrated portion of the dataset 1630. In some examples, receiving 2002, by the target storage system from the host 1640, the request 2006 directed at least in part to an unmigrated portion of the dataset 1630 is carried out by the storage controller 1608 receiving a storage service request 2006 from the host 1640. The storage service request 2006 can be, for example, a request to read data in the dataset 1630 or a request to write data in the dataset 1630. The request 2006 includes identifying information for a portion of data in the dataset 1630 for which the read/write access is requested. For example, the request 2006 can include a logical address of the data or a volume offset of the data.

The method of FIG. 20 also includes servicing 2004, by the target storage system 1606, the request 2006. Servicing 2004 the read/write access request 2006 is carried out in a variety of ways depending on the service that is requested. Where the request 2006 includes a read request, the storage controller 1608 can use the identifying information (e.g., a logical address) in the request 2006 to locate the data while remaining agnostic to the status of the migration process. That is, the storage controller navigates the metadata representation of the volume to locate the data—for migrated data, the metadata representation will point to storage in the target storage system 1606; whereas, for unmigrated data, the metadata representation will point to the source storage system. The storage controller 1608 reads the data from the storage location identified through the metadata representation and returns the data to the host 1640.

Where the request 2006 is a write request, the new data is written to a storage location in the storage resources 1610 of the target storage system and the metadata representation is updated to point to this storage location. If the new data is overwriting old data in the dataset 1630 that has not been migrated, a metadata object that points to the old data in the source storage system 1616 is updated to point to the storage location on the target storage system 1606 where the new data has been stored. If the new data is not overwriting old data in the dataset 1630, a new metadata object is created for the logical address of the new data with a pointer to the storage location in the storage resources 1610 where the new data has been stored.

Additional handling of a write request is carried out in dependence upon a failure mode that anticipates a potential failure during the migration process. In some examples, a modification of the dataset 1630 is propagated to the source storage system 1616. That is, when new data is written to the target storage system 1606 as part of a write request, the new data is also written, by the storage controller 1606, to the source storage system 1616. This technique is advantageous in that, if an error occurs, the entire migration can be undone by reverting the host 1640 to accessing the source storage system 1616 with no data loss. Thus, if there is an error such as a configuration error or a sizing error in the target storage system 1606, no further participation by the target storage system 1606 is required for a roll-back. However, certain features will require additional data handling when the source storage system receives propagated modifications of the dataset 1630. For example, a snapshot or clone should not simply perform an overwrite by writing new data to new locations on the first storage 1606 system while leaving the original (logically overwritten) data in its original location on the source storage system 1616. The overwritten data should be copied first unless a snapshot or clone can be coordinated on the source storage system 1616 and accessed by the target storage system 1606. In performing a virtual copy operation, if such operations have an optimized implementation on the target storage system 1606 but do not have an optimized implementation on the source storage system 1616, the data on the source storage system 1616 should be physically copied in order to keep the dataset 1630 on the source storage system 1616 up-to-date.

In other examples, modifications to the dataset 1630 are not propagated to the source storage system 1616 unless an error occurs during migration. In these examples, new writes can write to storage resources 1610 of the target storage system 1606, snapshots that include unmigrated data can leave the original data in place with overwrites written to new locations in the target storage system 1606, and virtual copies of unmigrated data in the source storage system 1616 can simply add new logical addresses that map to the same data blocks in the source storage system 1616. However, to back out of the migration (e.g., in the event of failure), the target storage system 1606 should write any updates to the source storage system 1616 before the migration can be safely rolled back without data loss. In such a scenario, the target storage system 1606 turns off read/write access, discontinues the process of copying data from the source storage system 1616, and pushes updated data (e.g., written to the migrated portions of the dataset 1630 in target storage system 1606) back to the source storage system 1616. An advantage of not propagating modification to the dataset 1630 back to the source storage system 1616 is that data service features such as snapshotting, cloning, virtual copy, data reduction, and replication are made available immediately through the target storage system 1606 for experimentation on the dataset 1630. If tests show that that migration is performing satisfactorily, then the migration can proceed. Otherwise, the migration can be backed out by copying updates back to the source storage system 1616. Also, the source storage system 1616 can serve as a snapshot of the dataset 1630 from just prior to the migration, and can operate in a safe read-only mode unless and until there is a decision made to back out of the migration.

Thus, when the request 2006 is a snapshot request, the target storage system 1606 can fulfill the request, depending on the failure mode, by replicating a metadata representation for the migration volume 1622 that includes unmigrated data (and possibly migrated data) or by first copying data from the source storage system 1616 to the target storage system 1606 and then performing the snapshot based on migrated data. Similarly, where the request 2006 is a request to create a clone, the target storage system 1606 can fulfill the request by creating another volume having a metadata representation that replicates a metadata representation for the migration volume, which includes unmigrated data (and possibly migrated data); or, by first copying data from the source storage system 1616 to the target storage system 1606 and then creating the clone based on migrated data. Similarly, where the request 2006 is a virtual copy request, the target storage system 1606 can fulfill the request by creating new metadata objects with new logical addresses that point to unmigrated data (and possibly migrated data), or by first physically copying data from the source storage system 1616 to the target storage system 1606 and then performing the virtual copy operation.

Where the request 2006 is a data reduction request, the target storage system 1606 can fulfill the request by performing data reduction as data is copied from the source storage system 1616 to the target storage system 1606. Where the request 2006 is a replication request, data is replicated to a different storage system as the data is copied from the source storage system 1616 to the target storage system 1606.

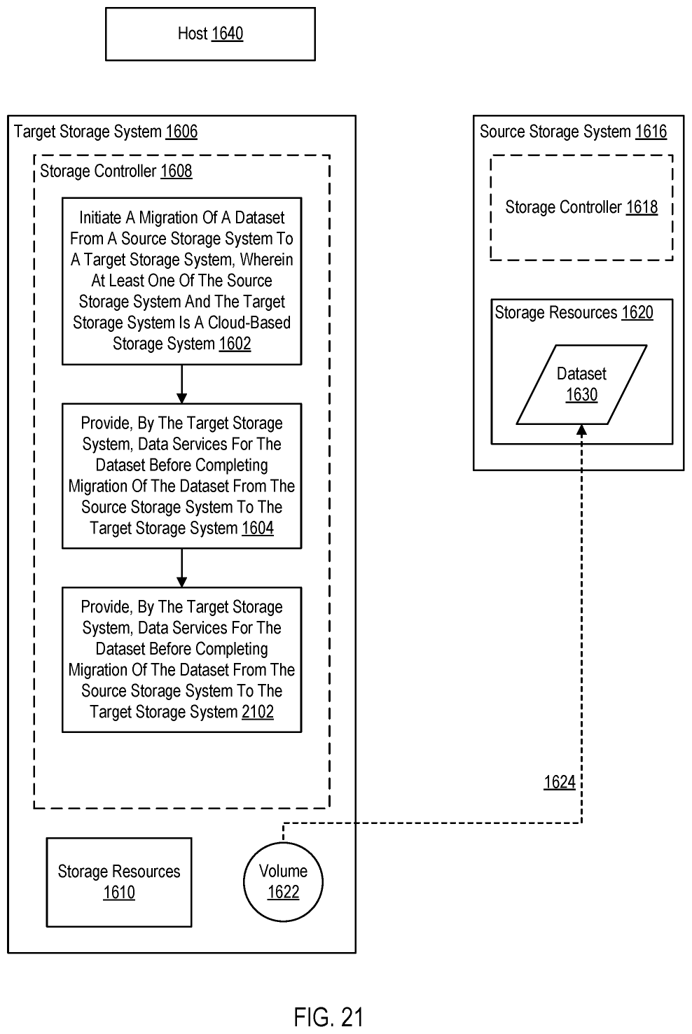

For further explanation, FIG. 21 sets forth another example method of integrating arbitrary storage into a virtualized storage system in accordance with some embodiments of the present disclosure. Like the example method of FIG. 16, the method of FIG. 18 includes initiating 1602 a migration of a dataset 1630 from a source storage system 1616 to a target storage system 1606, wherein at least one of the source storage system 1616 and the target storage system 1606 is a cloud-based storage system; and providing 1604, by the target storage system 1606, read/write access to the dataset 1630 before completing migration of the dataset 1630 from the source storage system 1616 to the target storage system 1606.

The example method of FIG. 21 also includes providing 2102, by the target storage system 1606, data services for the dataset 1630 before completing migration of the dataset 1630 from the source storage system 1616 to the target storage system 1606. The mapping 1624 created between the volume 1622 in the target storage system 1606 and the dataset 1630 in the source storage system is used by the storage controller 1608 to provide storage and data services for the dataset 1630 before migration of the dataset 1630 to the target storage system 1606 is completed. In some implementations, the storage and data services are provided before any portion of the dataset 1630 has been copied to the storage resources 1610 of the target storage system 1606. These storage and data services include, but are not limited to, snapshotting, cloning, replication, data reduction, and virtual copying. In some examples, one or more additional features are provided to a consumer of data services through one or more APIs of the storage controller 1608. Thus, upon providing 2102, by the target storage system 1606, data services for the dataset 1630 before completing migration of the dataset 1630, a host 1640 that utilizes the dataset 1630 can redirect to the target storage system 1606 and issue storage and data services requests to the target storage system 1606 instead of the source storage system 1616.

In some examples, providing 2102, by the target storage system 1606, data services for the dataset 1630 before completing migration of the dataset 1630 from the source storage system 1616 to the target storage system 1606 is carried out by the storage controller 1606 presenting the migration volume 1622 as an accessible volume and exposing one or more APIs for storage and data services on that volume. For example, the target storage system can receive a request 2006 to configure data services for the dataset 1630, such as snapshotting, cloning, replication, or virtual copying among others. For example, the configuration request 2006 can be a message, command, or other input that directs the target storage system 1606 to enable these data services and may include configuration settings for the data services. The target storage system 1606 may be configured to provide these data services for the dataset 1630 although some portion or all of the dataset 1630 remains unmigrated. In some examples, the request 2006 is received before any portion of the dataset 1630 is copied from the source storage system 1616 to the target storage system 1606. In other examples, the request 2006 is received during migration (i.e., where some, but not all, data of the dataset 1630 has been copied from the source storage system 1616 to the target storage system 1606).

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A method comprising:
initiating a migration of a dataset from a source storage system to a target storage system wherein at least one of the source storage system and the target storage system is a cloud-based storage system; and
providing, by the target storage system, read/write access to the dataset before completing migration of the dataset from the source storage system to the target storage system.

2. The method of claim 1, wherein the cloud-based storage system is a virtual storage system.

3. The method of claim 1, wherein at least one of the source storage system and the target storage system is physical storage system.

4. The method of claim 1, wherein both the source storage system and the target storage system are cloud-based storage systems.

5. The method of claim 1, wherein the migration is initiated by mapping a volume in the target storage system to the dataset in the source storage system.

6. The method of claim 5, wherein the volume is created in response to a request to migrate the dataset from the source storage system to the target storage system.

7. The method of claim 1, wherein the read/write access is provided before any portion of the dataset is copied from the source storage system to the target storage system.

8. The method of claim 1 further comprising:
providing, by the target storage system, data services for the dataset before completing migration of the dataset from the source storage system to the target storage system, wherein the data services include at least one of snapshotting, cloning, data reduction, virtual copy, and replication.

9. The method of claim 1 further comprising:
migrating a portion of the dataset from the source storage system to the target storage system; and
updating a mapping of the target storage system to the dataset to point to a location of the migrated portion in the target storage system.

10. The method of claim 6, wherein the dataset is copied from the source storage system to the target storage system without participation by a host.

11. The method of claim 6, wherein the dataset is encrypted, and wherein the target storage system includes one or more encryption keys for reading the dataset.

12. The method of claim 1 further comprising:
receiving, by the target storage system from a host, a request directed at least in part to an unmigrated portion of the dataset; and
servicing, by the target storage system, the request.

13. The method of claim 9, wherein an update to the dataset is propagated to the source storage system.

14. The method of claim 9, wherein an update to the dataset is not propagated to the source storage system.

15. The method of claim 1, further comprising:
providing, by the target storage system, data services for the dataset before completing migration of the dataset from the source storage system to the target storage system.

16. An apparatus comprising a computer processor and a computer memory operatively coupled to the computer processor, the computer memory storing computer program instructions that, when executed by the computer processor, cause the apparatus to:
initiate a migration of a dataset from a source storage system to a target storage system wherein at least one of the source storage system and the target storage system is a cloud-based storage system; and
provide, by the target storage system, read/write access to the dataset before completing migration of the dataset from the source storage system to the target storage system.

17. The apparatus of claim 16, wherein at least one of the source storage system and the target storage system is physical storage system.

18. The apparatus of claim 16, wherein both the source storage system and the target storage system are cloud-based storage systems.

19. The apparatus of claim 16, wherein the read/write access is provided before any portion of the dataset is copied from the source storage system to the target storage system.

20. A non-transitory computer readable storage medium storing instructions, which when executed, cause a processing device to:
initiate a migration of a dataset from a source storage system to a target storage system wherein at least one of the source storage system and the target storage system is a cloud-based storage system; and
provide, by the target storage system, read/write access to the dataset before completing migration of the dataset from the source storage system to the target storage system.
